(19) United States
(12) Patent Application Publication
(10) Pub. No.: US 2014/0244155 A1
(43) Pub. Date: Aug. 28, 2014

(54) INFORMATION PROCESSING APPARATUS, INFORMATION PROCESSING METHOD, AND PROGRAM

(71) Applicant: SONY CORPORATION, TOKYO (JP)

(72) Inventor: MAKOTO ABE, Tokyo (JP)

(73) Assignee: SONY CORPORATION, TOKYO (JP)

(21) Appl. No.: 14/153,392

(22) Filed: Jan. 13, 2014

(30) Foreign Application Priority Data
Feb. 27, 2013 (JP) 2013-036533

(51) Int. Cl. G06F 17/22; G01C 21/00

(52) U.S. Cl. CPC G06F 17/2235; G01C 21/00
USPC 701/410; 715/205; 701/533

(57) ABSTRACT

There is provided an information processing apparatus including: a link information acquisition unit which acquires link information obtained by associating a reproduction location of contents with geographic information regarding geography associated with a story of the contents at the reproduction location; and a display control unit which performs control for displaying a geographic image based on the geographic information associated with the story of the contents being reproduced, based on the acquired link information and a reproduction location of the contents being reproduced.

### CROSS REFERENCE TO RELATED APPLICATIONS

This application claims the benefit of Japanese Priority Patent Application JP 2013-036533 filed Feb. 27, 2013, the entire contents of which are incorporated herein by reference.

### BACKGROUND

The present technology relates to an information processing apparatus. The technology relates particularly to an information processing apparatus which reproduces contents from different source, an information processing method, and a program which causes a computer to execute the method.

In recent years, data (electronic book) obtained by digitalizing a book such as a novel is reproduced in a personal computer or a portable information terminal (for example, a mobile phone or a tablet terminal). Accordingly, a user can store many books which ask for space in small cabinet, and has advantages such as high retrieval performance and the like.

To realize the aforementioned advantages, for example, there are proposed a server apparatus and an electronic device which easily introduce various information items to a user on the basis of the electronic book by providing various information items associated with the electronic book (for example, see Japanese Unexamined Patent Application Publication No. 2010-262441).

### SUMMARY

In the technology of the related art, it is possible to display associated information which is added to an information item (for example, sentence or image) designated by a user. By following a link to the other data included in the associated information, a user can easily access other various information items.

As described above, according to the technology of the related art, it is possible to easily access the other various information items. When reading a book (contents) such as a novel or a travel journal, a reader usually reads while imagining a place where the event in the book occurs. In this case, the reader sometimes searches the geographic information of the place from a map or the internet. However, if a user performs the search on the web, it takes a long time, in many cases.

At the time of reproducing the contents, it is convenient if it is possible for a user to easily acquire the geographic information associated with the contents.

It is desirable that a user easily acquires the geographic information associated with a story of contents being reproduced.

According to an embodiment of the present technology, there is provided an information processing apparatus, an information processing method, and a program which causes a computer to execute the method, the apparatus including: a link information acquisition unit which acquires link information obtained by associating a reproduction location of contents with geographic information regarding geography associated with a story of the contents at the reproduction location; and a display control unit which performs control for displaying a geographic image based on the geographic information associated with the story of the contents being reproduced, based on the acquired link information and the reproduction location of the contents being reproduced. Accordingly, by using the link information obtained by associating the reproduction location of contents with the geographic information regarding geography associated with a story of the contents at the reproduction location, a geographic image according to the geographic information associated with the story of the contents being reproduced can be displayed.

According to the embodiment of the present technology, the geographic information may include the latitude and the longitude, and the display control unit may perform control for displaying a map to which a reproduction location mark which is a mark showing a location on a map specified in the geographic information associated with the reproduction location being reproduced is attached, as the geographic image. Accordingly, the map to which the reproduction location mark which shows the location on the map specified in the geographic information associated with the reproduction location being reproduced is attached, can be displayed.

According to the embodiment of the present technology, the link information may further include a date and time associated with the geographic information, and the display control unit may perform control for displaying the date and time associated with the geographic information corresponding to a selected reproduction location mark, if any of the reproduction location mark is selected. Accordingly, the date and time associated with the geographic information corresponding to the selected reproduction location mark can be displayed.

According to the embodiment of the present technology, the display control unit may perform control for displaying the map to which an apparatus location mark which is a mark showing a location on a map at which the information processing apparatus exists is further attached. Accordingly, the map to which the apparatus location mark for specifying the location at which the information processing apparatus exists is further attached, can be displayed.

According to the embodiment of the present technology, the display control unit may perform control for displaying the map to which associated location information which is associated with the story of the contents and is regarding a feature on the map is further attached. Accordingly, the map to which the associated location information which is associated with the story of the contents and pertains to the feature on the map is further attached, can be displayed.

According to the embodiment of the present technology, the associated location information may be point-of-interest (POI) information, and the display control unit may perform control for displaying the map to which the associated location information is further attached, in a case where the display of the POI information is allowed. Accordingly, in a case where the display of the POI information is allowed, the map to which the associated location information is further attached, can be displayed.

According to the embodiment of the present technology, the display control unit may perform control for displaying the map to which an associated information mark which is a mark showing a location on a map at which the associated location information exists is further attached, and displaying associated location information at a location of the associated information mark, in a case where a distance between the reproduction location mark and the associated information mark is shorter than a set distance. Accordingly, in a case where the distance between the reproduction location mark and the associated information mark is shorter than the set distance, the associated location information at location with the third mark can be displayed.

According to the embodiment of the present technology, the information processing apparatus may further include: a reproduction history information acquisition unit which acquires reproduction history information showing whether or not the contents are reproduced; and a setting unit which sets a predetermined value to the set distance in a case where the reproduction history information shows that the contents are not reproduced, and sets a value greater than the predetermined value to the set distance in a case where the reproduction history information shows that the contents are reproduced. Accordingly, in a case where the contents are not reproduced, the predetermined value can be set to the set distance, and in a case where the contents are reproduced, the value greater than the predetermined value can be set to the set distance.

According to the embodiment of the present technology, the display control unit may attach and display a mark for specifying a reproduction location being reproduced, on a contents image based on the contents. Accordingly, the mark for specifying a reproduction location being reproduced can be displayed on the contents image.

According to the embodiment of the present technology, the display control unit may attach and display a mark for specifying a reproduction location associated with the geographic information in the link information, on a contents image based on the contents. Accordingly, a mark for specifying a reproduction location associated with the geographic information in the link information can be attached to the contents image.

According to the embodiment of the present technology, the contents may be data configured to have one or a plurality of text contents, image contents, and audio contents. Accordingly, the contents can be configured with one or the plurality of text contents, image contents, and audio contents.

According to the embodiment of the present technology, the geographic information may include the latitude and the longitude and information associated with a feature at a location specified in the latitude and the longitude. Accordingly, the latitude and the longitude and the information associated with the feature at a location specified in the coordinates can be included in the geographic information.

According to the embodiment of the present technology, the display control, unit may perform control, for displaying a virtual map to which the reproduction location mark showing a location on a virtual map specified in the geographic information associated with the reproduction location being reproduced and a mark showing that it is the virtual map are attached, as the geographic image. Accordingly, in a case of displaying the virtual map, the mark showing that it is the virtual map can be attached.

According to the embodiment of the present technology, the link information may include two geographic information items, and the display control unit may perform control for displaying the geographic image including one of the two geographic information items, and displaying the geographic image including the other one of the two geographic information items after displaying the geographic image including both of the two geographic information items. Accordingly, the geographic image including one of the two geographic information items can be displayed, and the geographic image including the other one of the two geographic information items can be displayed after displaying the geographic image including both of the two geographic information items.

According to the embodiment of the present technology, the link information may include two geographic information items, and the display control unit may perform control for displaying the geographic image including one of the two geographic information items and the geographic image including the other one of the two geographic information items at the same time. Accordingly, the geographic image including one of the two geographic information items and the geographic image including the other one of the two geographic information items can be displayed at the same time.

According to the embodiment of the present technology, the link information may include two geographic information items, and the display control unit may perform control for selecting and displaying any of the geographic image including one of the two geographic information items and the geographic image including the other one of the two geographic information items based on the user manipulation. Accordingly, any of the geographic image including one of the two geographic information items and the geographic image including the other one of the two geographic information items can be displayed based on the user manipulation.

According to the embodiment of the present technology, the geographic image may be an image obtained by combining a map image and a photograph image. Accordingly, the image obtained by combining the map image and the photograph image can be displayed.

According to the embodiment of the present technology, the information processing apparatus may further include a reproduction history information acquisition unit which acquires reproduction history information showing whether or not the contents are reproduced, and the display control unit may perform control for displaying the geographic image which is different from that of a case in which the reproduction history information shows that the contents are not reproduced, in a case in which the reproduction history information shows that the contents are reproduced. Accordingly, in a case in which the contents are reproduced, the geographic image which is different from that of a case in which the contents are not reproduced, can be displayed.

According to the embodiment of the present technology, the link information may further include a date and time associated with the geographic information, and the display control unit may perform control for selecting and displaying the geographic information based on a length of a period between a specified reference date and time and a date and time associated with the geographic information. Accordingly, the geographic information selected based on a length of she period between she reference date and time and the date and time associated with the geographic information can be displayed.

According to the embodiment of the present technology, the information processing apparatus may further include a cost acquisition unit which acquires individual cost which is cost necessary for movement from a specified reference location to a location shown by each of the geographic information items, for each geographic information item, and the display control unit may perform control for selecting and displaying the geographic information based on the individual cost. Accordingly, the geographic information selected based on the individual cost can be displayed.

According to the embodiment of the present technology, the display control unit may perform control for selecting and displaying the geographic information with the minimum individual cost. Accordingly, the geographic information with the minimum individual cost can be displayed.

According to the embodiment of the present technology, the link information may further include locations at apexes of a region having a predetermined shape surrounding each of the geographic information items corresponding to the contents as representative locations for each contents, and the cost acquisition unit may acquire representative cost which is cost necessary for movement from the reference location to the representative location for each contents, to acquire the individual cost of each of the geographic information items corresponding to the contents selected based on the representative cost. Accordingly, the individual cost of each of the geographic information items corresponding to the contents selected based on the representative cost can be acquired.

According to the embodiment of the present technology, she cost acquisition unit may acquire the individual cost obtained by performing weighting for each of the geographic information items using a preset weight coefficient. Accordingly, the individual cost obtained by performing weighting for each of the geographic information items using the preset weight coefficient can be acquired.

According to the embodiment of the present technology, the link information may further include a date and time associated with the geographic information, and the cost acquisition unit may acquire the individual cost obtained by performing weighting using a weight coefficient which is a value based on a length of a period between a specific reference date and time and the date and time associated with the geographic information. Accordingly, the individual cost obtained by performing weighting using the weight coefficient which is the value based on the length of a period between the specific reference date and time and thus, the date and time associated with the geographic information can be acquired.

According to the embodiment of the present technology, the display control, unit may perform control for executing a selection process which is a process of selecting and displaying each of the geographic information items having the individual cost smaller than a given value. Accordingly, each of the geographic information items having the individual cost smaller than a given value can be displayed.

According to the embodiment of the present technology, the information processing apparatus may further include a location acquisition unit which acquires the reference location a plurality of times, and the display control unit may execute the selection process again based on a new reference location, in a case where the new reference location which is different from the predetermined location is acquired after executing the selection process based on the reference location of the predetermined location. Accordingly, in a case where the new reference location which is different from the predetermined location is acquired after executing the selection process based on the reference location of the predetermined location, the selection process can be executed again based on the new reference location.

According to the embodiment of the present technology, when reproducing the contents, an excellent effect is obtained in which a user can easily acquire the geographic information associated with the story of the content being reproduced.

### BRIEF DESCRIPTION OF THE DRAWINGS

FIG. 1 is a block diagram showing an example of a functional configuration of a display device of a first embodiment of the present technology.

FIG. 2 is a block diagram showing an example of a functional configuration of a control, unit of the first embodiment of the present technology.

FIG. 3 is a diagram showing an example of display of contents and a scene location of a display device of the first embodiment of the present technology.

FIG. 4 is a diagram schematically showing data held in a memory unit of the first embodiment of the present technology.

FIG. 5 is a diagram schematically showing a relationship between a sentence location of the contents in which text is stored, and a scene location, in the first embodiment of the present technology.

FIG. 6 is a diagram schematically showing a relationship between a sentence location of contents in which an image data group is stored, and a scene location, in a first embodiment of the present technology.

FIG. 7 is a diagram schematically showing a relationship between a sentence location of contents in which audio is stored, and a scene location, in the first embodiment of the present technology.

FIGS. 8A and 8B are diagrams schematically showing a relationship between a sentence location of contents in which a image data group of a cartoon is stored, and a scene location, in the first embodiment of the present technology.

FIGS. 9A and 9B are diagrams schematically showing an example of information stored in location information link data held in a memory unit of the first embodiment of the present technology.

FIGS. 10A and 10B are diagrams schematically showing an example of display displaying contents on a display unit of the first embodiment of the present technology.

FIGS. 11A to 11C are diagrams schematically showing an example of an effect of the first embodiment of the present technology.

FIG. 12 is a flowchart showing a procedure example when performing scenario display and scene display by a display device of the first embodiment of the present technology.

FIG. 13 is a diagram schematically showing data held in a memory unit of a second embodiment of the present technology.

FIG. 14 is a diagram schematically showing an example of a setting screen (POI display setting screen) for setting presence or absence of display of POI data of scene display, in the second embodiment of the present technology.

FIG. 15 is a diagram schematically showing an example of an effect of the second embodiment of the present technology.

FIG. 16 is a different example from pop-up display of FIG. 14 regarding pop-up display for displaying POI information in the second embodiment of the present technology.

FIG. 17 is a flowchart showing a procedure example when performing scenario display and scene display by a display device of the second embodiment of the present technology.

FIG. 18 is a block diagram showing an example of a functional configuration of a display device of a third embodiment, of the present technology.

FIG. 19 is a diagram showing an example of scene display of the third embodiment of the present technology.

FIG. 20 is a diagram schematically showing an example of display when displaying a virtual map, as a modification example of the present technology.

FIG. 21 is a diagram schematically showing data held in a memory unit of a fourth embodiment of the present technology.

FIGS. 22A to 22C are diagrams showing an example of display of maps of the fourth embodiment of the present technology.

FIG. 23 is a flowchart showing a procedure example when performing scenario display and scene display by a display device of the fourth embodiment of the present technology.

FIG. 24 is a flowchart showing an example of a scene location display updating process of the fourth embodiment of the present technology.

FIG. 25 is a diagram showing an example of display of maps of a fifth embodiment of the present technology.

FIG. 26 is a flowchart showing an example of a scene location display updating process of the fifth embodiment of the present technology.

FIG. 27 is a diagram showing, an example of display of map of a modification example of the fifth embodiment of the present technology.

FIG. 28 is a diagram schematically showing data held in a memory unit of a sixth embodiment of the present technology.

FIGS. 29A to 29C are diagrams showing an example of display of maps of the sixth embodiment of the present technology.

FIG. 30 is a diagram schematically showing data held in a memory unit of a seventh embodiment of the present technology.

FIG. 31 is a diagram showing an example of reproduction history information held in a memory unit of the seventh embodiment of the present technology.

FIG. 32 is a block diagram showing an example of a functional configuration of a control unit of the seventh embodiment of the present technology.

FIG. 33 is a flowchart, showing a procedure example when performing scenario display and scene display by a display device of the seventh embodiment of the present technology.

FIG. 34 is a diagram schematically showing data held in a memory unit of an eighth embodiment of the present technology.

FIG. 35 is a block diagram showing an example of a functional configuration of a control unit of the eighth embodiment of the present technology.

FIGS. 36A to 36C are diagrams schematically showing an example of an effect of the eighth embodiment of the present technology.

FIG. 37 is a flowchart showing a procedure example when performing scenario display and scene display by a display device of the eighth embodiment of the present technology.

FIG. 38 is a flowchart showing an example of a distance setting process of the eighth embodiment of the present technology.

FIG. 39 is a diagram schematically showing an example of information stored in location information link data held in a memory unit of a ninth embodiment of the present technology.

FIG. 40 is a diagram showing an example of display of a date and time of the ninth embodiment of the present technology.

FIG. 41 is a flowchart showing a procedure example when performing scenario display and scene display by a display device of the ninth embodiment of the present technology.

FIG. 42 is a diagram schematically showing an example of display of a scene location of a modification example of the ninth embodiment, of the present technology.

FIG. 43 is a flowchart showing a procedure example when performing scenario display and scene display by a display device of a modification example of the ninth embodiment of the present technology.

FIG. 44 is a block diagram showing an example of a functional configuration of a control unit of a tenth embodiment of the present technology.

FIGS. 45A and 45B are diagrams schematically showing an example of display of a scene location of the tenth embodiment of the present technology.

FIG. 46 is a flowchart showing a procedure example when performing scenario display and scene display by a display device of the tend embodiment of the present technology.

FIG. 47 is a flowchart showing an example of a nearest scene location searching process of the tenth embodiment of the present technology.

FIG. 48 is a diagram schematically showing an example of information stored in location information link data held in a memory unit of a first modification of the tenth embodiment of the present technology.

FIG. 49 is a diagram showing an example of a calculating method of cost of the first modification example of the tenth embodiment of the present technology.

FIG. 50 is a flowchart showing an example of a nearest scene location searching process of the first modification example of the tenth embodiment of the present technology.

FIG. 51 is a diagram showing an example of a setting method of a weight coefficient of a second modification example of the tenth embodiment of the present technology.

FIG. 52 is a diagram schematically showing an example of information stored in location information link data held in a memory unit of the second modification example of the tenth embodiment of the present technology.

FIG. 53 is a flowchart showing an example of a nearest scene location searching process of the second modification example of the tenth embodiment of the present technology.

FIG. 54 is a flowchart showing a procedure example when performing scenario display and scene display by a display device of a third modification example of the tenth embodiment of the present technology.

FIG. 55 is a flowchart, showing an example of a nearest scene location searching process of the third modification example of the tenth embodiment of the present technology.

FIG. 56 is a diagram schematically showing an example of information stored in location information link data held in a memory unit of a fourth modification example of the tenth embodiment of the present technology.

FIG. 57 is a diagram showing an example of a representative location of the fourth modification example of the tenth embodiment of the present technology.

FIG. 58 is a flowchart showing an example of a nearest scene location searching process of the fourth modification example of the tenth embodiment of the present technology.

FIG. 59 is a flowchart showing a procedure example when performing scenario display and scene display by a display device of an eleventh embodiment of the present technology.

FIG. 60 is a flowchart showing an example of a scene location searching process in a given distance of the eleventh embodiment of the present technology.

FIG. 61 is a flowchart showing a procedure example when performing scenario display and scene display by a display device of a modification example of the eleventh embodiment of the present technology.

### DETAILED DESCRIPTION OF EMBODIMENTS

Hereinafter, embodiments for realizing the present technology (hereinafter, referred to as embodiments) will be described. The embodiments will be described with the following procedure.

1. First Embodiment (Display Control: Example of Displaying Location (Scene location) on Map Associated with Reproduction Location of Contents)
2. Second Embodiment (Display Control: Example of Displaying Scene location and POI Information)
3. Third Embodiment (Display Control: Example of Displaying Scene location and Current Location of User)
4. Fourth Embodiment (Display Control: Example of Displaying Map Including Scene location Before and After Change to Switch Map)
5. Fifth Embodiment (Display Control: Example of Displaying Plurality of Maps Including Scene location)
6. Sixth Embodiment (Display Control: Example of Overlapping and Displaying Map and Aerial Photograph Including Scene location)
7. Seventh Embodiment (Display Control: Example of Displaying Map and Scene location Based on Reproduction History Information)
8. Eighth Embodiment (Display Control: Example of Changing Set Distance Which Displays Scene location And POI Information Based on Reproduction History Information)
9. Ninth Embodiment (Display Control: Example of Displaying Date and Time and Scene location Associated with Scene location)
10. Tenth Embodiment (Display Control: Example of Displaying Scene location Nearest to Reference Location)
11. Eleventh Embodiment (Display Control: Example of Displaying Scene location in Given Distance from Reference Location)

### 1. First Embodiment

### Functional Configuration Example of Display Device

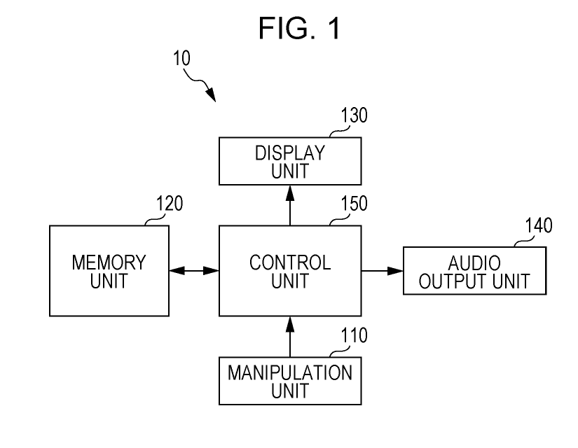

FIG. 1 is a block diagram showing an example of a functional configuration of a display device 10 of a first embodiment of the present technology.

FIG. 1 only shows the functional configuration based on operations by paying attention on display of contents and display of a location on a map associated with the contents.

The display device 10 is a device which reproduces digital contents (hereinafter, also simply referred to as contents) such as an electronic book or audio data, and includes a manipulation unit 110, a memory unit 120, a display unit 130, an audio output unit 140, and a control unit 150. The electronic book herein is data obtained by digitalizing publications such as a novel, a cartoon, a book, or a magazine. That is, the data of the electronic book may be a text only, an image only, or the combination of a text and an image.

The manipulation unit 110 receives manipulation input from a user, and when manipulation input from a user is received, the manipulation unit supplies a manipulation signal based on the manipulation input to the control unit 150.

The memory unit 120 holds data necessary for the display device 10 to reproduce contents. For example, the memory unit 120 holds contents which is a reproduction target. Hereinafter, the data in which the contents are stored is referred to as scenario data.

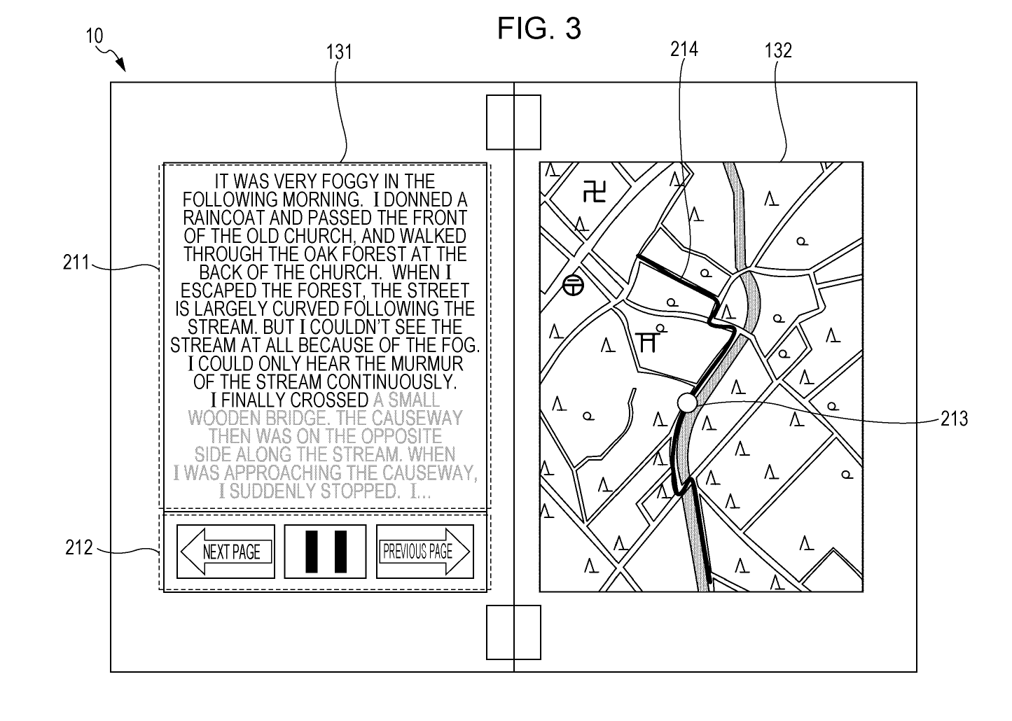

Since the display device 10 displays a display screen of a story of contents at a reproduction location (sentence location) and displays a screen (scene display screen) for displaying a location (scene location) on a map associated with the reproduction location, the memory unit 120 holds information necessary for the display of this location. In the first embodiment of the present technology, data held in the memory unit 120 as the necessary information will be described with reference to FIG. 3, and therefore the description is omitted herein.

As the memory unit 120, a removable recording medium (one or a plurality of recording media), for example, a disk such as a digital versatile disk (DVD) or a semiconductor memory such as a memory card can be used. In addition, the recording media may be embedded in the display device 10 or may be provided to be detachable from the display device 10.

The display unit 130 displays various information items to a user. The display unit 130 displays a display image of a story at a reproduction location of the contents which is being reproduced, or a display image of a scene location associated with this reproduction location. As the display unit 130, a display panel such as an organic electroluminescence (EL) panel, a liquid crystal display (LCD) panel, or the like can be used, for example.

The audio output unit 140 outputs audio based on audio data supplied from the control unit 150. This audio output unit 140 outputs audio at a reproduction location in a case where the story of the contents which is a reproduction target is audio data.

The control unit 150 controls each unit of the display device 10. For example, the control unit 150 is realized by a central processing unit (CPU), determines operation by performing a signal process of information supplied from each unit, and supplies information for performing the operation to each unit. In a case of reproducing contents (for example, electronic book) which is to be displayed on the display unit 130 and reproduced, the control unit 150 generates a display image of the reproduction location of the contents and a display image of a scene location of the reproduction location based on the various information items acquired from the memory unit 120 and supplies the display images to the display unit 130. In a case of reproducing contents which only outputs audio, the control unit 150 generates output data of audio and a display image of a scene location at a reproduction location of this audio file, based on various information items acquired from the memory unit 120, and supplies the output data and the display image to the audio output unit 140 and the display unit 130.

Functional Configuration Example of Control Unit

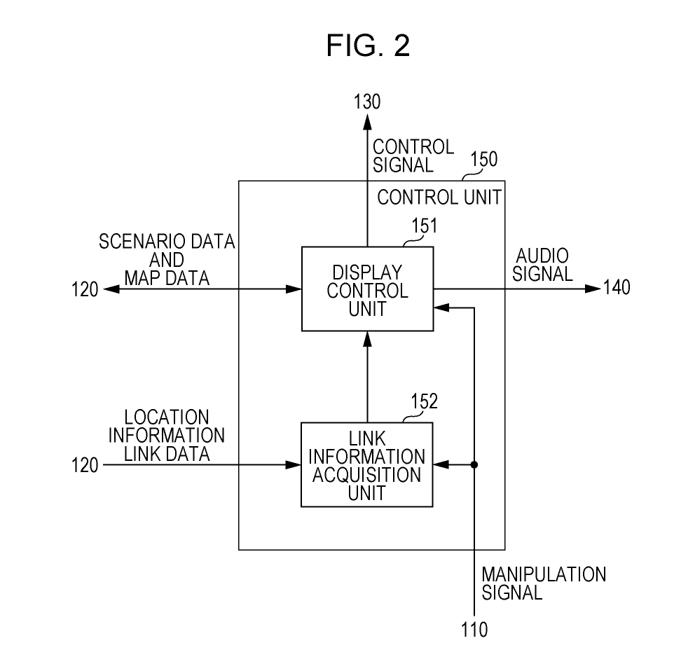

FIG. 2 is a block diagram showing an example of a functional configuration of the control unit 150 of the first embodiment of the present technology. The control unit 150 includes a display control unit 151 and a link information acquisition unit 152.

The link information acquisition unit 152 acquires location information link data. Herein, the location information link data is data for associating (linking) each reproduction location of the contents with a location (scene location) on a map. In a case of a plurality of contents items, the location information link data is stored in the memory unit 120 for each contents item. When a manipulation signal for designating the reproduction of the contents are received from the manipulation unit 110, the link information acquisition unit 152 reads out the location information link data corresponding to the contents from the memory unit 120. The link information acquisition unit 152 supplies the read-out location information link data to the display control unit 151.

The display control unit 151 displays a map corresponding to the scene locations of the contents being reproduced, based on the location information link data and the reproduction location of the content being reproduced. When the manipulation signal for designating the reproduction of the contents are received from the manipulation unit 110, the display control unit 151 starts reproduction of the contents. In a case where the contents includes image data and text data, the display control unit 151 controls the display unit 130 by a control signal and displays the story of the contents. On the other hand, in a case where the contents includes audio data, the display control unit 151 supplies an audio signal of the contents to the audio output unit 140.

In addition, the display control unit 151 temporarily holds the reproduction location of the content being reproduced in the memory unit 120. The display control unit 151 acquires the scene location corresponding to the reproduction location from the location information link data, and displays the map corresponding to the scene location on the display unit 130. In addition, the display control unit 151 displays the scene location on the displayed map using an icon or the like.

Example of Display Surface of Display Unit

FIG. 3 is a diagram showing an example of a display surface of the display device 10 of the first embodiment of the present technology.

Herein, the embodiment is described by assuming that the display device 10 includes two display screens.

The display device 10 includes two display screens (display screen 131 and display screen 132). The display screen 131 is a screen for displaying the content being reproduced and the display screen 132 is a screen for displaying the scene location. In FIG. 3, the embodiment is described by assuming that the text is displayed as the contents.

A region (contents display region 221) for displaying the contents are shown in the display screen 131. In addition, a region (manipulation button display region 222) for displaying manipulation buttons such as a proceeding button, a returning button, and a pausing button is shown in the display screen 131. Sentences of “Beautiful Village” written by Hori Tatsuo are shown in the contents display region 221 as the contents (same for drawings subsequent to FIG. 3). The display of the sentences displayed in the contents display region 221 proceeds by automatic progressing. The read sentences of the sentence displayed in the contents display region 221 are shown in black characters, and the unread sentences thereof are shown in gray characters.

On the display screen 132, a display screen (scene display screen) on which the scene location regarding the reproduction location (progressing location) of the content being reproducing which are displayed in the contents display region 221 of the display screen 131 is drawn on a map including the scene location is shown. On the display screen 132, the scene location corresponding to the progressing location (location of a boundary between the black character and the gray character) of the contents displayed in the contents display region 221 of the display screen 131 is shown by a circular icon (scene location icon 223). On the display screen 132, a line (movement route 224) showing a movement path of the scene location of the contents displayed in the contents display region 221 is shown on the drawn map.

As described above, the scene location regarding the reproduction location (progressing location) of the content being reproduced which are displayed in the contents display region 211 of the display screen 131 is displayed on the display screen 132.

In FIG. 3, the embodiment is described by assuming the case where the contents are the text data, however′, in a case where the contents are reading′ voice audio data, the manipulation button display region 222 may only be displayed.

Next, data held in the memory unit 120 will be described.

Example of Data Held in Memory Unit

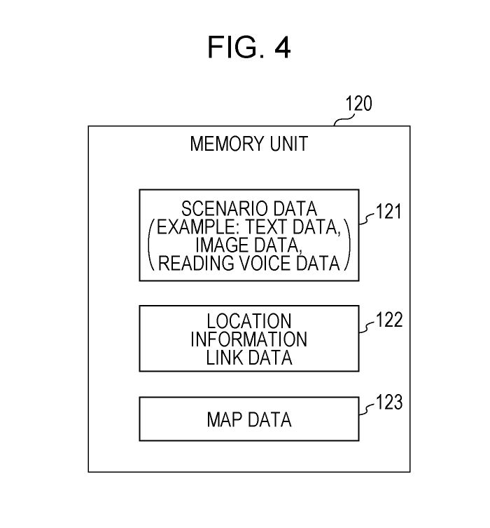

FIG. 4 is a diagram schematically showing data held in the memory unit 120 of the first embodiment of the present technology.

As shown in FIG. 4, scenario data 121, location information link, data 122, and map data 123 are held in the memory unit 120.

The scenario data 121 is file data of the contents. Text data is stored as a novel or the like, a group of image data (image data group) is stored as a cartoon or the like, and an audio file is stored as audio data such as a reading voice.

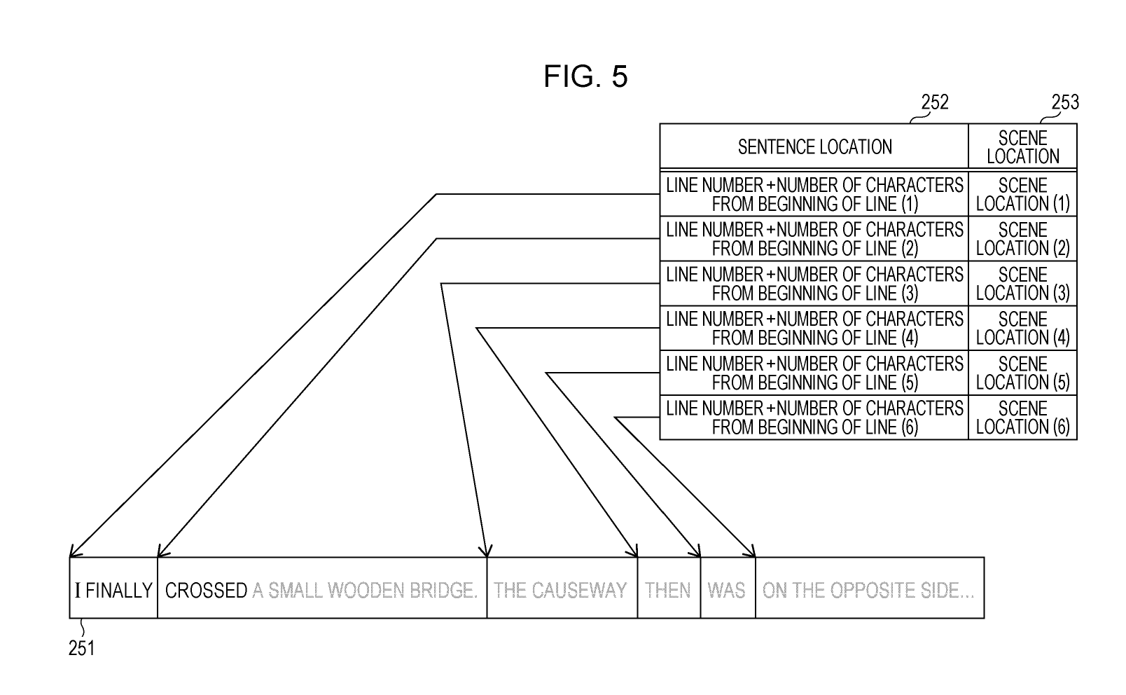

As described above, the location information link data 122 is data for associating (linking) each reproduction location of the contents stored in the scenario data 121 with the location (scene location) on the map of the map data 123. That is, the location information link data 122 is prepared for each scenario data item 121, in a case of the plurality of scenario data items 121. The location information link data 122 will be described with reference to FIGS. 5 to 9B, and therefore the specific description thereof is omitted herein.

The map data 123 is data for displaying a map on the display screen 132, and stores data regarding a map of Japan, for example. An example of preparing data for a plurality of periods for the map is considered, however, herein, for the convenience of description, the embodiment is described by assuming that data of one (current) map is held.

In the embodiment of the present technology, an example of using each data item which is stored in the memory unit 120 provided in the display device 10 is described, however, the description is not limited thereto, and all data items or a part of data items may be sequentially acquired from a server by using a communication unit of the display device 10.

Next, the location information link data 122 will be described. First, the relationship between the reproduction location (sentence location) of the scenario data 121 and the scene location will, be described with reference to FIGS. 5 to 8B by assuming a different plural types of scenarios (contents).

Related Example of Sentence Location of Contents of Text and Scene Location

FIG. 5 is a diagram schematically showing a relationship between the sentence location of the contents in which the text is stored, and the scene location in the first embodiment of the present technology.

FIG. 5 shows a rectangle (text data 251) to which sentences schematically showing the contents (scenario data 121) in which the text is stored, are attached, and a table schematically showing the sentence location and the scene location of the location information link data 122. This table shows a column (column 252) showing the sentence locations and a column (column 253) showing the scene locations, and the column 252 shows that the sentence locations are designated by the line number and the number of characters (character location) from the beginning of the line.

As described above, in a case of designating the sentence location of the text data, since the sentence is configured with a sentence line configured of a plurality of characters, the sentence location can be designated by the line number and the number of characters from the beginning of the line.

In FIG. 5, the example of designating the sentence location by the line number and the number of characters from the beginning of the line is described, however it is not limited thereto. In addition thereto, a method of designating the sentence location by the paragraph number and the number of characters from the beginning of the paragraph, or a method of designating the sentence location by the page number and the number of characters from the beginning of the page can be considered.

Related Example of Sentence Location of Contents of Image Data Group and Scene Location

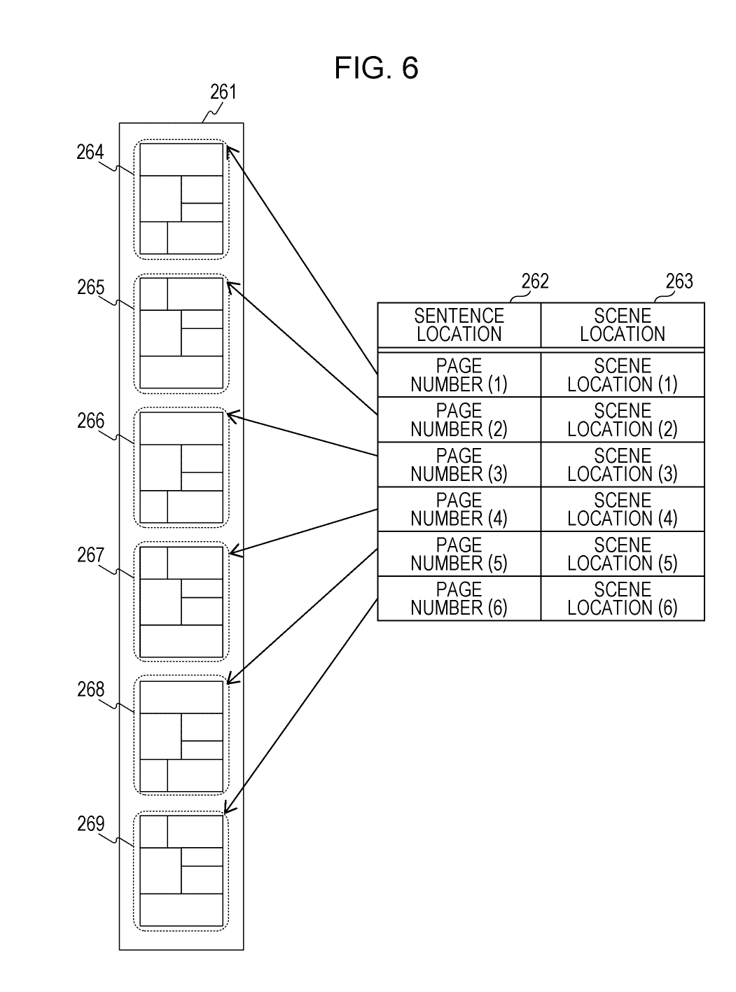

FIG. 6 is a diagram schematically showing a relationship between the sentence location of the contents in which the image data group is stored, and the scene location, in the first embodiment of the present technology.

FIG. 6 shows a rectangle (image group 261) schematically showing the contents (scenario data 121) in which a series of six images (image 264 to image 269) are stored as an image data group, and the sentence location and the scene location of the location information link data 122. This table shows a column (column 262) showing the sentence locations and a column (column 263) showing the scene locations, and the column 262 shows that the sentence locations are designated by the number (page number) of images from the first image.

As described above, in a case of designating the sentence location in the image data group configured with the plurality of images, the sentence location can be designated by the number (page number) of images from the first image.

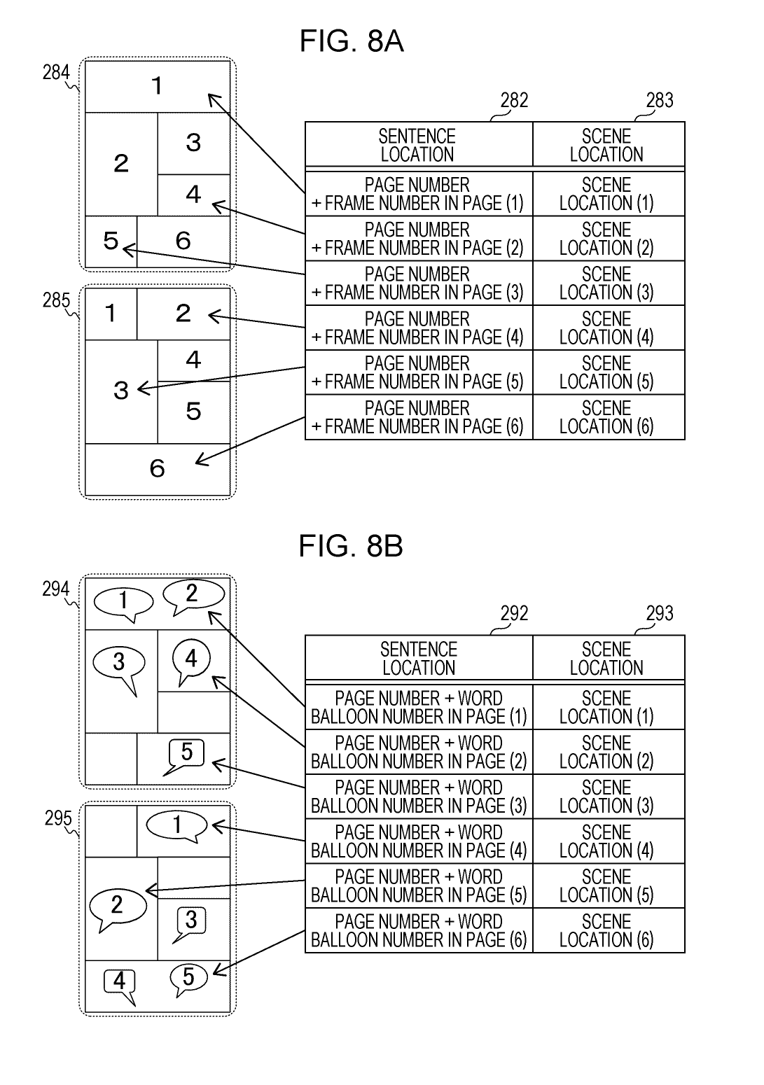

In FIG. 6, the drawing in which a plurality of frames are assumed to be in one image (for example, a cartoon) is shown, however, the designation of the sentence location by the page number can be also executed in a case with no plurality of frames (for example, an illustrated book). In a case where the plurality of frames are in one image, the designation of the sentence location for each frame is also considered, and this example will be described in FIGS. 8A and 8B.

Related Example of Sentence Location of Contents of Audio and Scene Location

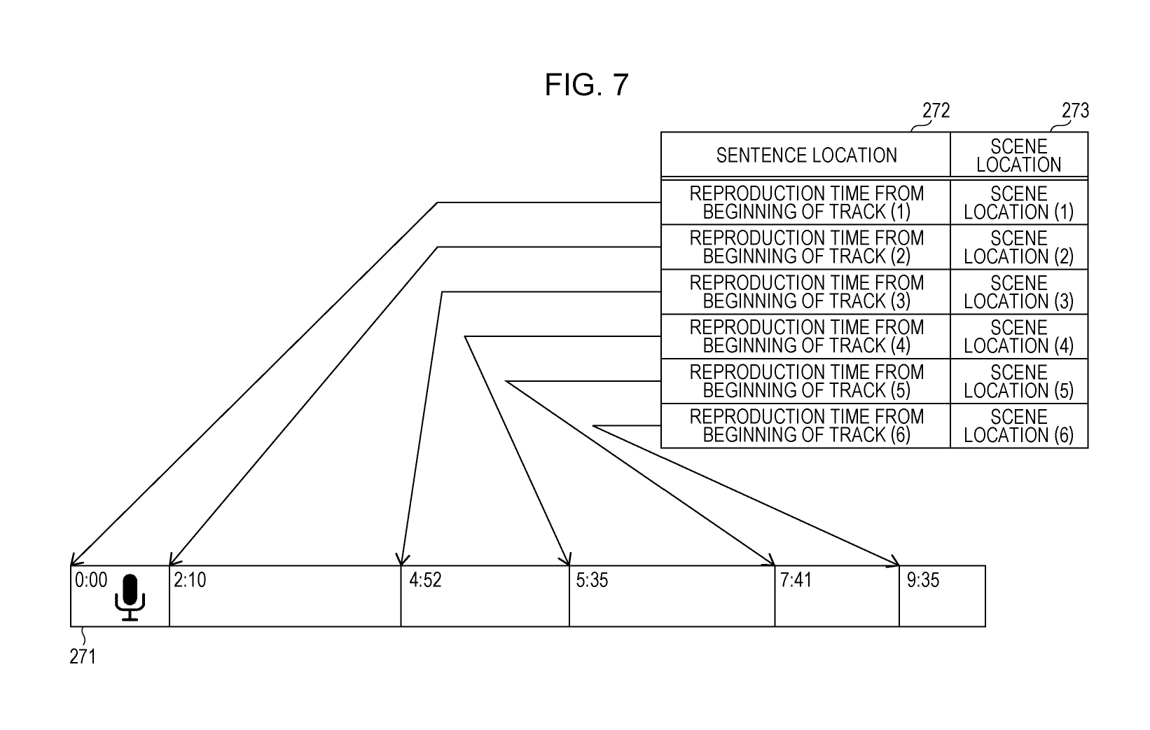

FIG. 7 is a diagram schematically showing a relationship between the sentence location of the contents in which the audio is stored, and the scene location, in the first embodiment of the present technology.

FIG. 7 shows a rectangle (audio data 271) schematically showing the contents (scenario data 121) in which the audio is stored, and a table schematically showing the sentence location and the scene location of the location information link data 122. This table shows a column (column 272) showing the sentence locations and a column (column 273) showing the scene locations, and the column 272 shows that the sentence location is designated by the elapsed time (reproduction time) from the beginning of the audio data (track).

As described above, in a case of designating the sentence location of the audio data, the sentence location can be designated by the reproduction time of the audio data. Related example of Sentence Location of Image Data Group of Cartoon and Scene location

FIGS. 8A and 8B are diagrams schematically showing a relationship between the sentence location of the contents in which the image data group of a cartoon is stored, and the scene location in the first embodiment of the present technology.

FIG. 8A shows an example of designating the sentence location of the cartoon by the number (page number) of images from the first image and the frame number in the page, and FIG. 8B shows an example of designating sentence location of the cartoon by the page number and the word balloon number in the page.

FIG. 8A shows two images (image 281 and image 285) of the cartoon, and a table schematically showing the sentence location and the scene location of the location information link data 122. This table shows a column (column 282) showing the sentence locations and a column (column 283) showing the scene locations, and the column 282 shows that the sentence locations are designated by the number (page number) of images from the first image and the frame number in the page.

As shown in FIG. 8A, the page of the cartoon is divided into a plurality of regions which is called the “frames”, as well as being called the “frame division”, and the story progresses in a unit of the frame. Accordingly, by numbering the frames of each page in progressing sequence and storing the information regarding the numbering in the scenario data 121, the sentence location can be designated in the frame unit to be associated with the scene location.

FIG. 8B shows two images (image 294 and image 295) of the cartoon, and a table schematically showing the sentence location and the scene location of de location information link data 122. This table shows a column (column 292) showing the sentence locations and a column (column 293) showing the scene locations, and the column 292 shows that the sentence locations are designated by the number (page number) of images from the first image and the word balloon number in the page.

As shown in FIG. 8B, in the cartoon, the words of the characters are shown as the “word balloons”, and the story progresses through the words disclosed in the “word balloons”. Accordingly, by numbering the word balloons of each page in progressing sequence and storing the information regarding the numbering in the scenario data 121, the sentence location can be designated in the word balloon unit to be associated with the scene location.

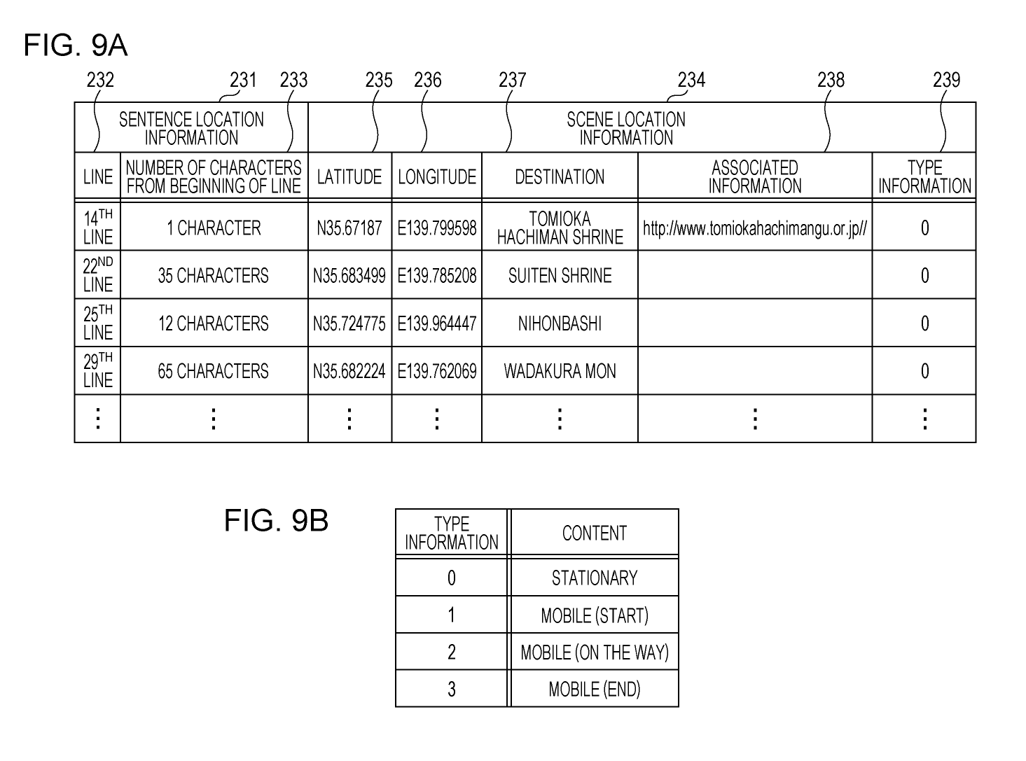

Next, the information stored in the location information link data will be described with reference to FIGS. 9A and 9B.

Example of Location Information Link Data

FIGS. 9A and 9B are diagrams schematically showing an example of information stored in the location information link data held in the memory unit 120 of the first embodiment of the present technology.

FIG. 9A shows a table showing an example of the information stored in the location information link data, and FIG. 9B shows a table for describing information types of the information items stored in the location information link data.

In FIG. 9A, the embodiment will be described by assuming the location information link data with respect to the contents (scenario data) in which the text is stored.

As shown in FIG. 9A, sentence location information (column 231) which is information showing the sentence locations, and scene location information (column 234) which is information regarding the scene locations are associated with each other in the location information link data. Since the information items are location information link data items with respect to the scenario data in which the text is stored, the line numbers (column 232) and the number of characters from the beginning of the line (column 233) are stored as the sentence location information (column 231).

In addition, the latitude (column 235), the longitude (column 236), a destination (column 237), the associated information (column 238), and an information type (column 239) are stored in the scene location information (column 234).

The latitude (column 235) and the longitude (column 236) are necessary information at the very least as the scene location information, and the location on the map is specified with these.

The destination (column 237) is a destination of a spot specified in the latitude (column 235) and the longitude (column 236), and the associated information (column 238) is additional information regarding the spot specified in the latitude (column 235) and the longitude (column 236). The destination (column 237) and the associated information (column 238) are not compulsory information items, and are not stored in a case without any information. The destination and the associated information are displayed in a pop-up manner on a side of an icon (see scene location icon 223 of FIG. 3) showing the spot specified in the latitude and the longitude.

The information type (column 239) is information for identifying a type of scene location information to which this information type belongs. There are two types of scene location information, and one of the types is she scene location information (stationary type) which is not associated with the scene location information of the previous and next sentence locations and independently showing each location. The other type thereof is the scene location information (mobile type) which is continued with the scene location information of the previous and next sentence locations and shows a linear movement path by the plurality of continued scene location information items. By storing the information type (column 239) showing the type of the scene location information as the scene location information, a movement route can be drawn on the map or the scene location and can be gradually moved on the drawn movement route.

Herein, an example of the information type will be described with reference to FIG. 9B.

FIG. 9B shows a table showing four values (0 to 3) which are stored as the information types, and the meaning (contents) of the four values. In a case where the value is it denotes the stationary type, and the movement route is not drawn. In a case where the value is “1”, it denotes a start location of the mobile type, and in a case where the sentence location associated with the scene location information in which this value is stored is reproduced, the movement route is created based on the scene location information continued to the end location (information in which the value of the information type is “3”) of the mobile type and the movement route is drawn on the map. In addition, in a case where the value is “2”, it denotes an on-the-way location of the mobile type, and in a case where the value is “3”, it denotes an end location of the mobile type.

As described above, the location information link data has a data structure in which the plurality of the sentence location information items, and the scene location information items associated with this sentence location information are stored based on the number of sentence locations. That is, in the location information link data, the plurality of sentence locations (reproduction locations) of the contents and the information items (information items regarding geography) regarding the locations on the map associated with the sentence locations are associated with each other and are stored.

The scene location information items shown in FIGS. 9A and 9B are one example, and the other information may be additionally stored based on the purpose of the location information link data. For example, by storing the information regarding a display magnification of the map, the display of the map can be finely controlled.

In addition, when using the plurality of maps (for example, when using maps for each period (1900s, 1600s, and the like)), by storing the information for specifying the maps in use, the plurality of maps can be easily divided and used.

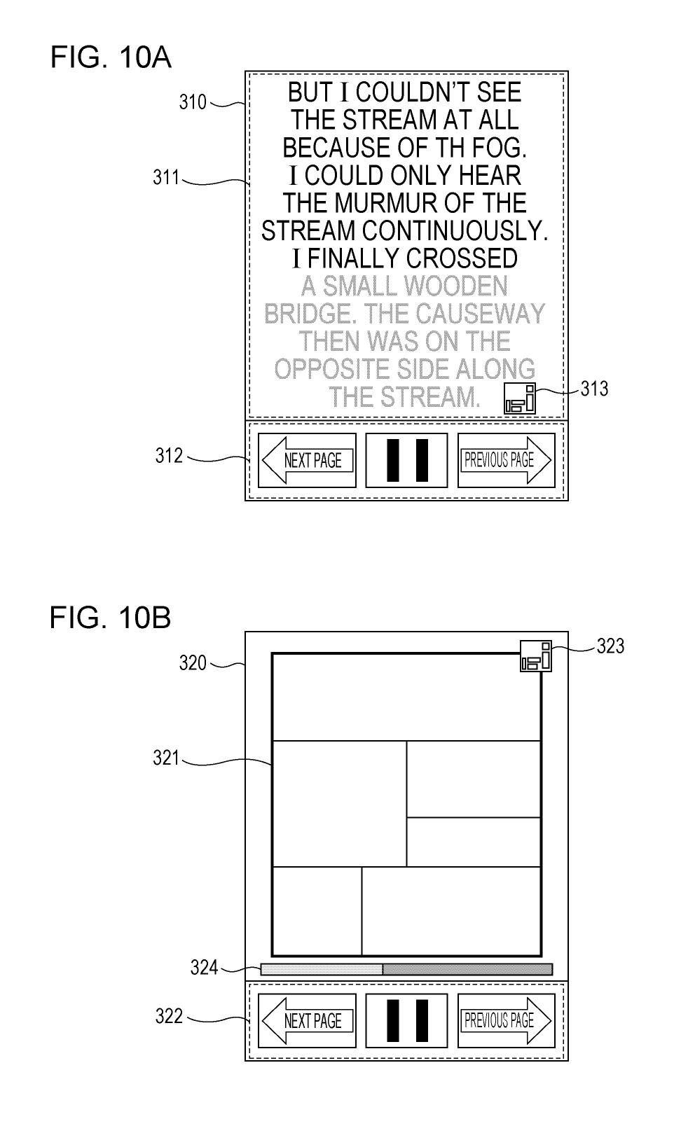

Next, a display example of the contents will be described with reference to FIGS. 10A and 10B by assuming the contents of text and the contents of the cartoon.

Display Example of Contents

FIGS. 10A and 10B are diagrams schematically showing an example of the display when displaying the contents on the display unit 130 of the first embodiment of the present technology.

FIG. 10A shows a display example of the contents of the text, and FIG. 10B shows a display example of the contents of the cartoon.

FIG. 10A shows a display region (contents display region 311) of the text data and a region (manipulation button display region 312) for displaying manipulation buttons, in a screen (display screen 310) for displaying the contents. An icon (icon 313) for notifying that the scene location information is associated with the sentence being displayed is shown in the contents display region 311.

The components other than the icon 313 correspond to the components shown in the display screen 131 of FIG. 3, and therefore the specific description thereof is omitted herein. By displaying a mark showing that there is the scene location information as the icon 313, the presence of the scene location information can be notified to a user.

FIG. 10A shows an example of differentiating the read portion and the unread portion with colors of the text, however other various methods are considered as the differentiating method. For example, a method of displaying an icon next to the text at the location (progressing location) being reproducing of the scenario and moving the location of the icon with the progressing of the scenario. In addition, a method of changing only the characters at the progressing location of the scenario, changing the character size or character font, or moving the location of the changed character with the progressing of the scenario is considered.

FIG. 10B shows a display region (contents display region 321) of the cartoon (imaged data group) and a region (manipulation button display region 322) for displaying manipulation buttons, in a screen (display screen 320) displaying the screen. Bar display (progress bar 324) for notifying a progressing state of the scenario of the image data displayed in the contents display region 321 is shown in the display screen 320. In addition, an icon (icon 323) for notifying that the scene location information is associated with the image data being displayed is shown in the contents display region 321.

The components other than the progress bar 324 shown in FIG. 10B correspond no the components shown in FIG. 10A, and therefore the description is omitted, and the attention is paid on the progress bar 324 to be described.

A length of the progress bar 324 is sequentially updated based on the progress of the scenario of the image data displayed in the contents display region 321. Accordingly, the progressing state of the scenario can be notified to a user. That is, by displaying the progress bar 324, even in a case where it is difficult to indicate the reproduction location (progressing location) being reproduced in the page as the image data, the progressing state of the scenario can be notified.

The progress bar 324 is not limited to the bar display, and a pie chart or a remaining amount of a sandglass mark can be displayed, for example.

In addition to the example shown in FIG. 10B, when the progressing is performed with the image in a frame unit or a word balloon unit of the cartoon (when the frame number or the word balloon number are stored in the scenario data), in the same manner as the example of the contents of the text of FIG. 10A, a method of changing the colors of the read portion and unread portion is considered. Alternatively, a method of changing the display colors for only the frame and the word balloon corresponding to the progressing location of the scenario or performing the popping display is also considered.

### Effect Example

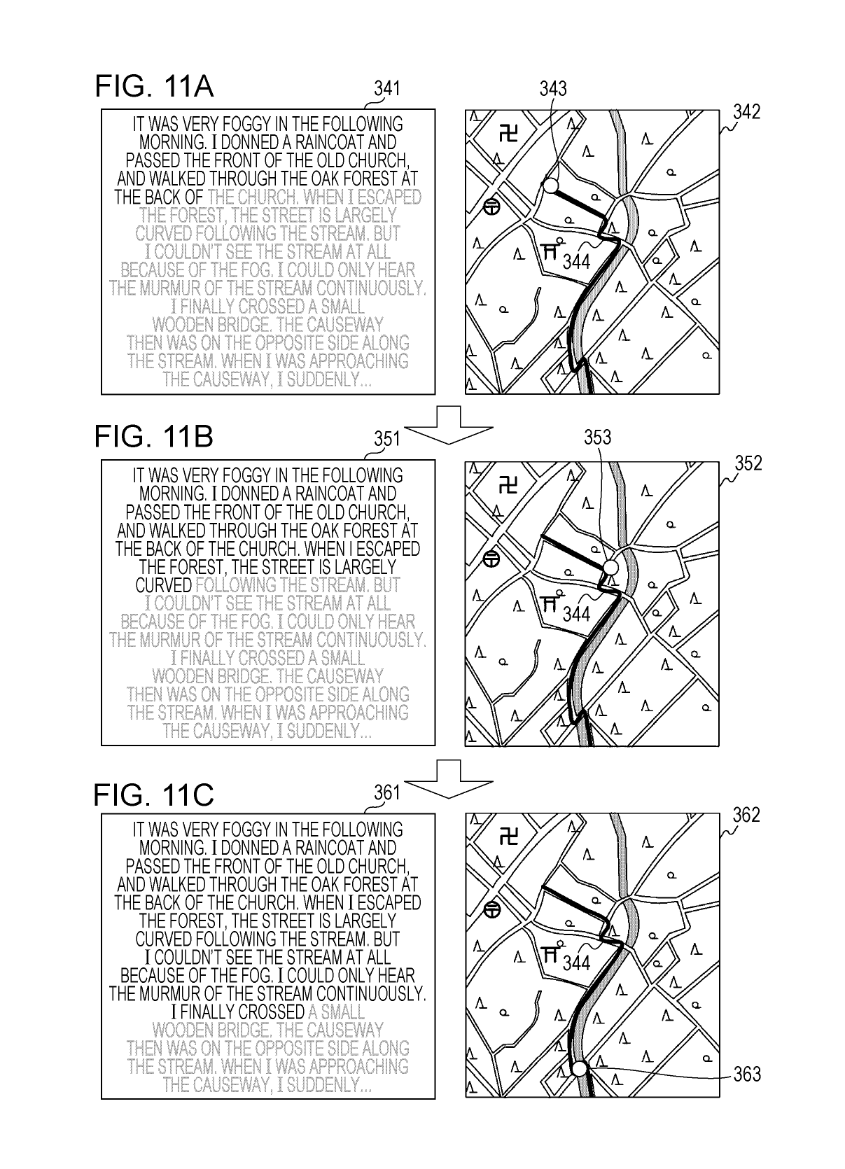

FIGS. 11A to 11C are diagrams schematically showing an example of an effect of the first embodiment of the present technology.

In FIGS. 11A to 11C, a relationship between the progress of the scenario and transition of the display of the scene location will be described using the contents of the text shown in FIG. 2.

The embodiment of the FIGS. 11A to 11C will be described by assuming that the scenario progresses from a state shown in FIG. 11A to a state shown in FIG. 11B, and then the scenario progresses from a state shown in FIG. 11B to a state shown in FIG. 11C.

In the same manner as described above, the black characters of the sentences (sentences 341, sentences 351, and sentences 361) displayed in FIGS. 11A to 11C show the read portion and the gray characters thereof show the unread portions.

In the sentences 341 of FIG. 11A, the characters from the beginning to the middle part of the fifth line in the sentences 341 are shown in black. On a screen (display screen 342) on which the map of FIG. 11A is displayed, an icon (scene location icon 343) showing a location on the may corresponding to the reading voice location of the contents are shown at a start location of a line (movement route 344) showing a movement route of the scene location.

In the sentences 351 of FIG. 11B, the scenario progresses further than the sentences 341, and the characters from the beginning to the middle part of the seventh line in the sentences 351 are shown in black. On a display screen 352, a scene location icon 353 is shown at a location which is obtained by moving from the start location on the movement route 344 and making a curve from a straight street from the start location.

In the sentences 361 of FIG. 11C, the scenario progresses further than the sentences 351, and the characters from the beginning to the middle part of the eleventh line in the sentences 361 are shown in black. On a display screen 362 of FIG. 11C, a scene location icon 363 is shown at a location obtained by further proceeding from the location shown by the scene location icon 353 of FIG. 11B on the movement route 344 and crossing downstream on the display screen 362.

As described above, by using the location information link data corresponding to the contents (scenario data), the location display (scene display) on the map associated with the scenario can be updated based on the progress of the scenario.

Operation Example of Display Device

Next, the operation of the display device 10 of the first embodiment of the present technology will be described with reference to the drawing.

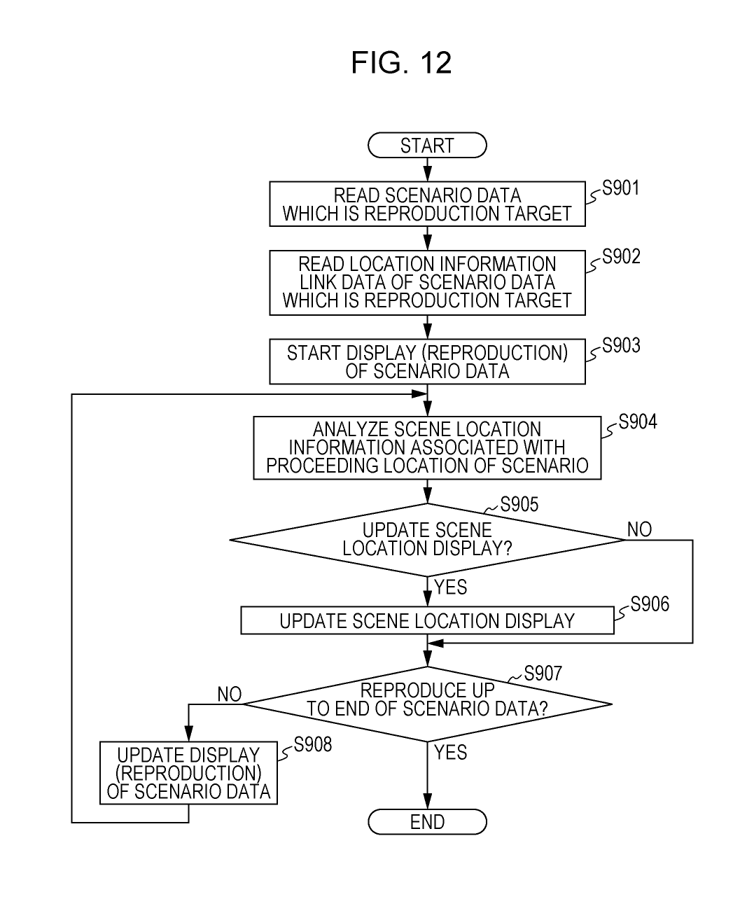

FIG. 12 is a flowchart showing a procedure example when performing the scenario display and the scene display by the display device 10 of the first embodiment of the present technology.

The flowchart shown in FIG. 12 shows a procedure after a user selects the contents (scenario data) which are a reproduction target.

First, the scenario data which is a reproduction target is read out from the memory unit 120 by the control unit 150 (Step S901). Then, the location information link data corresponding to the read-out scenario data is read out from the memory unit 120 by the control unit 150 (Step S902). Step S902 is an example of an acquisition procedure according to claims of the present technology.

After that, display (reproduction) of the scenario data on the display unit 130 is started by the control unit 150 based on the read-out scenario data (Step S903).

The scene location information associated with the sentence location corresponding to the reproduction location (progressing location) being reproduced of the scenario is acquired from the read-out location information link data, and the acquired scene location information is analyzed by the control unit 150 (Step S904). Then, the control unit 150 determines whether or not to update scene display which is displayed on the display unit 130 based on the analyzed result of the scene location information (Step S905). In a case where it is determined not to update the scene display (Step S905), the process proceeds to Step S907.

On the other hand, in a case where it is determined update the scene display (Step S905), the scene display is updated (Step S906). The case in which it is determined to update the scene display in Step S905 corresponds to a case in which the scene location information which is an analysis target is switched to the scene location information at the next sentence location based on the progressing of the scenario. In addition, in Step S906, in a case where the scene location information is switched to the stationary type scene location information, the map which is displayed with the scene location is also updated. In a case where the scene location information is switched to the start type scene location information among the mobile type scene location information items, the icon, the movement route, and the map showing the scene location are updated. In a case where the scene location information is switched to the on-the-way type and the end type scene location information items among the mobile type scene location information items, only the location on the map of the icon showing the scene location is updated. Step S906 is an example of a control procedure according to claims of the present technology.

After that, the control unit 150 determines whether or not the scenario data which is a reproduction target is reproduced to the end thereof (Step S907), and in a case where it is determined that the scenario data is reproduced to the end thereof, the procedure of the scenario display and the scene display ends.

On the other hand, in a case where it is determined that the scenario data is not reproduced to the end thereof (Step S907) the display of the scenario data is updated (Step S908), and the process returns to Step S904.

As described above, according to the first embodiment of the present technology, by updating the scene display based on the progress of the contents using the location information link data, a user can easily acquire the geographic information associated with the story of the content being reproduced.

In Step S905 and Step S906 of FIG. 12, it is assumed that the display is updated by the switching of the scene location information, however it is not limited thereto. For example, when the mobile type scene location information is an analysis target, although the scene location information is not changed, the location of the scene location icon of the scene display may be updated based on the progress of the scenario, so as to gradually move the icon on the movement route drawn on the map until the scene location information becomes the scene location information having the information type showing the end spot of the mobile type.

### 2. Second Embodiment

In the first embodiment of the present technology, the example of displaying the scene location corresponding to the progressing location of the scenario (contents) on the map is described. The basic geographic information of that place is displayed in the displayed map. If the additional information (associated information) regarding that place is displayed based on user's preference, not only the basic geographic information, but also the convenience in accessing the contents is further improved.

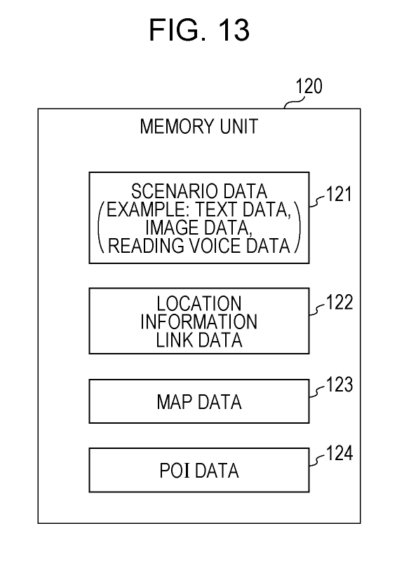

Herein, in a second embodiment of the present technology, an example of displaying the scene location on the map and also displaying the associated information of that place will be described with reference to FIGS. 13 to 17.

Example of Data Held in Memory Unit

FIG. 13 is a diagram schematically showing data held in the memory unit 120 of the second embodiment of the present technology.

The configuration diagram of the second embodiment of the present technology is the same as the configuration diagram of the display device 10 shown in FIG. 1. However, in the second embodiment of the present technology, the data held in the memory unit 120 is different from the first embodiment of the present technology. Accordingly, the description of the configuration diagram is omitted herein with reference to FIG. 1.

The scenario data 121, the location information link data 122, the map data 123, and the point-of-interest (POI) data 124 are held in the memory unit 120 of the second embodiment of the present technology. The data items other than the POI data 124 are the same as each data item shown in FIG. 4, and therefore the description thereof is omitted herein.

The POI data 124 is information in which information (POI information) obtained by associating a location (spot) gleaned based on a predetermined theme, with information regarding that location is stored. The various themes are considered as the predetermined theme, however, the second embodiment of the present technology will be described by assuming that four POI data items are held in the memory unit 120. One of the four POI data items is POI data prepared for each scenario data item 121, and is POI data obtained by associating geographic location information of a spot (feature on map) associated with the story of the contents of the scenario data 121 with information for describing this spot. The POI data 124 is information corresponding to POI data of a general map display software, and by previously setting the POI data to be displayed by a user, the information that a user wants to add is added in the map display.

In FIG. 13, an example of holding the POI data 124 as independent information, however, it is not limited thereto. The POI data which is prepared as the dedicated POI data for each scenario data item, may be stored in the location information link data 122 so as to be differentiated from the original, location information link data.

Example of Setting Screen of Display of POI Data

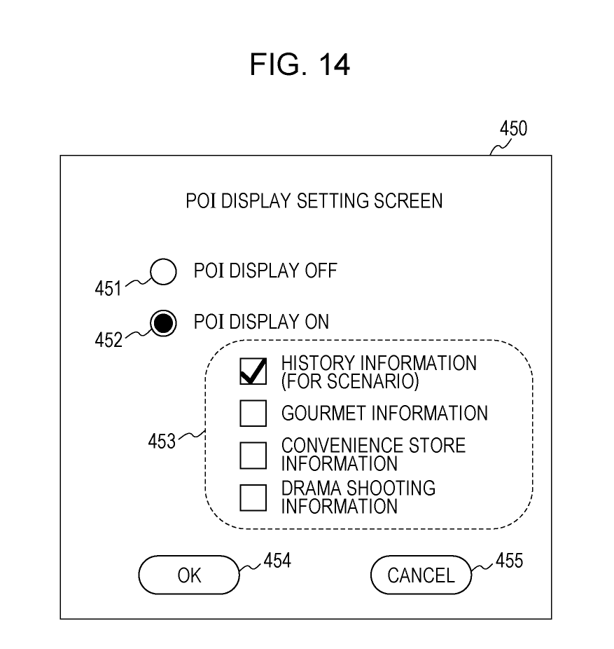

FIG. 14 is a diagram schematically showing an example of a setting screen (POI display setting screen) for setting presence or absence of display of the POI data of the scene display, in the second embodiment of the present technology.

Two radio buttons (radio button 451 and radio button 452) for setting the turning on or off of the POI display are shown on the POI display setting screen (display screen 450) shown in FIG. 14. On the display screen 450, in a case where the radio button (radio button 452) for turning on the POI display is selected, four check buttons (check button group 453) for selecting the POI data to be displayed are shown. On the display screen 450, a button (OK button 454) for determining the selection of the display screen 450 and a button (Cancel button 455) for canceling the selection of the display screen 450 are shown.

As our POI data items, information (history information) regarding a historical building, information (gourmet information) regarding gourmet, information (convenience store information) regarding a convenience store, and information (drama shooting information) regarding drama shooting spot are shown in FIG. 14. Herein, the history information is set to the dedicated POI data of the scenario data which is a reproduction target.

For example, if the OK button 454 is pressed after selecting the radio button (radio button 451) for turning off the POI display, no POI information is displayed in the scene display.

In addition, after selecting the radio button (radio button 452) for turning on the POI display, if the POI information desired to be displayed is checked in the check button group 453 and the OK button 454 is pressed, the checked POI information is displayed in the scene display.

By displaying the screen for setting presence or absence of the display of the POI data shown in the display screen 450 after selecting the contents (scenario data) which is a reproduction target, the display of the POI information of the scene display can be set.

### Effect Example

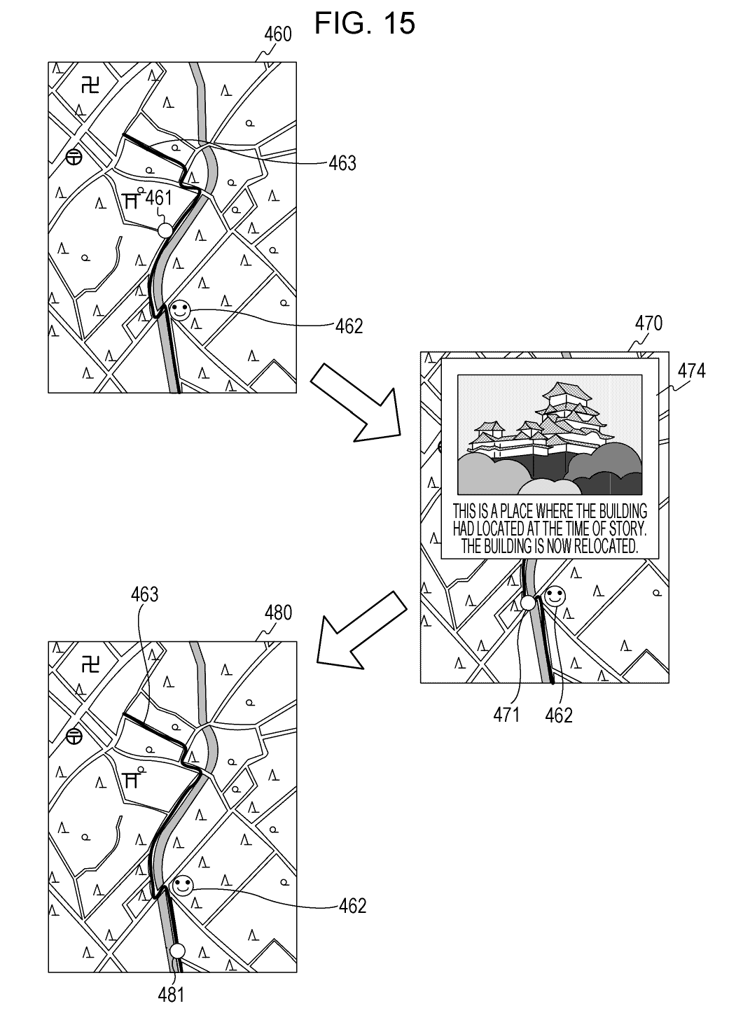

FIG. 15 is a diagram schematically showing an example of an effect of the second embodiment of the present technology.

In FIG. 15, an example of displaying POI information of a location when a scene location icon approaches a vicinity of a location at which information is present in the POI data, will be described.

Three display screens (display screens 460, 470, and 480) which show timing at which the POI information is displayed, and the display before and after this timing are shown in FIG. 15.

On the display screen 460, the scene display at the timing before the progressing location (scene location icon) of the scenario shown on the map enters a range of a set distance which is previously set, from the location of the POI information, is shown. A movement route 463 and a scene location icon 461 shown on the display screen 460 correspond to the movement route and the scene display icon shown in FIG. 3 or FIGS. 11A to 110, and therefore the description thereof is omitted herein. An icon (POI information icon 462) showing the location at which the POI information is present, is shown on the display screen 460.

As shown on the display screen 460, in a case where the scene location icon 461 is absent within the range of the set distance (for example, range of distance from location of POI information icon 462 to have a size of two icons) from the POI information icon 462, the POI information including the POI information icon 462 is not displayed.

On the display screen 470, a display screen at the timing at which the scene location icon enters the range of the set distance from the location of the POI information is shown. On the display screen 470, the scene location icon 471 is present in the range of the set distance from the POI information icon 462, and the POI information at the location of the POI information icon 462 is displayed in a pop-up manner (pop-up display 474).

On the display screen 480, a display screen at timing at which the scene location icon comes out from the range of the set distance after entering the range of the set distance from the location of the POI information, is shown. On the display screen 480, since a scene location icon 481 is separated from the POI information icon 462 further than the set distance, the pop-up display 474 shown in the display screen 470 is removed.

As described above, the POI data is held in the memory unit 120, and accordingly the additional information regarding the place in the vicinity of the scene location can be displayed based on user's preference.

In FIG. 15, the example of the pop-up display of the POI information in a case where the scene location icon enters the range of the set distance from the POI information icon is described, however, it is not limited thereto. For example, the POI information may be displayed all the time.

In FIG. 15, the pop-up display 474 is described by assuming the example of simply displaying only the additional information, however, the various examples of the contents of the pop-up display 474 are considered. For example, in a case where the information regarding the link is held in the POI data, it is considered to display a button for causing the link to function, in the pop-up display 474.

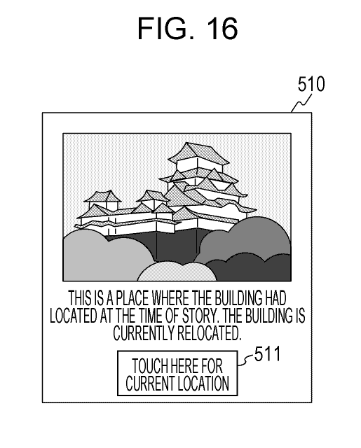

FIG. 16 is an example different from the pop-up display 474 of FIG. 15 regarding the pop-up display for displaying the POI information in the second embodiment of the present technology.

In pop-up display (pop-up display 510) shown in FIG. 16, a link button 511 is shown in addition to the POI information shown in the pop-up display 474 of FIG. 15.

The link button 511 is a button for displaying the associated information (associated. POI information) with other physical location information associated with the information notified to a user in the pop-up display 510. When the link button 511 is pressed, on the basis of the associated POI information, a map of the location indicated by the associated POI information is displayed, or information stored in the associated POI information is displayed. As described above, the location can be further moved, and accordingly, it is easy to access the location in a case where the building at the time of the scenario is currently moved to another spot, for example.

Operation Example of Display Device

The operation of the display device of the second embodiment of the present technology will be described with reference to the drawing.

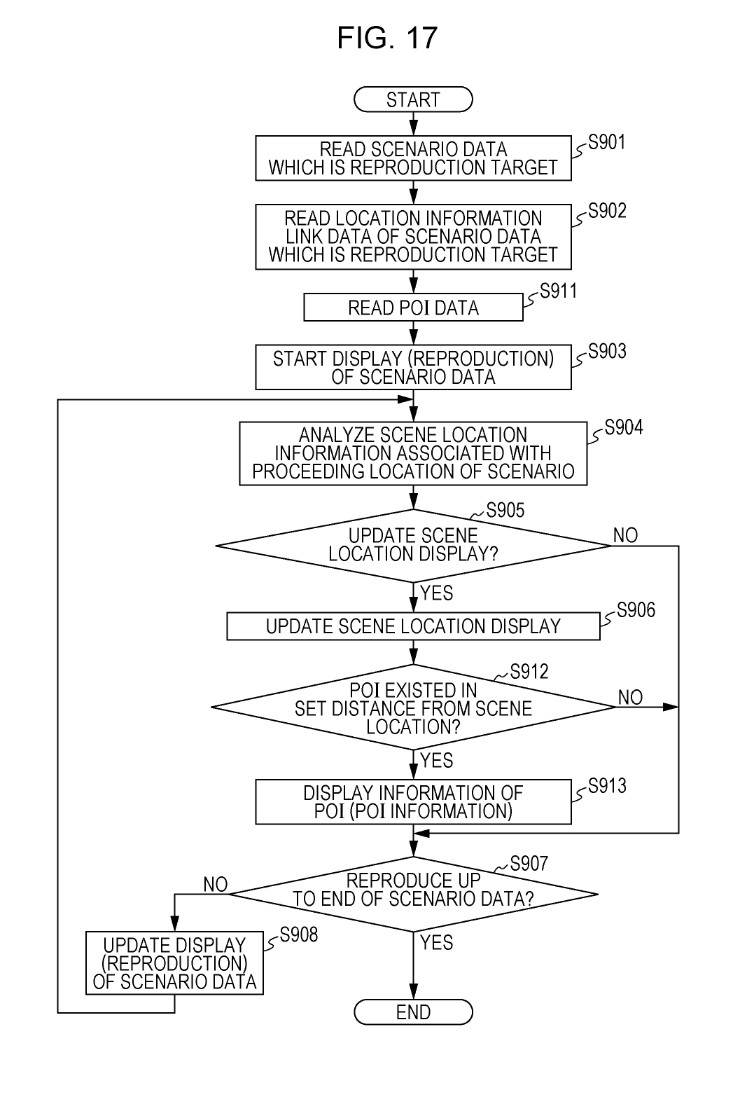

FIG. 17 is a flowchart showing a procedure example when performing the scenario display and the scene display by the display device of the second embodiment of the present technology.

The flowchart shown in FIG. 17 is a modification example of the flowchart of the first embodiment of the present technology in FIG. 12, and only the different point is that a process regarding the POI data is added. Herein, in FIG. 17, the description of the same process as the flowchart of FIG. 12 is omitted and the same reference numerals are denoted.

FIG. 17 is a diagram which describes that by assuming that the POI display is set to be turned on, the POI data to be displayed is selected on the setting screen of the POI display shown in FIG. 14.

When the location information link data of the scenario data read out in Step S902 is read out, the POI data in which the POI information to be displayed is stored, is read out from the memory unit 120 by the control unit 150 (Step S911), and then the process proceeds to Step S903.

In addition, after the scene display is updated in Step S906, the control unit 150 determines whether or not the POI is present in the set distance from the scene location (Step S912). In a case where it is determined that the POI is absent in the set distance from the scene location (Step S912), the process proceeds to Step S907. In Step S906, she icon (POI information icon of FIG. 15) for showing the location having the POI information is also displayed on the map.

On the other hand, in a case where it is determined that the POI is present in the set distance from the scene location (Step S912), the information (POI information) regarding she POI is displayed (Step S913), and she process proceeds to Step S907.

As described above, according to the second embodiment of the present technology, by displaying the POI information, the information selected based on the user preference is further added to the scene display, and the convenience can be further improved.

### 3. Third Embodiment

In the first and second embodiments of the present technology, the example of displaying the scene location is described. If the location of a user (current location) is also displayed when a user is in the vicinity of the displayed scene location, the convenience is further improved for a user if the user is on site.

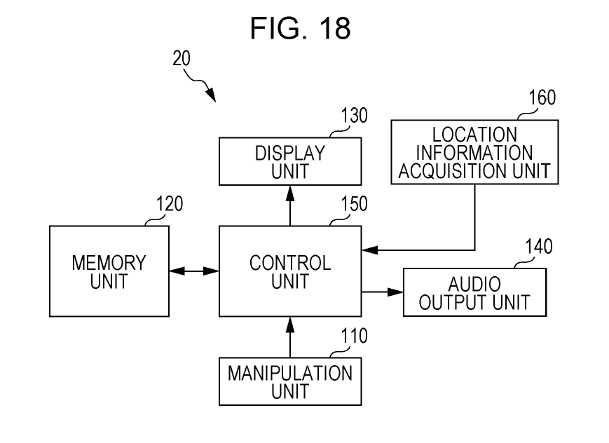

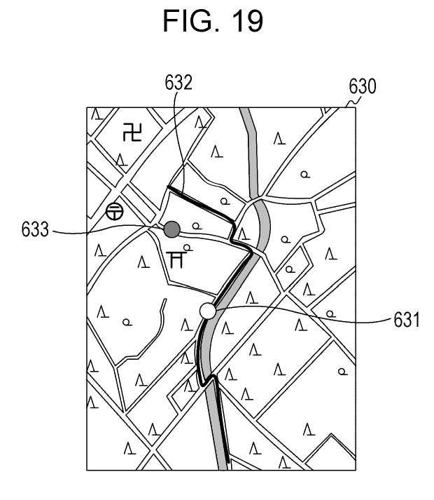

Herein, an example of displaying the current location of a user with the scene location will be described with reference to FIGS. 18 to 19 as the third embodiment of the present technology.

Functional Configuration Example of Display Device

FIG. 18 is a block diagram showing, an example of a functional configuration of a display device 20 of the third embodiment of the present technology.

The display device 20 is a modification example of the display device 10 shown in FIG. 1, and the only different point is that a location information acquisition unit 160 is additionally added to each configuration of the display device 10. Herein, the attention is paid on the location information acquisition unit 160 to be described.

The location information acquisition unit 160 acquires an actual current location (that is, the current location of display device 20) of a user. The location information acquisition unit 160 is realized by a GPS receiver which regularly or irregularly acquires location information (the latitude and the longitude) based on a GPS signal transmitted from GPS satellites, for example, and generates location information.

### Display Example

FIG. 19 is a diagram showing an example of the scene display of the third embodiment of the present technology.

On a scene display screen (display screen 630) shown in FIG. 19, an icon (scene location icon 631) showing a location (scene location) on the map corresponding to the progressing location of the scenario, and a line (movement route 632) showing a movement path of the scene location are shown on the map display. In addition, on the display screen 630, an icon (current location icon 633) showing an actual current location of a user acquired by the location information acquisition unit 160 is shown on the map display.

As described above, by additionally displaying the actual current location of a user in addition to the scene location, a user can move based on the movement of the scene location on the map, and the user can experience the background of the story deeper.

The description of the flowchart is omitted herein, since the only point that it is determined for updating even when the current location of a user acquired by the location information acquisition unit 160 is changed, when determining whether or not to update the scene display of Step S905 of FIG. 12, is different.

As described above, according to the third embodiment of the present technology, by displaying the current location at the scene location, the user convenience can be further improved.

In FIGS. 18 and 19, the example of displaying the current location with the scene location is described, however, the scene location is not limited thereto, and for example, the POI shown in the second embodiment of the present technology can also be displayed. The display of the POI information in this case can also be set to be displayed in a case where the current location of a user enters the range of the set distance of the POI, not only the case where the scene location enters the range of the set distance of the POI. In addition, a user can set so as to determine the presence or absence of toe display of the POI information when the scene location enters the range of the set distance of the POI, based on the current location of a user.

The POI information can be prepared so that the POI information displayed when the current location of a user enters the range of the set distance of the POI, and the POI information displayed when the scene location enters the range of the set distance of the POI are different information items. In addition, the POI information which is only displayed when the current location of a user enters the set distance of the POI can be prepared.

### Modification Example

In the first to third embodiments of the present technology, the embodiments are described by assuming that the scene location is present on the actual map. However, when the contents (scenario data) is fictitious, the story progresses on the virtual map. Even in this case, by setting the latitude and the longitude on the virtual map, the process can be performed in the same manner as the first to third embodiments of the present technology.

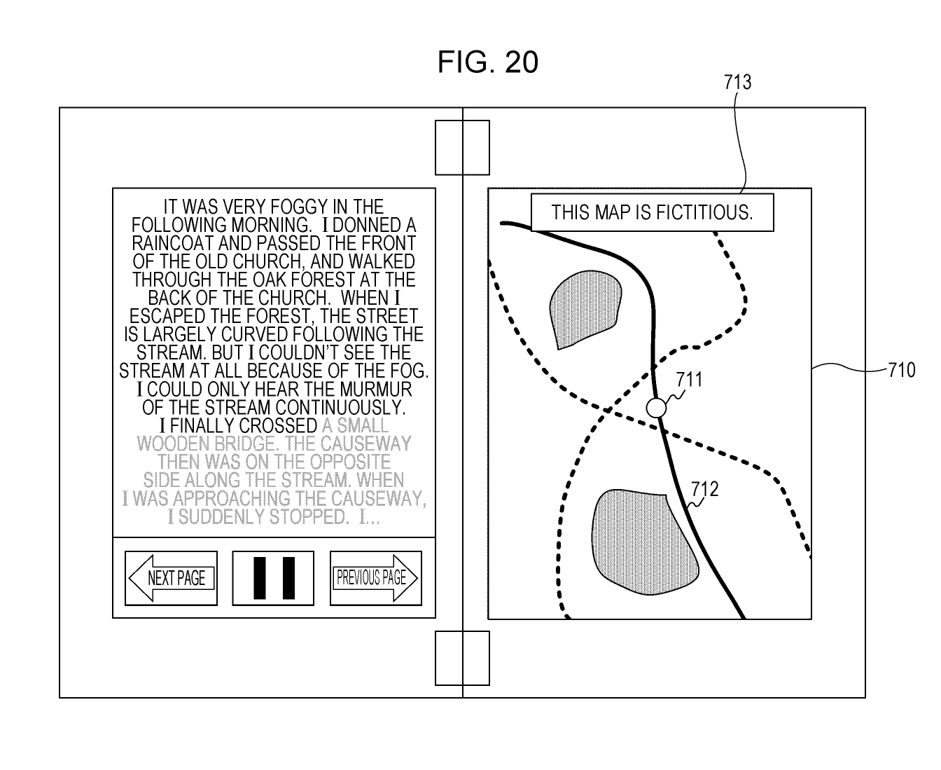

Next, an example of displaying the virtual map will be described with reference to FIG. 20 as a modification example of the present technology.

Display Example of Virtual Map

FIG. 20 is a diagram schematically showing an example of display when displaying the virtual, map, as a modification example of the present technology.

FIG. 20 is a modification example of FIG. 3, and only a point that the display of the display screen (display screen 132) of the scene location of FIG. 3 is changed to the virtual map is different. Accordingly, the attention is paid on a display screen (display screen 710) of the scene location of FIG. 20 to be described.

On the display screen 710, an icon (scene location icon 711) showing the scene location and a line (movement route 712) showing a movement path of the scene location are shown on the virtual map.

On the display screen 710, a message box (message box 713) for notifying that the map displayed on the display screen 710 is the virtual map to a user is shown. The message box 713 may not be displayed as a sentence but may be displayed as an icon.

In a case where the plurality of virtual maps exist as virtual planet A and virtual planet B, for example, and the display thereof is switched, icons showing each map are displayed, and the maps may be switched to each other by selection of the icons. As described above, the scene display can be performed using the virtual maps.

As described above, according to the embodiments of the present technology, a user can easily acquires the geographic information associated with the story of the contents being reproduced. Accordingly, along the flow of the scenario such as a novel, a travel journal, a cartoon, or reading voice, the spot which is the scene thereof can be specifically grasped on the map.

In addition, the POI information (associated information with the geographic location information) associated with the scenario can be acquired with the progress of the scenario. By associating with the other associated. POI information to this POI information, even when the building at the time of the story is moved to another spot, the information of the place where the building is currently located can be acquired, and when the story is made to a drama, the information of a shooting place which is different from the actual spot can be acquired.

In addition, by simultaneously displaying the current location of a user on the map, the current location of a user is displayed on the map which is the scene of the scenario, and a user can further experience the scene of the scenario.

### 4. Fourth Embodiment

In the first embodiment of the present technology, the display device 10 performs the switching of the maps if necessary, when changing the scene location. However, when changing the scene location from a certain scene location to another location separated further from the location, it may be difficult to grasp the location relationship of respective scene locations before and after the scene change, for a user. Herein, when the change in the scene location drastic, it is desirable to switch the maps after displaying a map including both scene locations before and after the change. The display device 10 of the fourth embodiment is different from that of the first embodiment in that the map is switched after displaying the map including both scene locations before and after the change.

Example of Data Held in Memory Unit

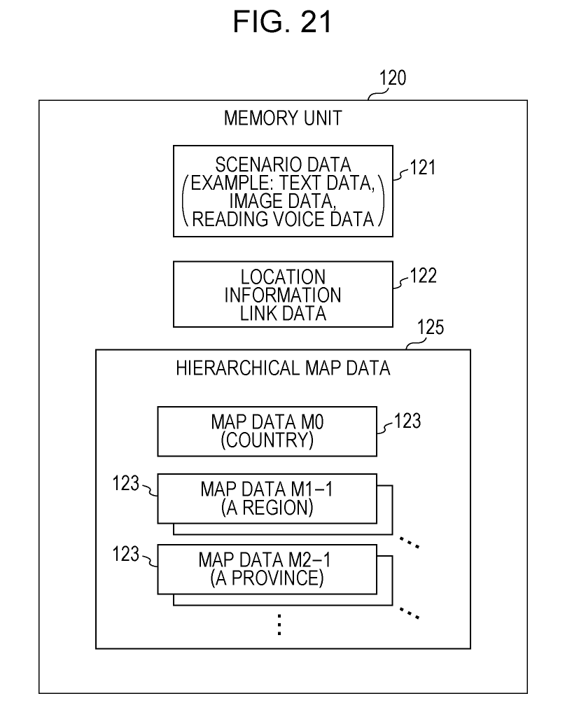

FIG. 21 is a diagram schematically showing data held in the memory unit 120 of the fourth embodiment of the present technology. The fourth embodiment is different from the first embodiment in that the plurality of map data items 123 are hierarchized. The hierarchized map data items 123 are held together as hierarchical map data 125.

The map data items 123 are hierarchized to a plurality of levels. The map data 123 at a certain level can be set as a parent, and the plurality of map data items 123 at lower layers than a certain layer can be set as a child. Each of the map data 123 items which are set as children can be set as a parent, and the plurality of map data items 123 at further lower layers can be set as a child. The child map data 123 does not nave a plurality or parents. In addition, a reduced scale of the map data 123 is different for each level, and the reduced scale of the parent map data 123 is larger than the reduced scale of the child map data 123. The parent map data 123 is map data showing a region including each of the child map data items 123.

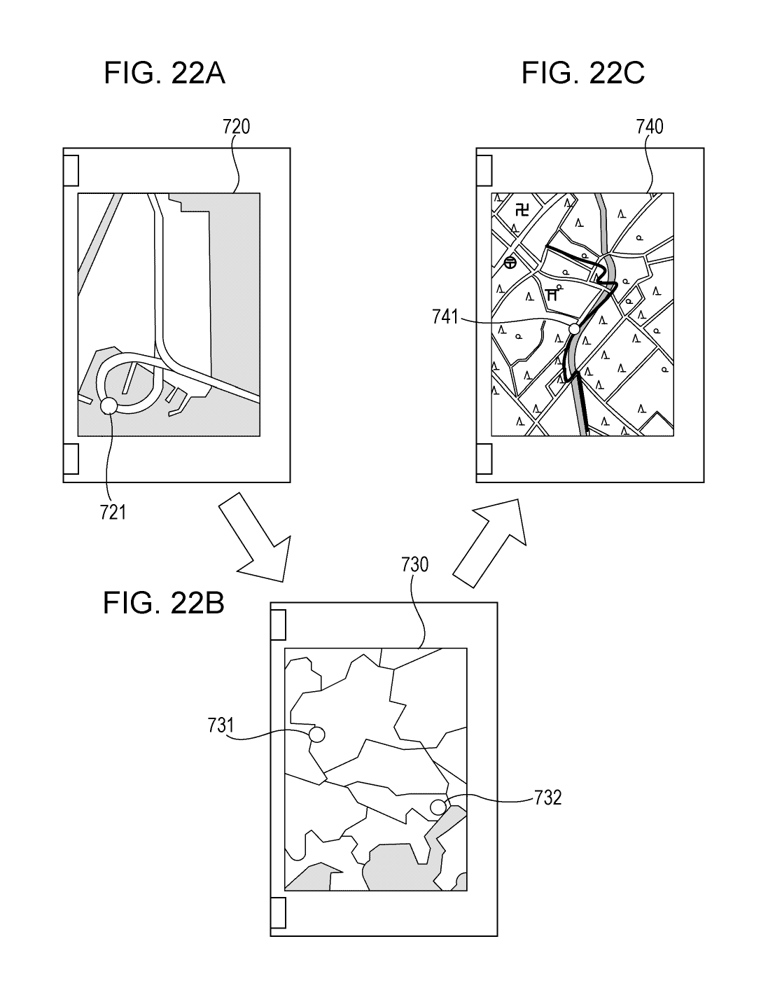

For example, as shown in FIGS. 22A to 22C, map data M0 which is a map of Japan is disposed at the uppermost level, and map data M1-1 which is map of each region (Kanto region or the like) in the country is disposed at the second level from the top. Map data M2-1 which is a map of each province in the region is disposed at the third level from the top, and map data 123 which is a map of village in the province is disposed at the lower level thereof.

Display Example of Map

FIGS. 22A to 22C are diagrams showing an example of the display of the map of the fourth embodiment of the present technology. FIG. 22A is a diagram showing an example of a map 720 before the change of the scene location. A scene location icon 721 showing the scene location before the change is displayed on the map 720. FIG. 22B is a diagram showing an example of a map 730 including the scene location before and after the change. A scene location icon 731 showing the scene location before the change and a scene location icon 732 showing the scene location after the change are displayed on the map 730. FIG. 22C is a diagram showing an example of a map 740 after changing the scene location. A scene location icon 741 showing the scene location after the change is displayed on the map 740.

The control unit 150 determines whether or not a distance between the scene locations before and after the change is longer than the given distance, when changing the scene location after displaying the map shown in FIG. 22A. In a case where the distance between the scene locations are longer than a given distance, the control unit 150 acquires the map 730 including both scene locations before and after the change. In detail, the control unit 150 reads out the parent map 730 having both child map 720 and map 740 from the memory unit 120. As shown in FIG. 22B, the control unit 150 switches the displays the acquired map 730, and as shown in FIG. 22C, the control unit switches the map to the map 740 including the scene location after the change. On the other hand, in a case where the distance between the scene locations is equal to or shorter than a given distance, the control unit 150 switches the map without displaying the map including the scene locations before and after the change.

### Operation Example of Display Device

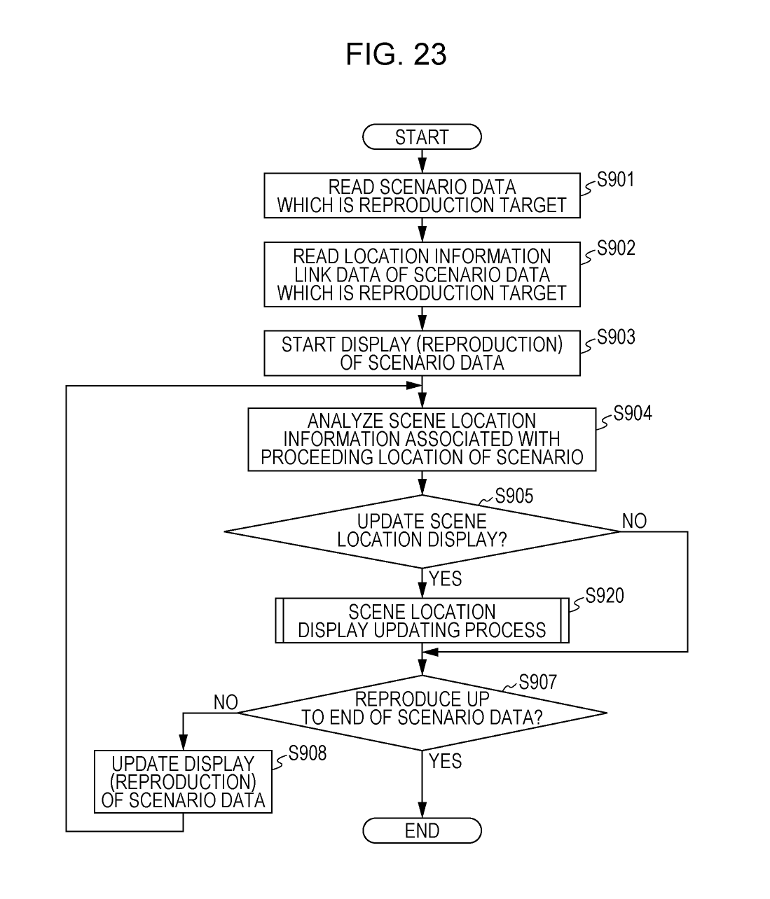

FIG. 23 is a flowchart showing a procedure example when performing the scenario display and the scene display by the display device 10 of the fourth embodiment of the present technology. The procedure of the fourth embodiment is different from that of the first embodiment in that the executing a scene location display updating process (Step S920) is by the display device 10 instead of Step S906.

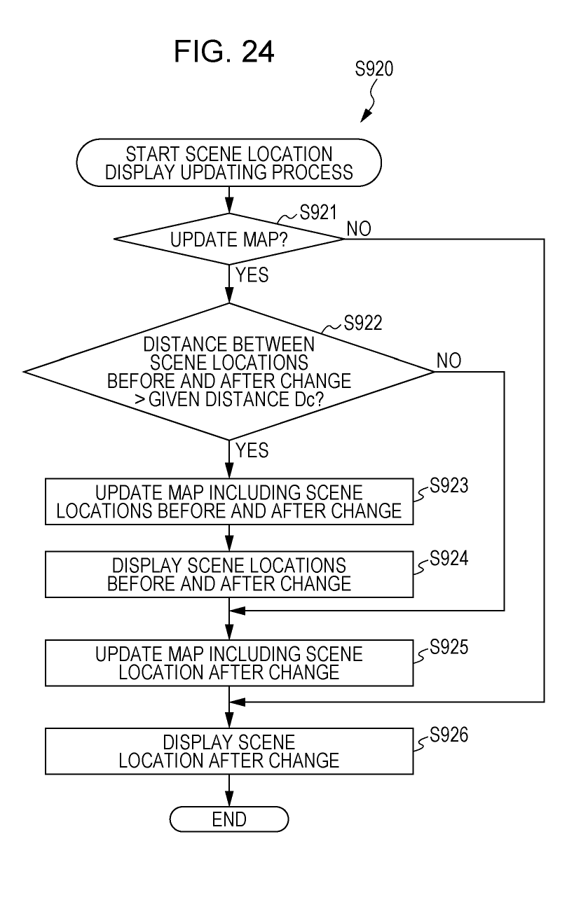

FIG. 24 is a flowchart showing an example of the scene location display updating process of the fourth embodiment of the present technology. The display device 10 determines whether or not to update the map (Step S921). If the scene location after the change is at a location on the map being displayed, it is not necessary to update the map. On the other hand, if the scene location after the change is not at a location on the map being displayed, it is necessary to update the map.

In a case of updating the map (Step S921; Yes), the display device 10 determines whether or not the distance between the scene locations before and after the change is longer than a given distance Dc (Step S922). In a case where the distance between the scene locations is longer than the given distance Dc (Step S922; Yes), the display device 10 updates the map to a map including the scene locations before and after the change (Step S923). The display device 10 displays the icon showing each scene location before and after the change on the updated map (Step S924).

In a case where the distance between the scene locations is not longer than the given distance Dc (Step S922; No), or after Step S924, the display device 10 updates the map to a map including the scene location after the change (Step S925). In a case of not updating the map (Step S921; No), or after Step S925, she display device 10 displays the icon showing the scene location after the change on the updated map (Step S926). After Step S926, the display device 10 ends the scene location display updating process.

As described above, according to the fourth embodiment of the present technology, since the display device 10 switches the map after displaying the map including both scene locations before and after the change, a user can easily grasp the location relationship between the scene locations before and after the change.

### 5. Fifth Embodiment

In she fourth embodiment of the present technology, the display device 10 only displays one map on the display screen. However, the display device 10 can display the plurality maps on the display screen. The display device 10 of the fifth embodiment is different from that of the fourth embodiment in that the plurality of maps are displayed on the display screen.

Display Example of Map

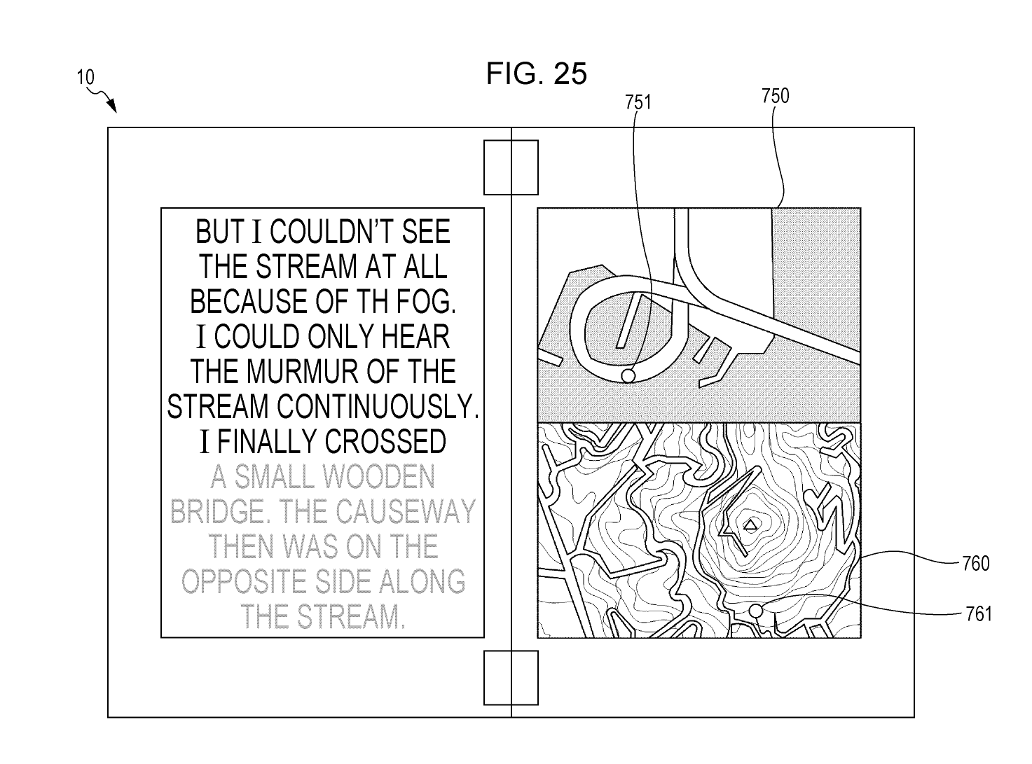

FIG. 25 is a diagram showing an example of the display of the map of the fifth embodiment of the present technology. If the scene location after the change is not at the location on the map being displayed when changing the scene location, the display device 10 divides the display screen, and displays both of the map including the scene location before the change and the map including the scene location after the change. In FIG. 25, a map 750 is a map including the scene location before the change. A scene location icon 751 showing the scene location before the change is displayed on the map 750. A map 760 is a map including the scene location after the change. A scene location icon 761 showing the scene location after the change is displayed on the map 760. The display device 10 may display three or more maps on the display screen.

Operation Example of Display Device

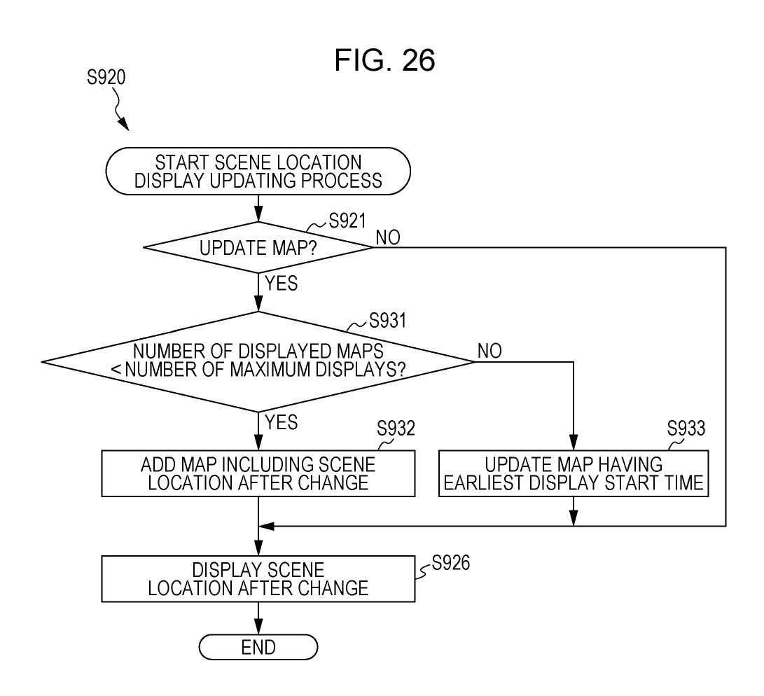

FIG. 26 is a flowchart showing an example of the scene location display updating process of the fifth embodiment of the present technology. The display device 10 determines whether or not to update the map (Step S921). In a case of updating the map (Step S921; Yes), the display device 10 determines whether or not the number of maps being displayed is smaller than the number of preset maximum displays (step S931). In a case where the number of maps is smaller than the number of maximum displays (Step S931; Yes), the display device 10 adds and displays the map including the scene location after the updating (Step S932).

On the other hand, in a case were the number of maps being displayed is greater than the number of maximum displays (Step S931; No), the map having the earliest display start time is updated (Step S933). In a case of not updating the map (Step S921; No), or after Step S932 or Step S933, the display device 10 displays the scene location icon showing the scene location after the updating on the corresponding map (Step S926).

As described above, according to the fifth embodiment of the present technology, since the display device 10 displays the plurality of maps including the scene locations, a user can completely grasp the geographic information (scene location or the like) disclosed in each of the plurality of maps.

### Modification Example

In the fifth embodiment, the display screen is divided and the plurality of the maps are displayed, however, if the display screen is divided having a limited area, the area on the display screen of each map becomes smaller than the case in which the screen is not divided. Accordingly, the display screen is not divided and only one map is displayed, and when switching the map to another map, it is desirable to switch the map based on the user manipulation. The display device 10 of the modification example is different from that of the fifth embodiment in that any of the plurality of maps can be switched and displayed based on the user manipulation.

Display Example of Map

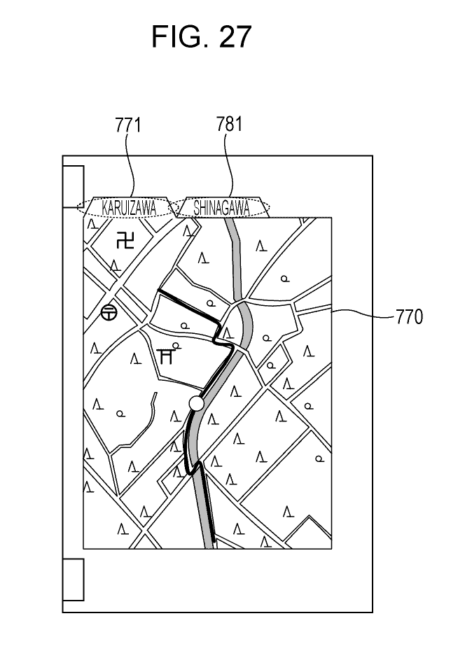

FIG. 27 is a diagram showing an example of the display of the map of the modification example of the fifth embodiment of the present technology. A map 770 including the scene location is displayed on the display screen. Tabs 771 and 781 are shown on the upper portion of the map 770. The tab 771 is a graphical user interface (GUI) component for switching the map to the map 770. The tab 781 is a GUI component for switching the map to a map different from the map 770, among the maps including the scene locations. If the tab 771 is manipulated, the display device 10 displays the map 770. On the other hand, if the tab 781 is manipulated, the display device 10 switches the map to a different map from the map 770 and displays the map. The map including the scene location may be switched by manipulation other than the tab manipulation, such as the physical manipulation of buttons provided on the display device 10.

As described above, based on the modification example, since the display device 10 switches the map to any of the plurality of maps including the scene locations and displays the map based on the user manipulation, the map can be displayed to be greater than the case of dividing the screen.

### 6. Sixth Embodiment

In the first embodiment of the present technology, the display device 10 displays the map, however, an aerial photograph may be displayed on the map in an overlapped (that is, combined) manner. The display device 10 of the sixth embodiment is different from that of the first embodiment in that displaying of the image obtained by overlapping the map and the aerial photograph is different.

Example of Data Held in Memory Unit

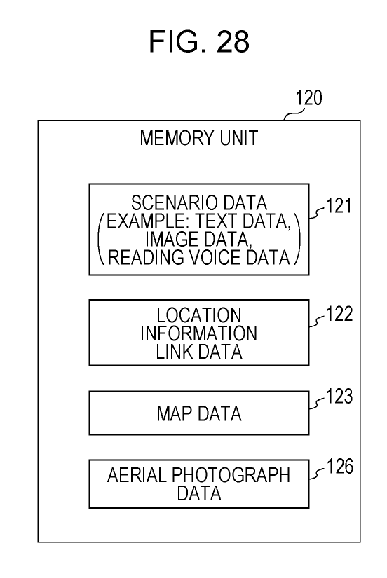

FIG. 28 is a diagram schematically showing data held in the memory unit 120 of the sixth embodiment of the present technology. Aerial photograph data 126 is further held in the memory unit 120 of the sixth embodiment. The aerial photograph data 126 is image data obtained by imaging a terrain shown in the map from the sky.

Display Example of Map

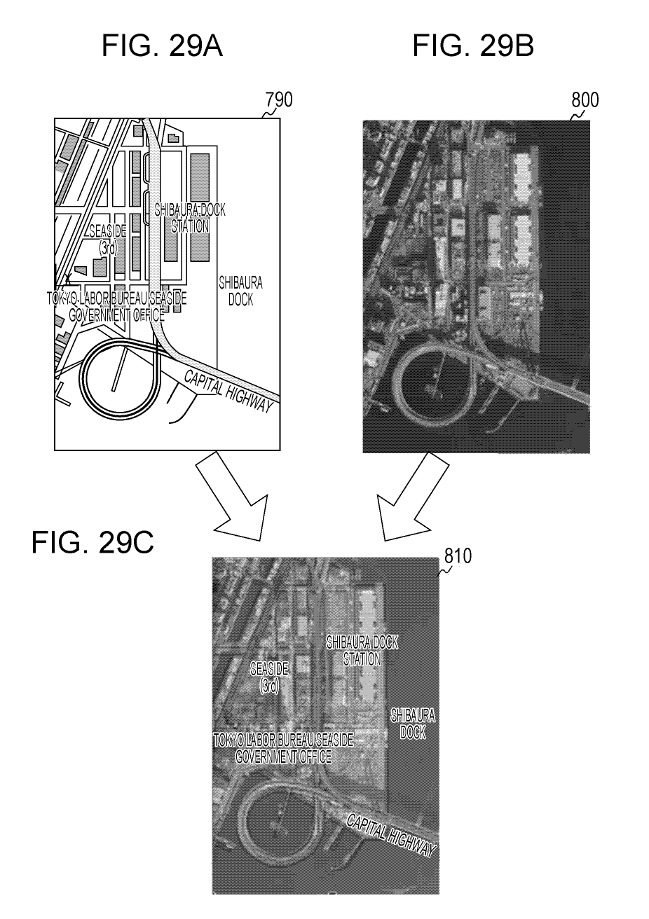

FIGS. 29A to 29C are diagrams showing an example of the display of the map of the sixth embodiment of the present technology. FIG. 29A is an example of a map 790 including the scene location. FIG. 29B is an example of an aerial photograph 800 obtained by imaging the terrain shown in the map 790 from the sky. As shown in FIG. 29C, the display device 10 displays an image 810 obtained by overlapping the map 790 and the aerial photograph 800.

The display device 10 may switch and display any of the map, the aerial photograph, and the overlapped image, based on the use manipulation. In addition, the display device 10 previously holds the map data 123 and the aerial photograph data 126 and overlaps those data items, however, it may hold the image obtained by previously overlapped map data 123 and the aerial photograph data 126.

As described above, according to the sixth embodiment of the present technology, since the display device 10 displays the image obtained, by overlapping the image and the aerial photograph, a user can grasp the information on the map and the information on the aerial photograph at the same time.

### 7. Seventh Embodiment

In the first embodiment of the present technology, the display device 10 displays the same map without recognizing the reproduction of the contents. However, in a case where the contents are not reproduced, if the map which is different from the case where the contents are reproduced is displayed, the convenience of the display device 10 is improved. For example, in the contents such as a detective novel, when the novel is read (that is, reproduced), if a map in which a place where an incident occurred in a novel or the description of the incident is disclosed, is displayed, then a user easily can imagine the story of the novel. On the other hand, in a case where the novel is unread (that is, not reproduced), if such a map is displayed, a user may lose interest in the novel. The display device 10 of the seventh embodiment is different from that of the first embodiment in that the displaying different maps are different for the case where the contents are reproduced and for the case where the contents are not reproduced.

Example of Data Held in Memory Unit

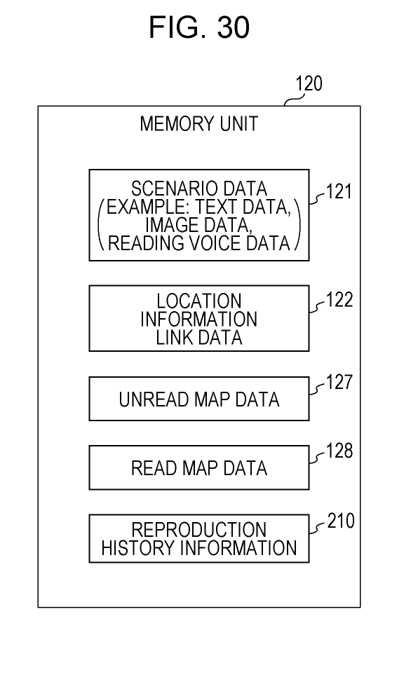

FIG. 30 is a diagram schematically showing data held in the memory unit 120 of the seventh embodiment of the present technology. The memory unit 120 of the seventh embodiment is different from that of the first embodiment in that holding the unread map data 127, the read map data 128, and the reproduction history information 210, instead of the map data 123.

The unread map data 127 is map data displayed when the contents are not reproduced. The read map data 128 is map data displayed when the contents are reproduced. In addition, the reproduction history information 210 is data including information showing whether or not the contents are reproduced.

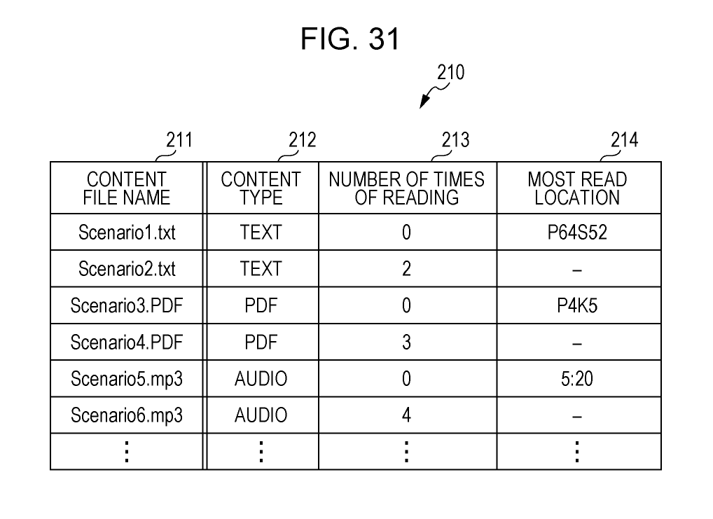

FIG. 31 is a diagram showing an example of the reproduction history information 210 held in the memory unit 120 of the seventh embodiment of the present technology. The reproduction history information 210 is data including a contents type 212, number of times of reading 213, and a most read location 214 for each contents file name 211.

The contents file name 211 is a name of a file which stores the contents. The contents type 212 is information showing a data type of the contents. The number of times of reading 213 is the number of times the contents are reproduced to a specific reproduction location (for example, the last reproduction location). If the number of times of reading is “0”, it is determined that the contents are not reproduced, and if the number of times of reading is larger than “0”, it is determined that the contents are reproduced. The most read location 214 is a location nearest to the last reproduction location, among the reproduced reproduction locations. The number of times of reading 213 is used for display a list by sorting each name of the plurality of contents items in order of greater number of times of reading 213.

A case where the contents having a contents file name “Scenario.1.txt” is reproduced to 52nd line of page 64, and is not reproduced to the last, is considered. In this case, in the reproduction history information, “0” is held as the number of times of reading, and “P64S52” is held, as the most read location.

The configuration of the reproduction history information 210 is not limited to the configuration shown in FIG. 31. For example, the reproduction history information 210 may be information including only a graph showing whether or not the contents are reproduced, for each contents item.

Functional Configuration Example of Control Unit

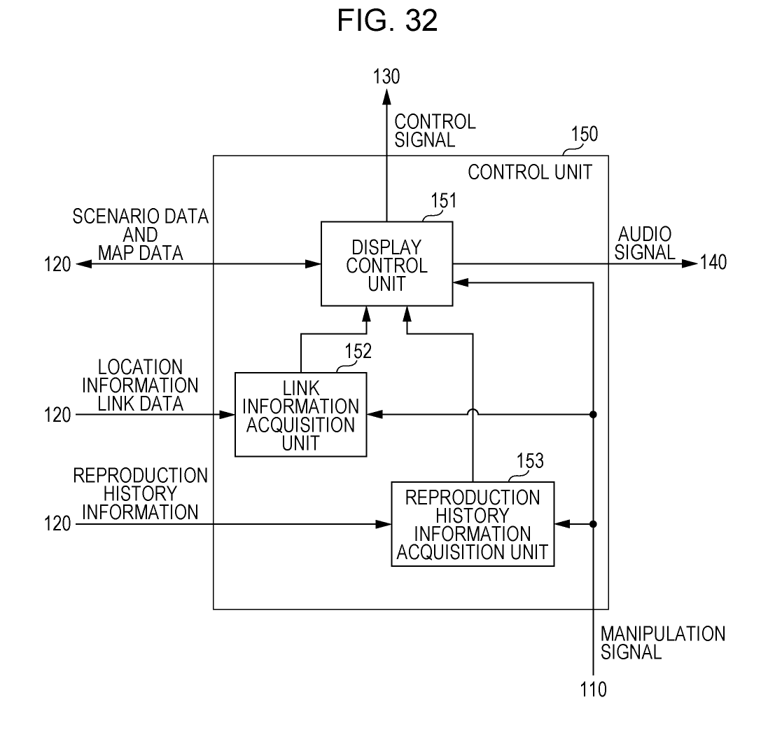

FIG. 32 is a block diagram showing an example of a functional configuration of the control unit 150 of the seventh embodiment of the present technology. The control unit 150 of the seventh embodiment is different from that of the first embodiment in that a reproduction history information acquisition unit 153 is further included.

The reproduction history information acquisition unit 153 acquires reproduction history information. When a manipulation signal for designating the reproduction of the contents are received from the manipulation unit 110, the reproduction history information acquisition unit 153 reads out reproduction history information corresponding to the contents from the memory unit 120. The reproduction history information acquisition unit 153 supplies the read-out reproduction history information to the display control unit 151.

The display control unit 151 of the seventh embodiment determines whether or not the contents are reproduced based on the reproduction history information, and displays the read map data 128 when the contents are reproduced. On the other hand, when the contents are not reproduced, the display control unit 151 displays the unread map data 127. In addition, the display control unit 151 updates the reproduction history information each time reproducing the contents.

Operation Example of Display Device

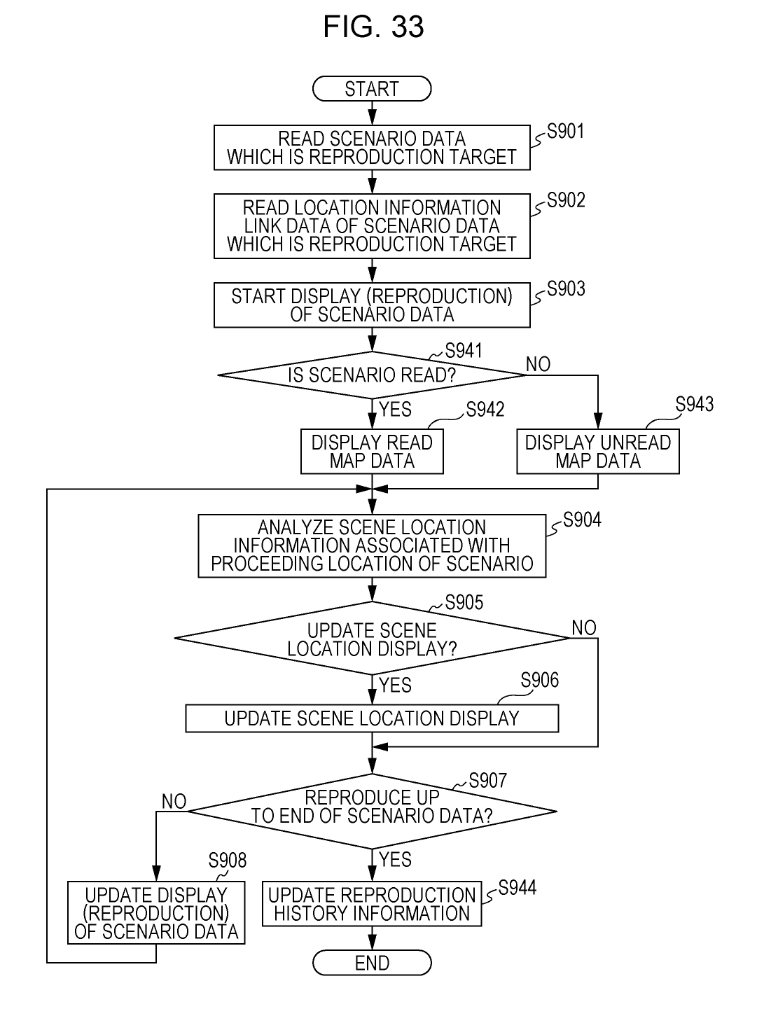

FIG. 33 is a flowchart showing a procedure example when performing the scenario display and the scene display by the display device 10 of the seventh embodiment of the present technology. The procedure of the seventh embodiment is different from that of the first embodiment in that there is a further executing Step S941 to Step S943, and Step S944 instead of Step S908 is executed.

The display device 10 starts the reproduction of the scenario data (Step S903), and determines whether or not the scenario thereof is read, based on the reproduction history information (Step S941). In a case where the scenario is read (Step S941; Yes), the display device 10 displays the read map data 128 (Step S942). On the other hand, in a case where the scenario is not read (Step S941; No), the display device 10 displays the unread map data 127 (Step S943). In addition, if the scenario data is reproduced last (Step S907; Yes), the display device 10 updates the reproduction history information 210. In detail, the display device 10 increases the number of times of reading 213 of the reproduced scenario data in the reproduction history information 210 (Step S914). After Step S941, the display device 10 ends the procedure.

As described above, according to the seventh embodiment of the present technology, the display device 10 displays the different map depending on whether or not the contents are reproduced, the convenience of the display device 10 can be improved.

### 8. Eighth Embodiment

In the second embodiment of the present technology, the set distance between the scene location icon and the POI information icon when starting the display of the POI is set to be constant. However, in a case where the contents are reproduced, if the set distance is longer than the case where the contents are not reproduced, the convenience is improved. The display device 10 of the eighth embodiment is different from that of the second embodiment in that the setting of the set distance is longer when the contents are not reproduced compared to when the contents are reproduced.

Example of Data Held in Memory Unit

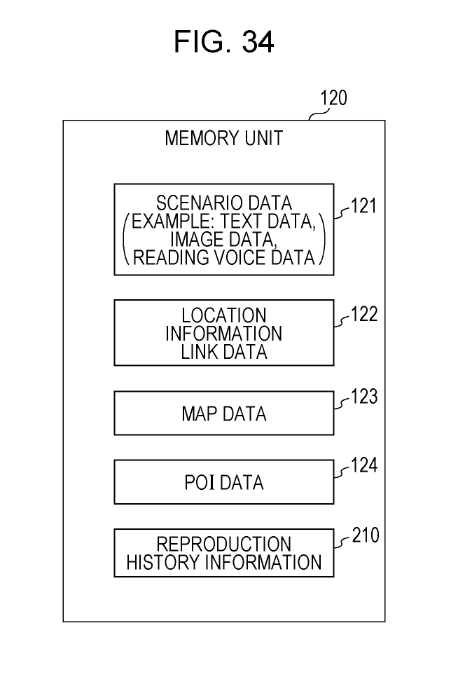

FIG. 34 is a diagram schematically showing data held in the memory unit 120 of the eighth embodiment of the present technology. The memory unit 120 of the eighth embodiment is different from that of the second embodiment in that holding of the reproduction history information 210 is longer.

Functional Configuration Example of Control Unit

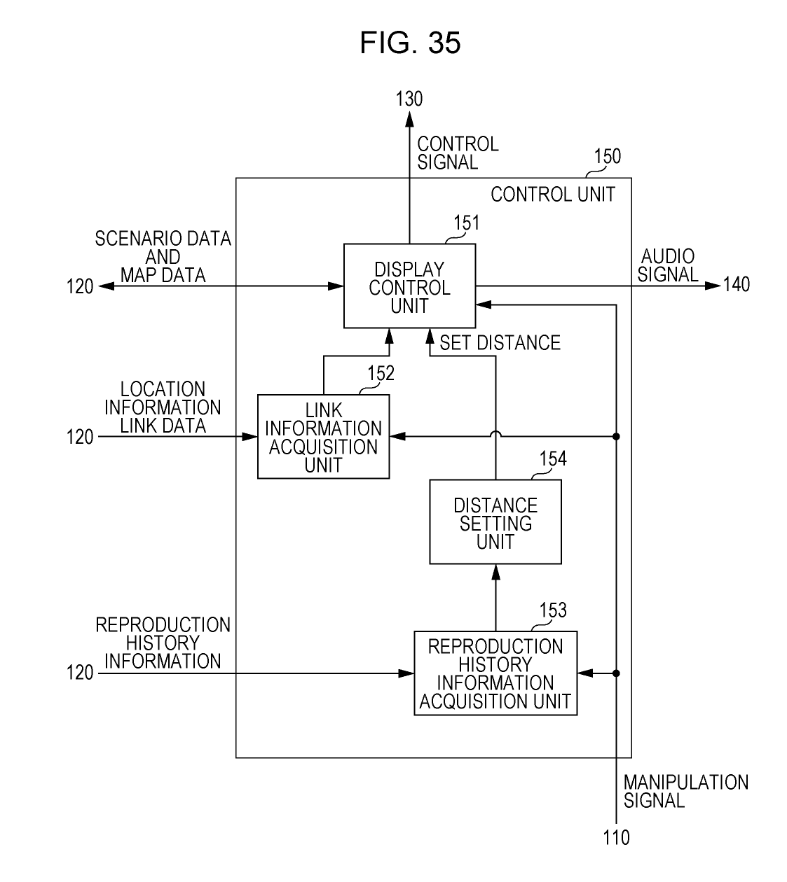

FIG. 35 is a block diagram showing an example of a functional configuration of the control unit 150 of the eighth embodiment of the present technology. The control unit 150 of the eighth embodiment is different from that of the second embodiment in that the reproduction history information acquisition unit 153 and a distance setting unit 154 are further included. The reproduction history information acquisition unit 153 of the eighth embodiment acquires the reproduction history information based on the manipulation signal and supplies the information to the distance setting unit 151.

The distance setting unit 154 sets a set distance based on the reproduction history information. The distance setting unit 154 determines whether or not the contents are reproduced based on the reproduction history information, and in a case where the contents are reproduced, a longer set distance than that in the case where the contents are not reproduced is set. On the other hand, in a case where the contents are not reproduced, the distance setting unit 154 sets a set distance shorter than that in the case where the contents are reproduced. The distance setting unit 154 supplies the set distance to the display control unit 151.

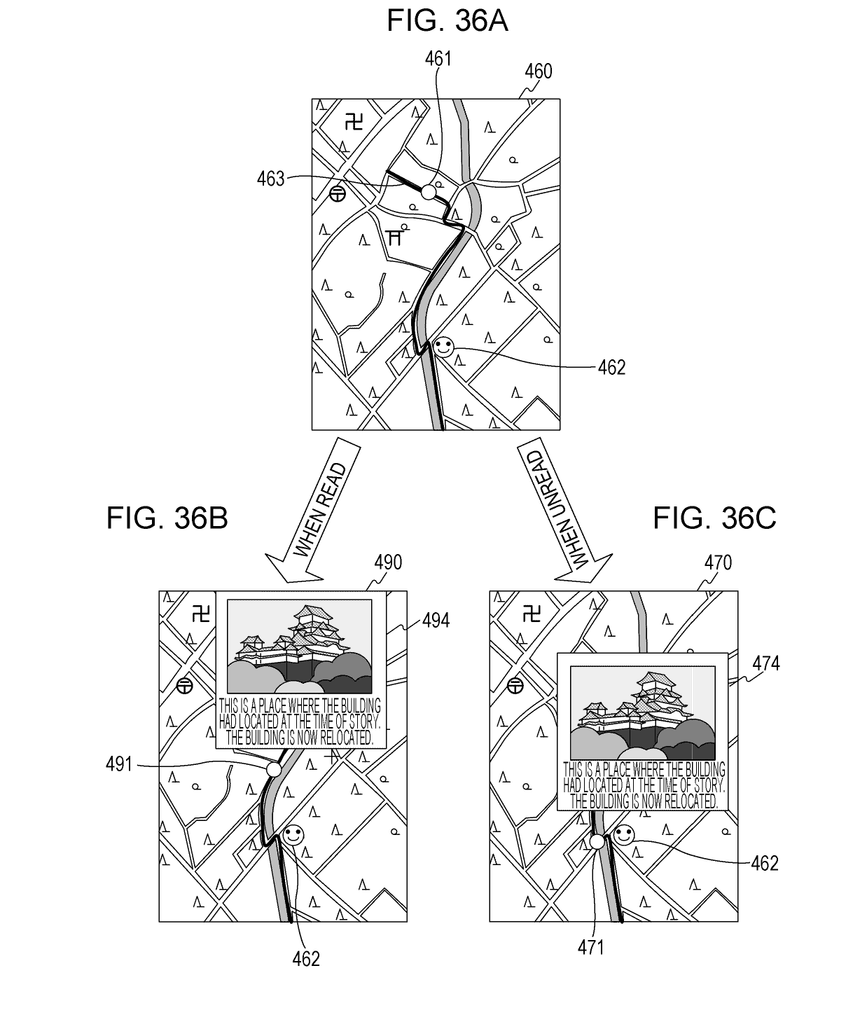

FIGS. 36A to 360 are diagrams schematically showing an example of an effect of the eighth embodiment of she present technology. FIG. 36A is an example of a display screen 460 of the case where the scene location icon 461 is not in the set distance from the POI information icon 462. FIG. 36B is an example of a display screen 490 of a case where a scene location icon 491 is in the set distance from the POI information icon 462 and the contents are read. In this case, the POI information 494 is displayed.

FIG. 36C is an example of the display screen 470 of the case where the scene location icon 471 is in the set distance from the POI information icon 462 and the contents are not read. As described above, when the contents are not read, the set distance shorter than the case where the contents are read, is set. Accordingly, as shown in FIG. 36C, when the scene location icon 471 approaches the location nearer to the POI information icon 462 than the case where the contents are read, the POI information 474 is displayed. When the contents are not read, a user concentrates on the story of the contents, and does not use the POI information as much as when the contents are read, in many cases. On the other hand, when the contents are read, a user has interest in the additional information (POI information or the like) around the scene location, in many cases. Accordingly, when the contents are read, by setting the set distance longer than the case where the contents are not read, the POI information is easily displayed and the convenience is improved.

Operation Example of Display Device

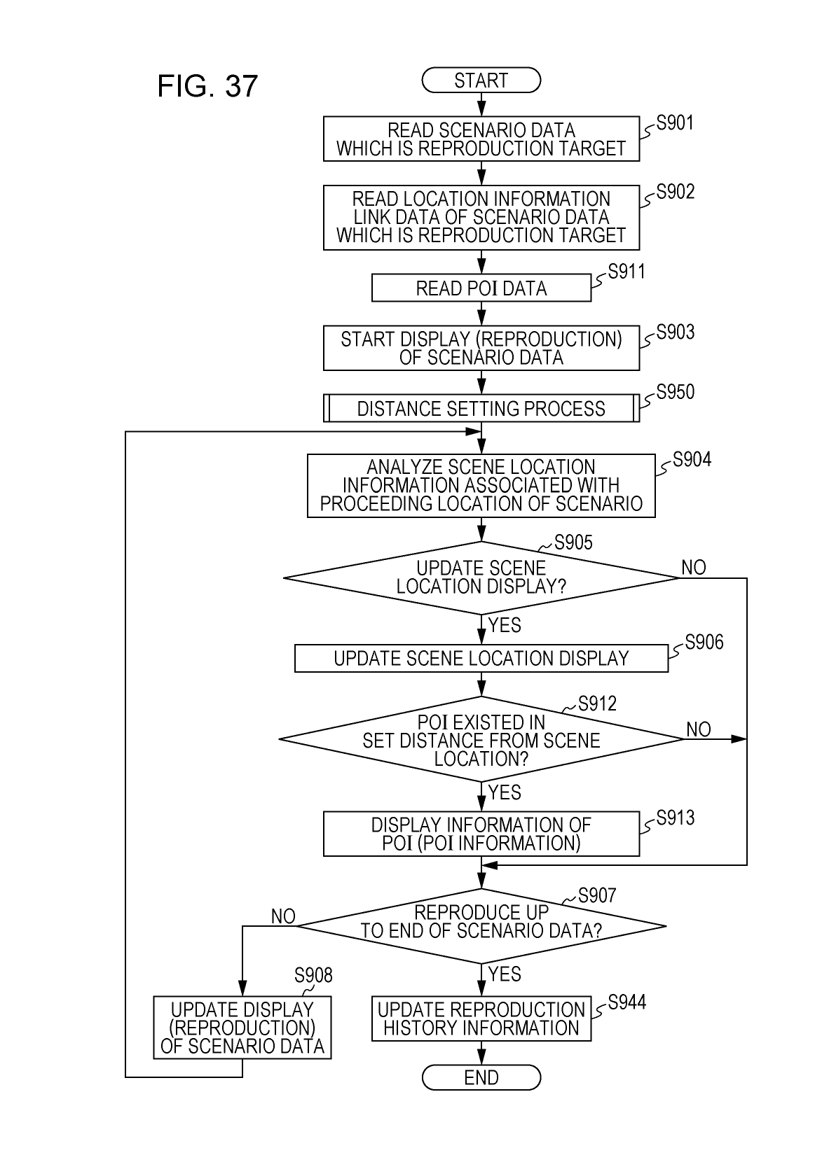

FIG. 37 is a flowchart showing a procedure example when performing the scenario display and the scene display by the display device 10 of the eighth embodiment of the present technology. The procedure of the eighth embodiment is different from that of the second embodiment in that Step S950 and Step S944 are further executed. The display device 10 executes a distance setting process (Step S950) between Steps S903 and 904. In addition, if the scenario data is reproduced last (Step S907; Yes), the display device 10 updates the reproduction history information 210 (Step S944).

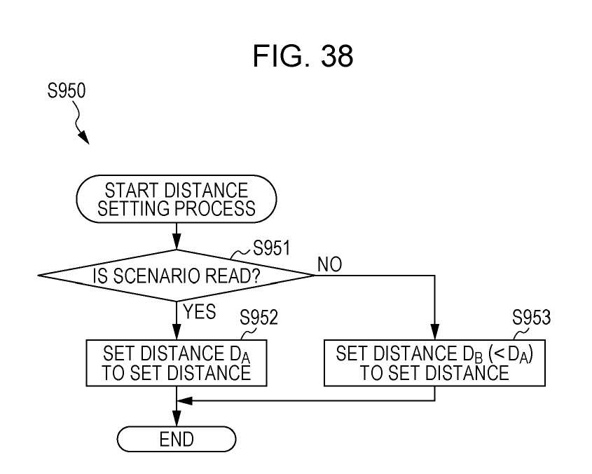

FIG. 38 is a flowchart showing an example of the distance setting process of the eighth embodiment of the present technology. The display device 10 determines whether or not the scenario is read based on the reproduction history information (Step S951). In a case where the scenario is read (Step S951; Yes), the display device 10 sets a predetermined distance D_{A} to the set distance (Step S952). On the other hand, in a case where the scenario is not read (Step S951; No), the display device 10 sets a distance D_{B} which is shorter than D_{A} to the set distance (Step S953). After Step S952 or S953, the display device 10 ends the distance setting process.

As described above, according to the eighth embodiment of the present technology, since the display device 10 sets the set distance longer than the case where the contents are not reproduced, in a case where the contents are reproduced, the convenience of the display device 10 can be improved.

### 9. Ninth Embodiment

In the first embodiment of the present technology, the date and time which is the background of the scene location are not displayed, or the date and time thereof may be displayed. The display device 10 of the ninth embodiment is different from that of the first embodiment in that the date and time which is the background of the scene location are displayed.

Example of Data Held in Memory Unit

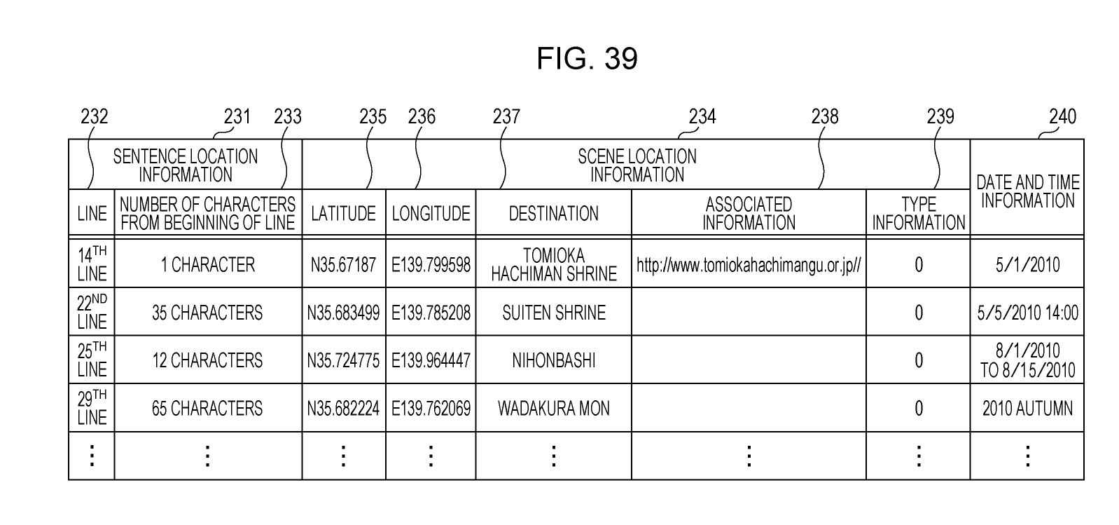

FIG. 39 is a diagram schematically showing an example of information stored in the location information link data held in the memory unit 120 of the ninth embodiment of the present technology. In the location information link data of the ninth embodiment, date and time information 240 is further associated with the scene location information. The date and time information 240 is information showing the date and time which is the background of the scene location in the contents. For example, in a case where the date and time which is the background of the scene location which is “Tomioka Hachiman Shrine” is May, 1, 2010, the date and time information 240 which is “2010/5/1” is associated with the scene location.

Display Example of Date and Time

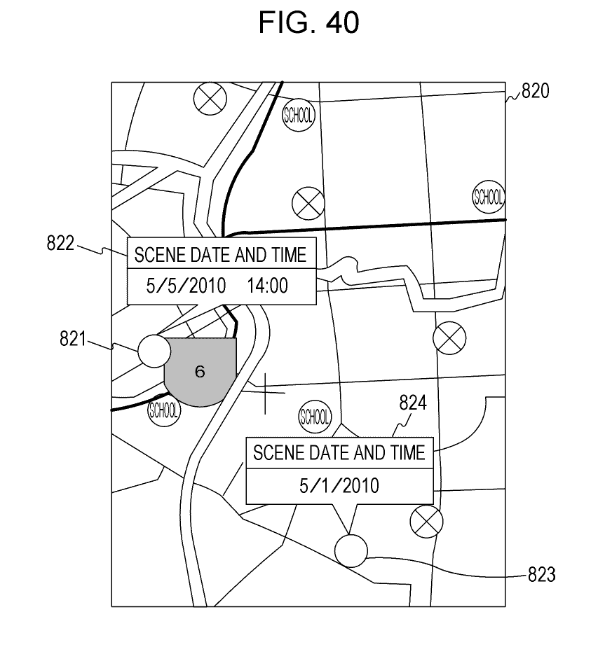

FIG. 40 is a diagram showing an example of the display of the data and time of the ninth embodiment of the present technology. As shown in FIG. 40, if a scene location 821 is selected, the display device 10 acquires date and time 822 associated with the selected scene location from the location information link data, and displays the date and time. Further, if a scene location 823 is selected, the display device 10 acquires date and time 824 corresponding to the scene location from the location information link data and displays the date and time. By displaying the date and time of the selected scene location 823, a user can recognize the date and time which is the background of the scene location 823, without checking the story of the contents regarding the scene location 823. Accordingly, the convenience is further improved.

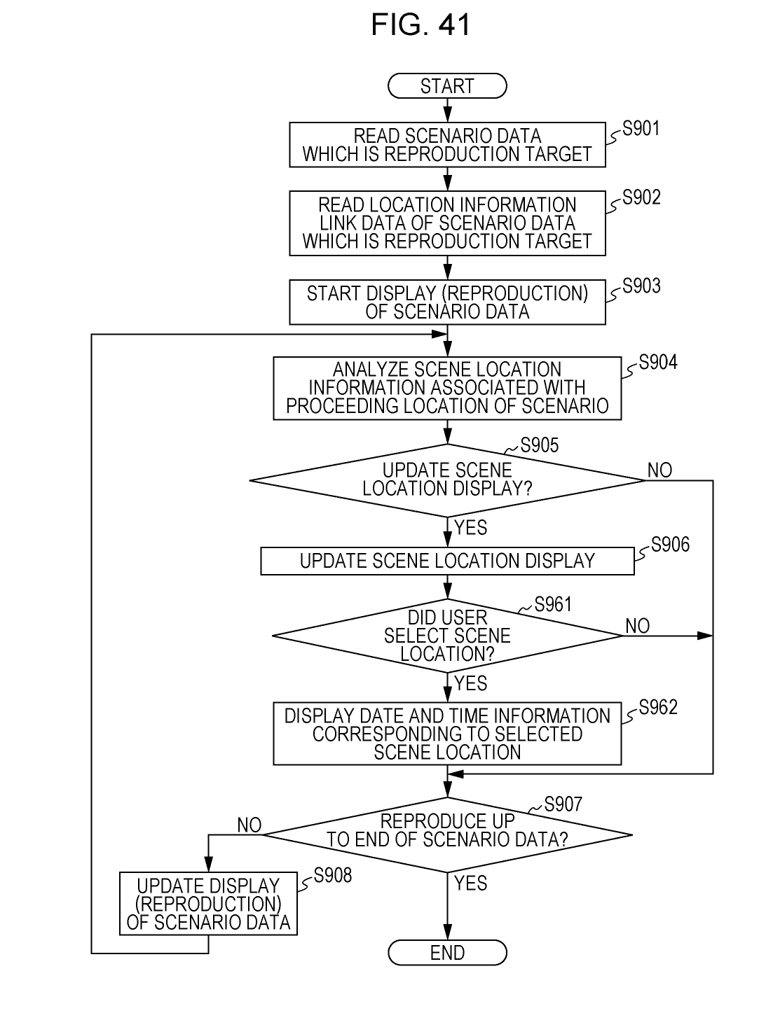

FIG. 41 is a flowchart showing a procedure example when performing the scenario display and the scene display by the display device 10 of the ninth embodiment of the present technology. The procedure of the ninth embodiment is different from that of the first embodiment in that Steps S961 and S962 are further executed by the display device 10.

The display device 10 updates the scene location display (Step S906), and a user determines whether or not the scene location being displayed is selected (Step S961). In a case where a user selects the scene location (Step S961; Yes), the display device 10 acquires the date and time associated with the selected scene location from the location information link data and displays the date and time (Step S962). On the other hand, in a case where a user does not select the scene location (Step S961; No) or after Step S962, the display device 10 executes Step S907. The display device 10 executes Steps S961 and S962 during reproduction of the scenario data, however, the process may be executed before starting the reproduction or after finishing the reproduction of the scenario data.

As described above, according to the ninth embodiment of the present technology, since the display device 10 displays the date and time associated with the selected scene location, a user can easily grasp the date and time associated with the scene location. Accordingly, the convenience is improved.

### Modification Example

In the ninth embodiment of the present technology, the display device 10 displays the date and time of the scene location selected, by a user. However, a reference date and time (current date and time or the like) which is a reference may be acquired, and the scene location associated with the date and time close to the reference date and time may be displayed. The display device 10 of the modification example of the ninth embodiment is different from that of the ninth embodiment in that the scene location associated with the date and time close to the reference date and time are displayed.

Display Example of Scene Location

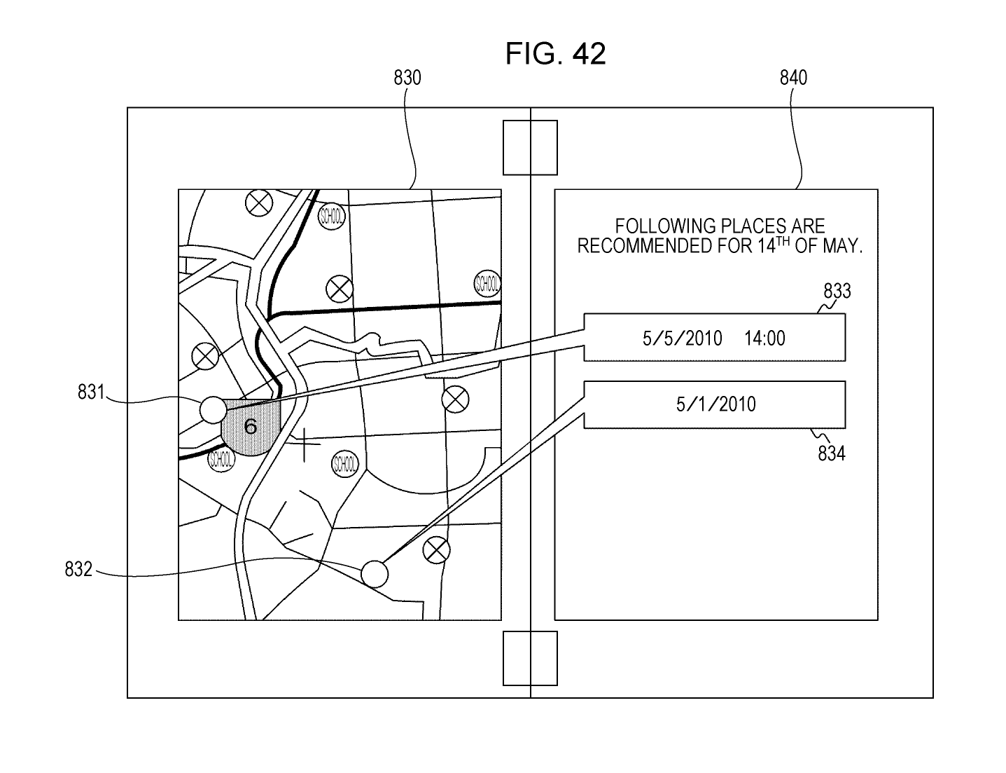

FIG. 42 is a diagram schematically showing an example of the display of the scene location of the modification example of the ninth embodiment of the present technology. If the reproduction of the contents are designated, the display device 10 acquires the reference date and time. The reference date and time is current date and time acquired by the display device 10 or date and time input to the display device 10 by a user. The display device 10 searches the scene location corresponding to the date and time (that is, date and time close to the reference date and time) in a given period from the reference date and time, in the location information link data. Herein, a case of two scene locations corresponding to the date and time in a given period from the reference date and time is considered. In this case, the display device 10 displays the map corresponding to the searched scene location on a screen 830, and displays scene location icons 831 and 832 showing the scene location on the map. In addition, the reference date and time and a date and time 833 and a date and time 834 of the searched scene locations are displayed on a screen 840. The display device 10 displays the searched scene locations on the map however, only the name of the scene locations may be displayed.

Operation Example of Display Device

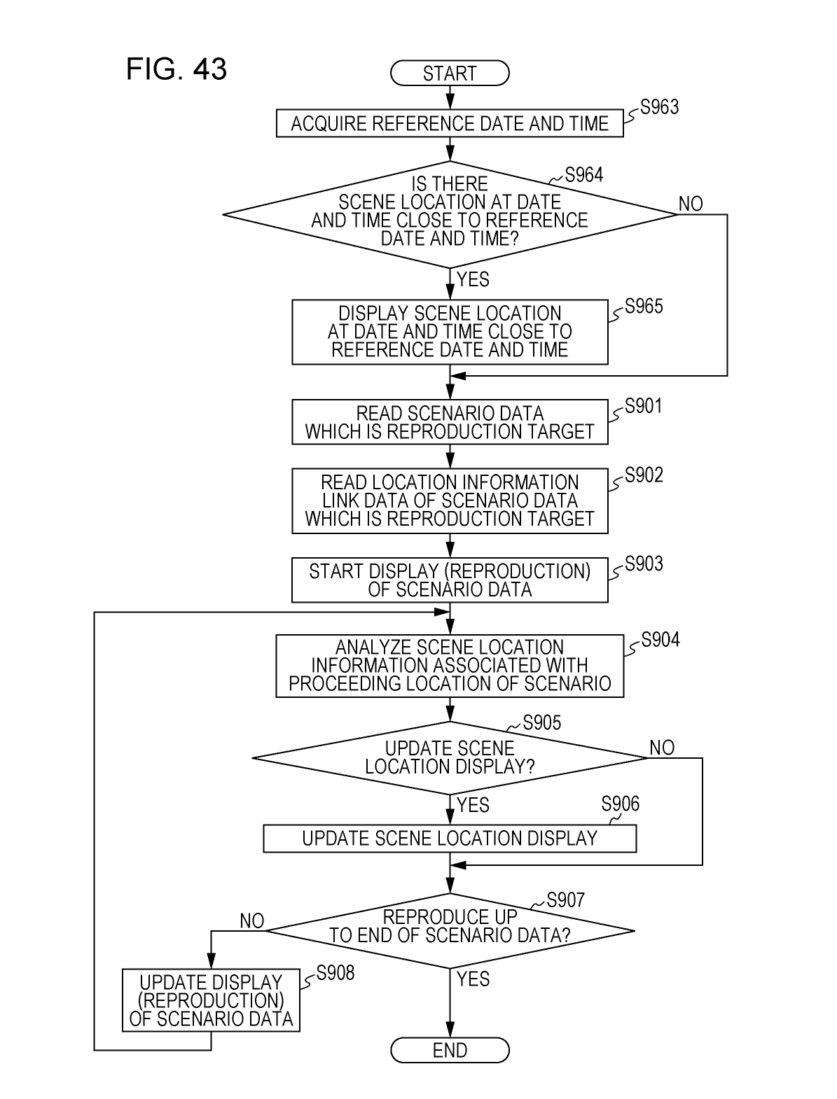

FIG. 43 is a flowchart showing a procedure example when performing the scenario display and the scene display by the display device 10 of the ninth embodiment of the present technology. The procedure of the ninth embodiment is different from that of the first embodiment in that steps S963, S964, and S965 are executed by the display device 10.

The display device 10 acquires the reference date and time (Step S963). The display device 10 determines whether or not the scene location corresponding to the date and time close to the reference date and time is in the location information link data (Step S964). In a case where the corresponding scene location exists (Step S964; Yes), the scene location thereof is displayed (Step S965). On the other hand, in a case where the corresponding scene location does not exist (Step S964; No) or after Step S965, the display device 10 receives manipulation for selecting the displayed scene location or the scenario data. The display device 10 reads out the scenario data corresponding cc the selected scene location or the selected scenario data (Step S901).

In Step S965, the display device 10 displays only the scene location, however, may display the name of the scenario data corresponding to the scene location with the scene location. The display device 10 executes the process of steps S963 to S965 before the reproduction of the scenario data, however, may execute the process during the reproduction or after finishing the reproduction of the scenario data.

As described above, according to the modification example of the ninth embodiment of the present technology, since the display device 10 displays the scene location associated with the date and time in the given period from the reference date and time, a user gets interested in the scene location.

### 10. Tenth Embodiment

In the first embodiment of the present technology, the display device 10 displays the scene location regardless of the distance from the specific reference location (location at which the display device 10 exists). However, by searching and displaying a nearest scene location which is nearest to the reference location, a user can grasp the scene location to which a user can easily visit. Accordingly, the convenience is further improved. The display device 10 of the tenth embodiment is different from that of the first embodiment in that the nearest scene location is searched and displayed.

Functional Configuration Example of Control Unit

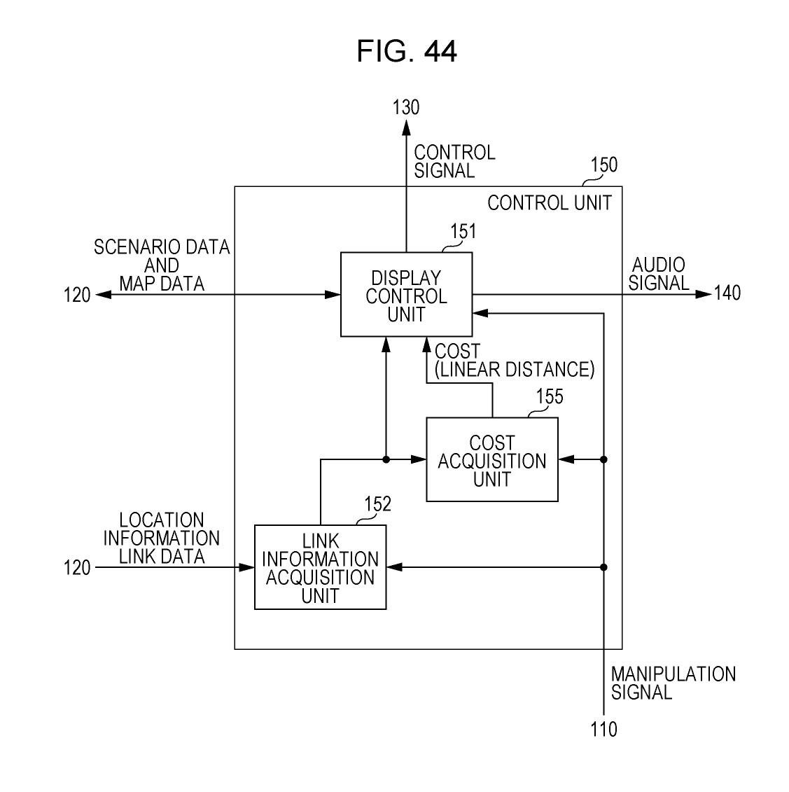

FIG. 44 is a block diagram showing an example of a functional configuration of the control unit 150 of the tenth embodiment of the present technology. The control unit 150 of the tenth embodiment is different from that of the first embodiment in that a cost acquisition unit 155 is further included.

The link information acquisition unit 152 of the tenth embodiment supplies the location information link data to the cost acquisition unit 155, in addition to the display control unit 151. The cost acquisition unit 155 acquires cost necessary for movement from the specific reference location to the scene location. Herein, the reference location is a location which is a reference in cost acquisition, and for example, a location at which the display device 10 exists, or a location input to the display device 10 by a user. In addition, the cost is expense or effort generated in the movement, and is shown with a distance, time, or payment.

If a manipulation signal for designating the reference location is input, the cost acquisition unit 155 acquires the scene location from the location information link data, and calculates cost necessary for the movement from the reference location to the scene location for each scene location. For example, a linear distance between the reference location and the scene location is calculated as the cost. The cost acquisition unit 155 supplies the cost acquired for each scene location to the display control unit 151.

The display control unit 151 of the tenth embodiment displays a scene location having smallest cost (that is, closest) on the map before starting the reproduction of the scenario data

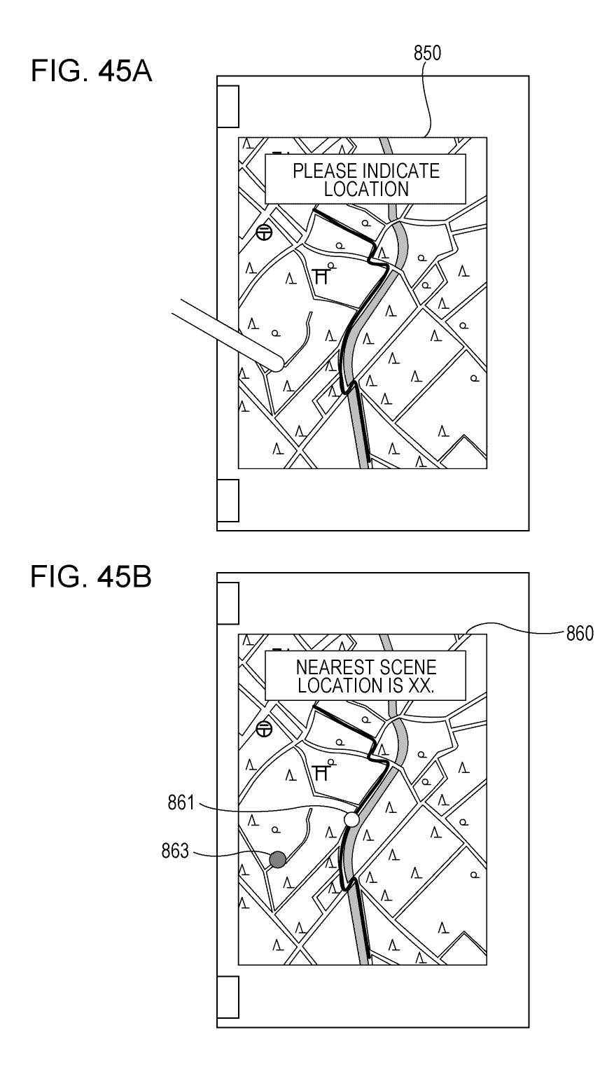

FIGS. 45A and 45B are diagrams schematically showing the display of the scene location of the tenth embodiment, of the present technology. Before starting the reproduction of the contents, as shown in FIG. 45A, the display device 10 displays a message promoting input of the reference location on a screen 850. If the reference location is input by touch manipulation using a stylus, as shown in FIG. 45B, the display device 10 displays a scene location icon 861 showing the scene location closest to the input reference location on the screen 860. The reference location icon 861 showing the input reference location, and a message including the name of the nearest scene location are displayed on the screen 860. The display device 10 may display any one of the scene location icon 861 and the name of the scene location.

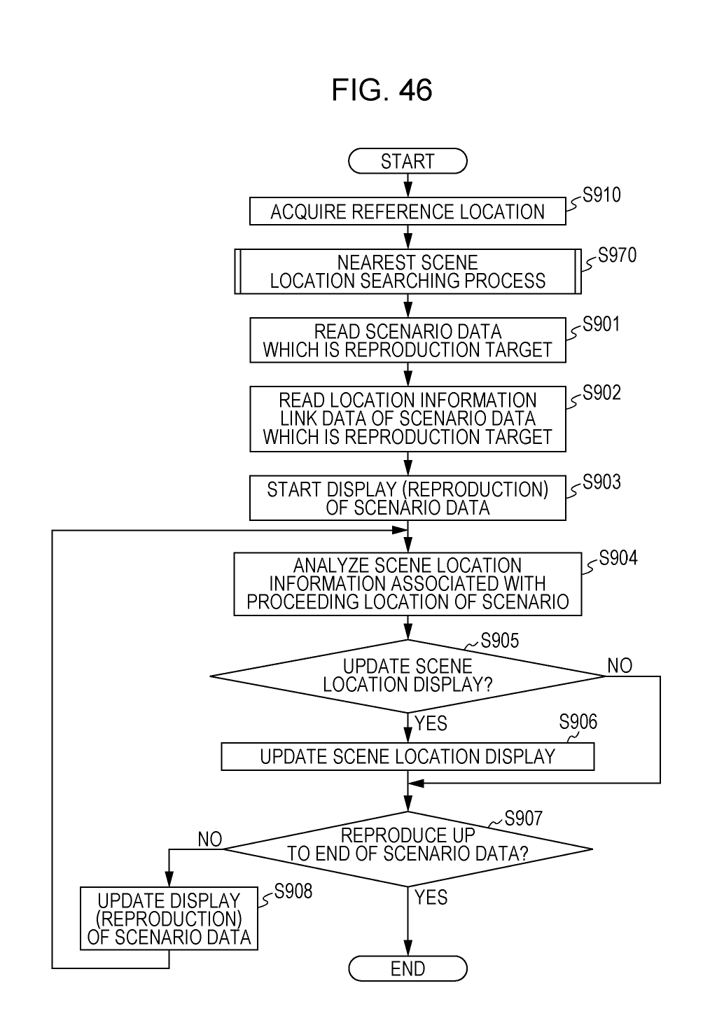

FIG. 46 is a flowchart showing a procedure example when performing the scenario display and the scene display by the display device 10 of the tenth embodiment of the present technology. The procedure of the tenth embodiment is different from that of the first embodiment in that Steps S910 and S970 are further executed by the di lay device 10.

Operation Example of Display Device

The display device 10 acquires the reference location (Step S910). The display device 10 executes a nearest scene location searching process for searching the scene location nearest to the reference location (Step S970). After the Step S970, the display device 10 receives selection manipulation of the scenario data corresponding to the nearest scene location or another scenario data. If any of the scenario data items is selected, the display device 10 reads the scenario data (Step S901). The display device 10 executes steps S910 and 3970 before starting the reproduction of the scenario data, however may execute during the reproduction or after finishing the reproduction.

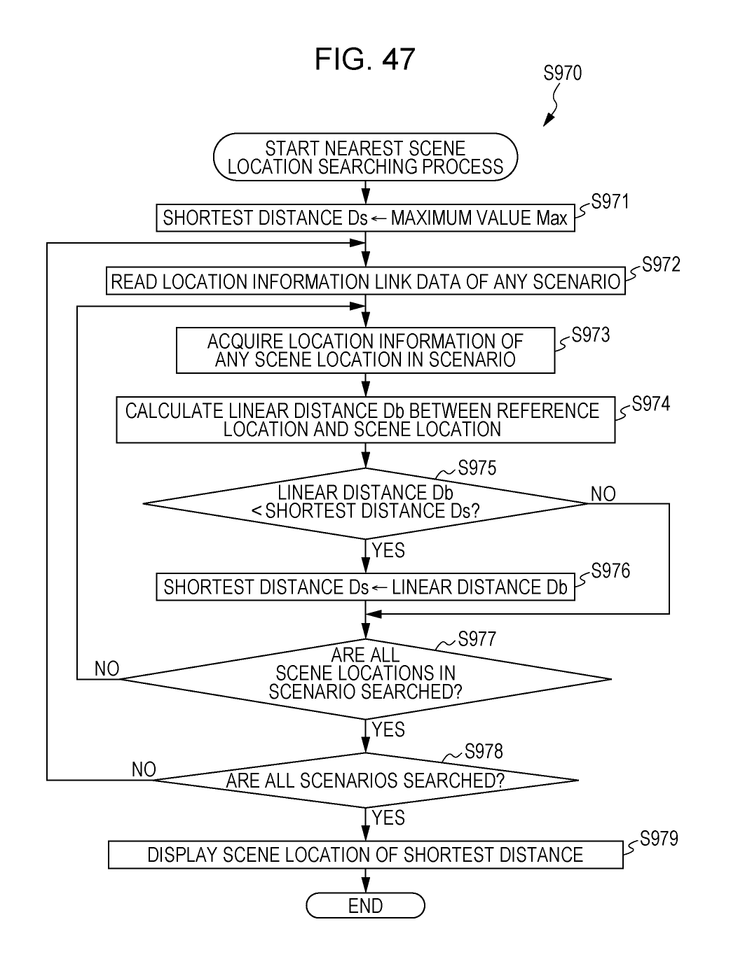

FIG. 47 is a flowchart showing an example of the nearest scene location searching process of the tenth embodiment of the present technology. The display device 10 sets a maximum value Max to a shortest distance Ds (Step S971). Herein, the shortest distance Ds is a variable showing a minimum value of the linear distance between the reference location and the scene location. The maximum value Max is a fixed value showing the maximum value in values which can be used as the shortest distance Ds.

The display device 10 reads the location information link data of any scenario data (Step S972), and acquires the location information of any scene location in the scenario data (Step S973). Then, the display device 10 calculates a linear distance Db between the reference location and the scene location (Step S974).

The display device 10 determines whether or not the linear distance Db is shorter than the shortest distance Ds (Step S975). In a case where the linear distance Db is shorter than the shortest distance Ds (Step S975; Yes), the display device 10 updates the shortest distance Ds by the linear distance Db. In addition, the location information or the name of the scene location at which the shortest distance Ds is calculated, is held (Step S976). In a case where the linear distance Db is shorter than the shortest distance Ds (Step S975; No) or after Step S976, the display device 10 determines whether or not all scene locations in the scenario data is searched (Step S977).

In a case where some scene locations are not searched (Step S977; No), the display device 10 returns to Step S973. On the other hand, in a case where all, scene locations are searched (Step S977; Yes), the display device 10 determines whether or not all scenario data items are searched (Step S978). In a case where some scenario data items are not searched (Step S978; No), the display device 10 returns to Step S972. On the other hand, in a case where all scenario data items are searched (Step S978; Yes), the display device 10 displays the scene location of the shortest distance Ds (Step S979). After Step S979, the display device 10 ends the nearest scene location searching process. In Step S979, the display device 10 may further display the nearest scene location and the name of the scenario data corresponding to the scene location.

As described above, according to the tenth embodiment of the present technology, since the display device 10 displays the scene location having the shortest linear distance from the reference location, a user can easily acquire the nearest scene location. Accordingly, the convenience is further improved.

### First Modification Example

In the tenth embodiment of the present technology, the display device 10 calculates the linear distance as the cost, however, in a case where the terrain is not flat or in a case where a user moves through traffic networks, the linear distance may not coincide with the actual cost. The display device 10 of the first modification example is different from that of the tenth embodiment in that accurate cost is calculated by path searching on the traffic networks.

Example of Data Held in Memory Unit

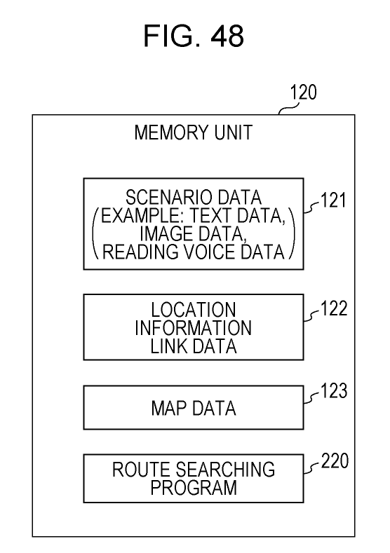

FIG. 48 is a diagram schematically showing an example of information stored in location information link data held in the memory unit 120 of the first modification example of the tenth embodiment of the present technology. A route searching program 220 is further held in the memory unit 120 of the first modification example.

The route searching program 220 is a program for searching a shortest path with the smallest cost, among paths connecting the reference location and the scene location to each other on traffic networks. The Dijkstra's Algorithm is used for example, in searching of the shortest path. The route searching program 220 may have a configuration of holding a route searching server connected to the display device 10 by the traffic networks. In this case, the display device 10 transmits the reference location and the scene location to the route searching server, and acquires the cost between the locations received by the route searching server to transmit the cost display device 10.

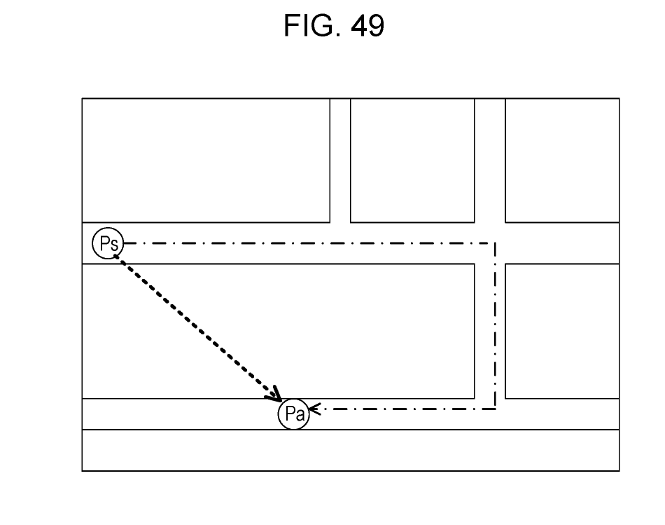

FIG. 49 is a diagram showing an example of a calculating method of the cost of the first modification example of the tenth embodiment of the present technology. A case of an obstacle such as a building exists between the reference location Ps and the scene location Pa is considered. In this case, a user has to move from the reference location Ps to the scene location Pa through the path (a street or the like) for making detour around the obstacle. A dashed line of FIG. 47 is an example of the path for making detour around the obstacle. In such a case, the linear distance does not coincide with the actual cost. Herein, the display device 10 of the first modification example searches the path on the traffic networks and accurately calculates the minimum cost.

Operation Example of Display Device

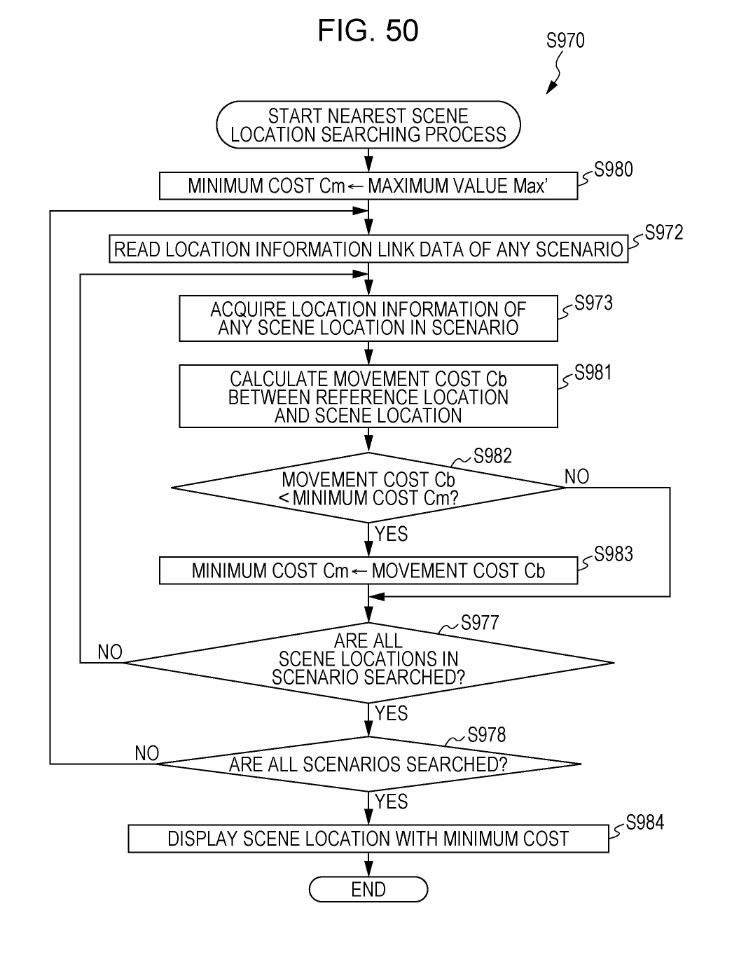

FIG. 50 is a flowchart showing an example of the nearest scene location searching process of the first modification example of the tenth embodiment of the present technology. The nearest scene location searching process of the first modification example is different from that of the tenth embodiment in that Steps S980 to S984 are executed instead of the Steps S971, S974 to S976, and S979.

The display device 10 sets a maximum value Max′ to the minimum cost Cm (Step S980), and executes Step S972. Herein, the minimum cost Cm is a variable showing a minimum value of the cost between the reference location and the scene location. The maximum value Max′ is a fixed value showing a maximum value in values which can be used as the minimum cost Cm.

After the Step S973, The display device 10 executes the route searching program 220, searches a shortest path between the reference location and the scene location, and calculates movement cost Cb of the shortest path (Step S981). The display device 10 determines whether or not the movement cost Cb is smaller than the minimum cost Cm (Step S982). In a case where the movement cost Cb is smaller than the minimum cost Cm (Step S982; Yes), the display device 10 updates the minimum cost Cm by the movement cost Cb. The location information or the name of the scene location at which the minimum cost Cm is calculated, is held (Step S983). In a case where the movement cost Cb is equal to or greater than the minimum cost Cm (Step S982; No) or after Step S983, the display device 10 executes Step S977.

In a case where all scenario data items are searched (Step S978; Yes), the display device 10 displays the scene location having the minimum cost (Step S984).

As described above, according to the first modification example of the present technology, since the display device 10 calculates the cost of the path on the traffic networks, the more accurate cost than the case of calculating the linear distance can be acquired.

### Second Modification Example

In she tenth embodiment, the display device 10 acquires cost regardless of the importance of the scene location. However, the display device 10 may perform weighting to the cost based on the importance of the scene location. The display device 10 of the second modification example is different from that of the tenth embodiment in a that weighting to the cost is performed using a weight coefficient set for each scene location.

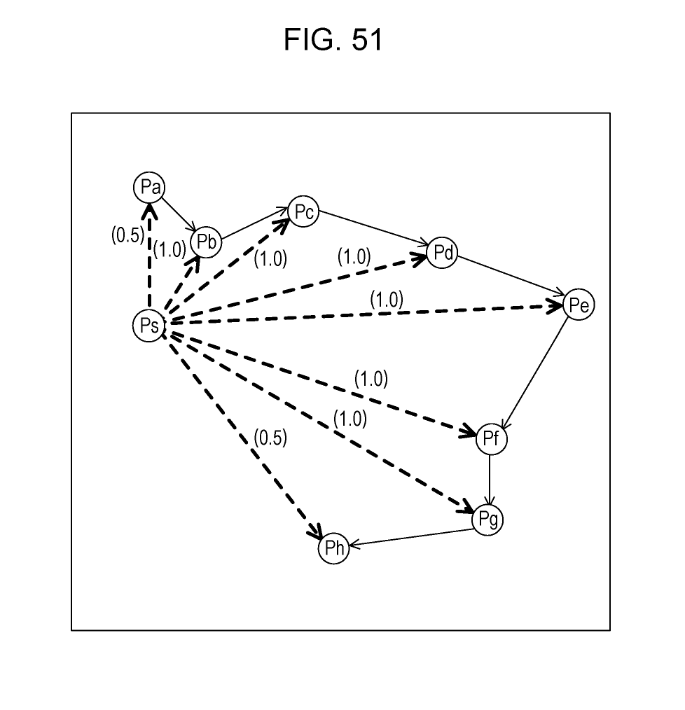

FIG. 51 is a diagram showing an example of a setting method of the weight coefficient of the second modification example of the tenth embodiment of the present technology. In FIG. 51, Ps denotes the reference location and Pa to Ph denote the scene locations. A length of a dotted line from the reference location. Ps to each of the scene locations Pa to Ph shows a length of the linear distance. A numerical value attached on the dotted line is a weight coefficient. The scene location Pa is a scene location corresponding to an initial reproduction location, and the scene location Ph is a scene location corresponding to the last reproduction location.

If the scene location is the scene location at the initial or the last reproduction location, the display device 10 sets the weight coefficient (for example, 0.5) which is smaller than the other scene location. On the other hand, if the scene location is the scene location at the reproduction location in the middle, the display device 10 sets a large weight coefficient (for example, 1.0). The display device 10 performs weighting of the cost by the set weight coefficient, and acquires the scene location corresponding to the minimum cost. Since the scene location at the initial, or the last reproduction location has high importance in the scenario, by setting the weight coefficient of the scene location small, the scene location having high importance is preferentially searched.

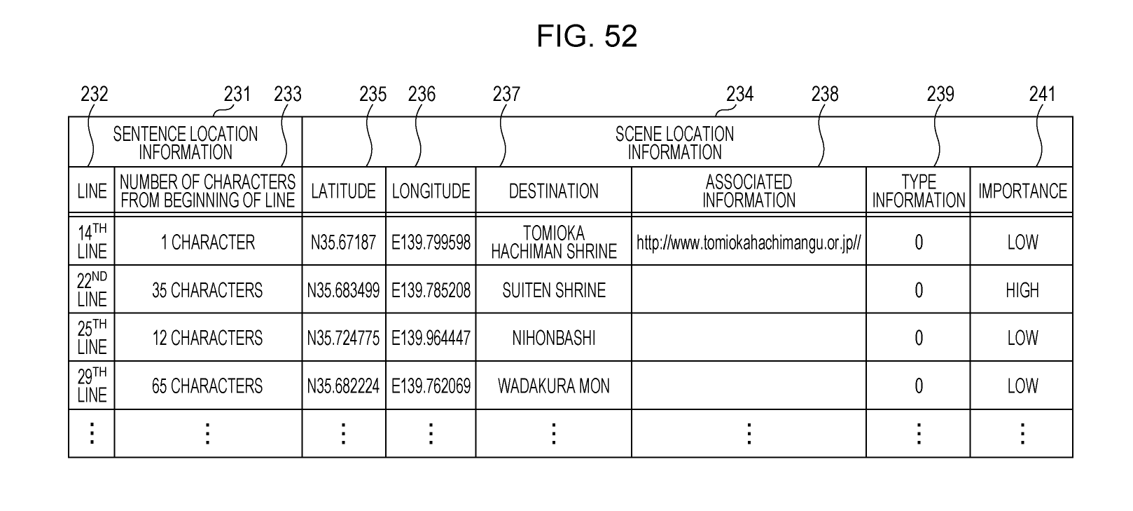

In the location information link data, if the scene locations are sorted in order of the reproduction locations in advance, the display device 10 can easily acquire the scene location corresponding to the initial or the last reproduction location. Accordingly, it is not necessary to disclose she importance or the weight coefficient in the location information link data. Although the scene location is the scene location corresponding to the reproduction location in the middle, the importance in the scenario may be high. In this case, as shown in FIG. 52, in the location information link data, information 241 showing the importance may be disclosed to correspond to the scene location. In addition, in the location information link data, the weight coefficient which is previously set for each scene location may be disclosed.

Operation Example of Display Device

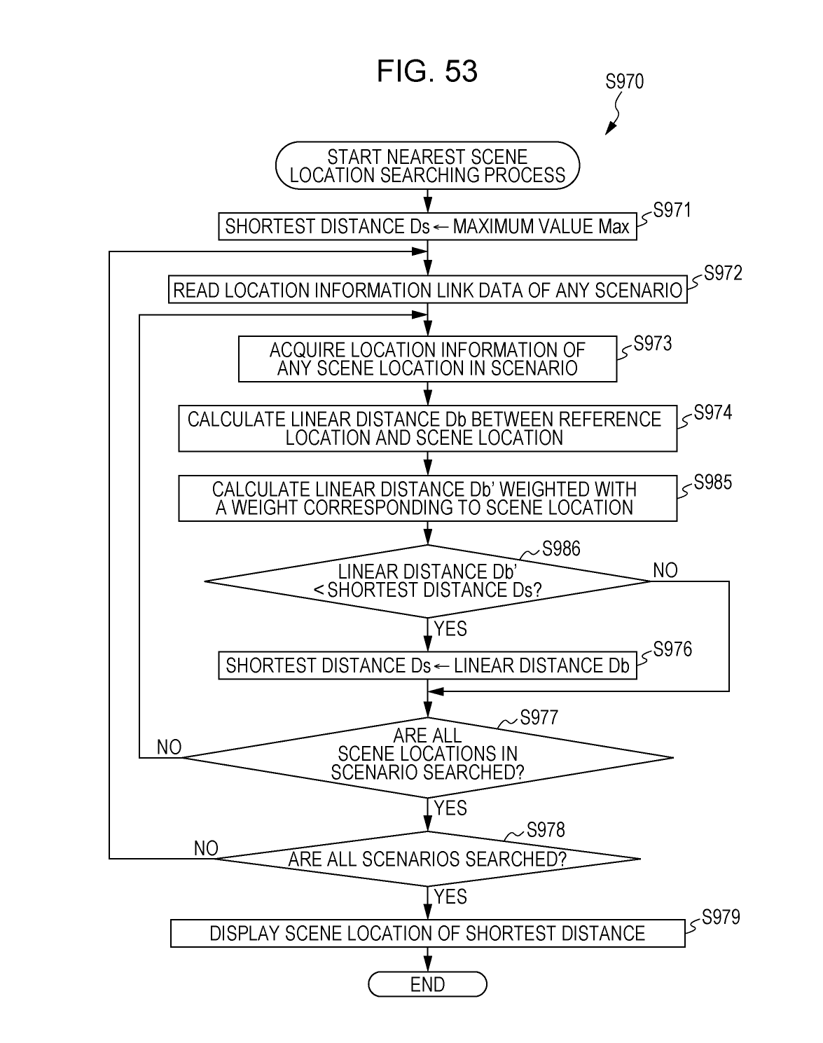

FIG. 53 is a flowchart showing an example of the nearest scene location searching process of the second modification example of the tenth embodiment of the present technology. The nearest scene location searching process of the second modification example is different from that of the tenth embodiment in that Steps S985 and S986 are executed instead of Steps S975 and S976.

After calculating the linear distance Db (Step S974), the display device 10 calculates a linear distance Db′ weighted by the weight coefficient corresponding to the scene location (Step S985). The display device 10 determines whether or not the linear distance Db′ is shorter than the shortest distance Ds (Step S986). In a case where the linear distance Db′ is shorter than the shortest distance Ds (Step S986; Yes), the display device 10 executes Step S976, and if it is not the case (Step S986; No) or after Step S976, the display device executes Step S977.

As described above, according to the second modification example of the present technology, since the display device 10 acquires the cost weighted by she weight coefficient set for each scene location, the scene location having the small weight coefficient can be preferentially searched. Accordingly, if the small weight coefficient is set as the high importance, the scene location with the high importance is preferentially searched.

### Third Modification Example

In the tenth embodiment of the present technology, the display device 10 acquires the cost regardless of the date and time of the scene location. However, the weighting to the cost may be performed based on a length of a period between the reference date and time and the date and time associated with the scene location. The display device 10 of the third modification example is different from that of the tenth embodiment in that weighting to the cost is performed based on a length of a period between the reference date and time and the date and time associated with the scene location.

Operation Example of Display Device

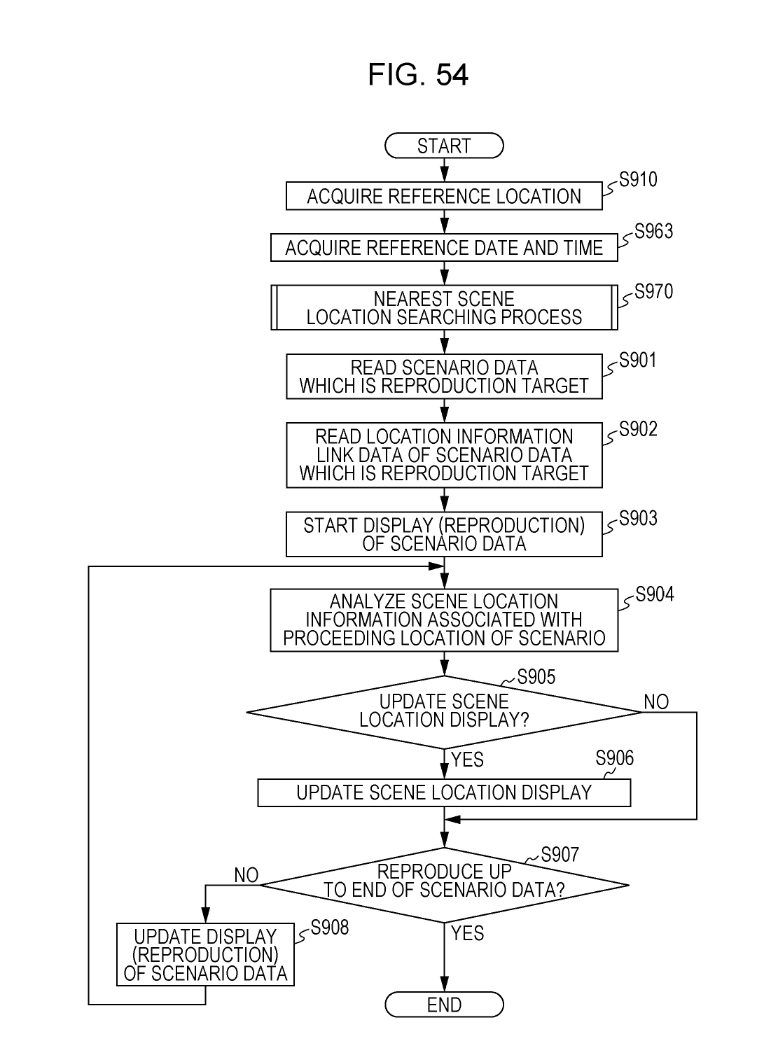

FIG. 54 is a flowchart, showing a procedure example when performing the scenario display and the scene display by a display device 10 of the third modification example of the tenth embodiment of the present technology. The procedure of the third modification example is different from that of the tenth embodiment in that Step S963 is further executed by the display device 10.

The display device 10 acquires the reference location (Step S910), and acquires the reference date and time (Step S963). Then, the display device 10 executes the nearest scene location searching process (Step S970).

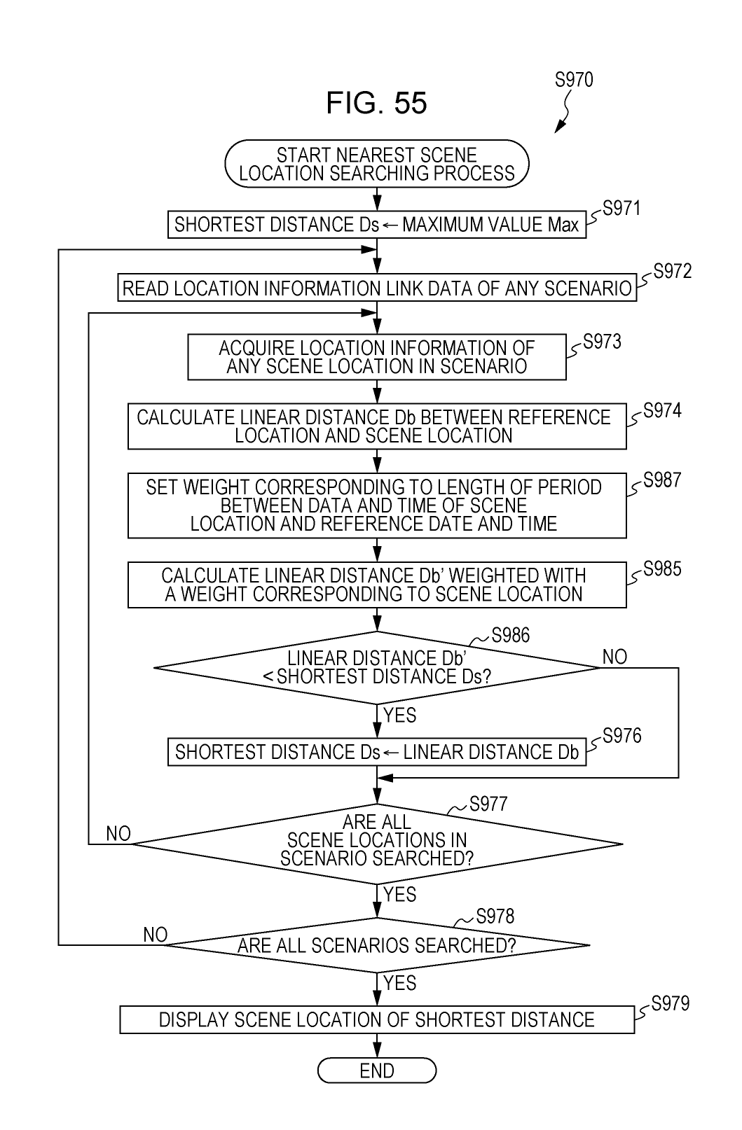

FIG. 55 is a flowchart showing an example of the nearest scene location searching process of the third modification example of the tenth embodiment of the present technology. The nearest scene location searching process of the third modification example is different from that of the second modification example in that Step S987 is further executed. The display device 10 calculates the linear distance Db (Step S974), and sets a weight coefficient based on the length of a period between the date and time associated with the scene location and the reference date and time. For example, the display device 10 sets a small weight coefficient as the period thereof is short (Step S987). Then, the display device 10 calculates the linear distance Db weighted by the weight coefficient (Step S985).

As described above, according to the third modification example of the present technology, since the display device 10 acquires the cost weighted according to the length of the period from the reference date and time, the scene location can be searched based on the length from the reference location.

### Fourth Modification Example

In the tenth embodiment of the present technology, the display device 10 acquires the cost of all scene locations and acquires the minimum cost by comparing those. However, the minimum cost can be acquired more efficiently. In detail, a location on an apex of a region having a given shape surrounding all scene locations in the contents are held as a representative location for each contents item, and the display device 10 acquires cost (herein, referred to as “representative cost”) from the reference location to the representative location for each contents item. Then, the display device 10 may acquire each cost of all scene locations in the contents having relatively low representative cost, and may acquire the minimum cost among those. Accordingly, since the display device 10 may not acquire the cost of all scene location for the contents having relatively large representative cost, the minimum cost can be efficiently acquired. The display device 10 of the fourth modification example is different from chat of the tenth embodiment in that the cost is acquired for each scene location in the contents selected based on the representative cost.

Example of Data Held in Memory Unit

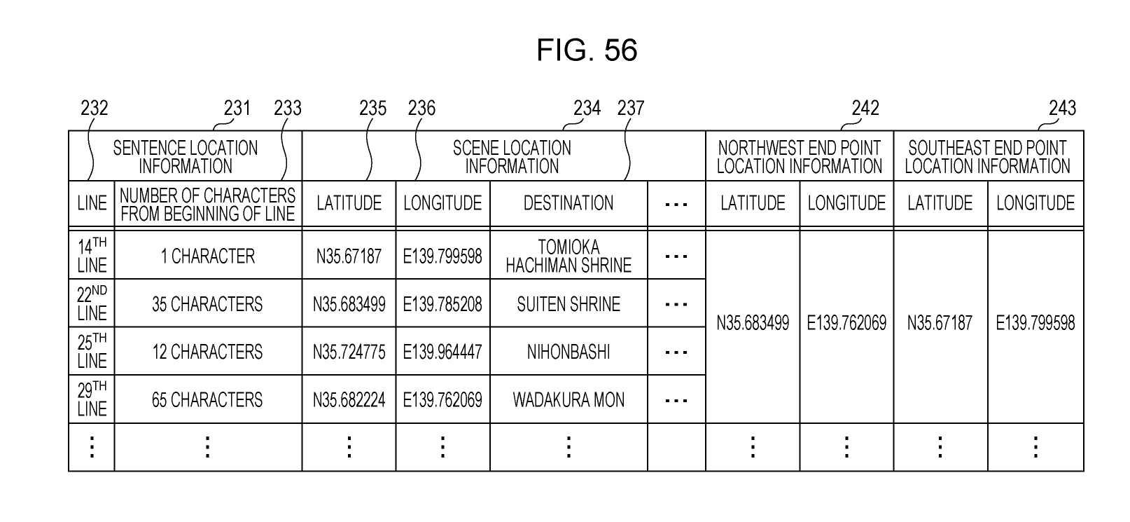

FIG. 56 is a diagram schematically showing an example of the information stored in the location information link data held in the memory unit 120 of the fourth modification example of the tenth embodiment of the present technology. Northwest end point location information 242 and southeast end point location information 243 are further included in the location information link data of the fourth modification example as location information of the representative location. The northwest end point location information 242 is location information of a northwest end point, in a rectangular region surrounding all scene locations in the contents, and the southeast end point location information 243 is location information of a southeast end point in the region thereof.

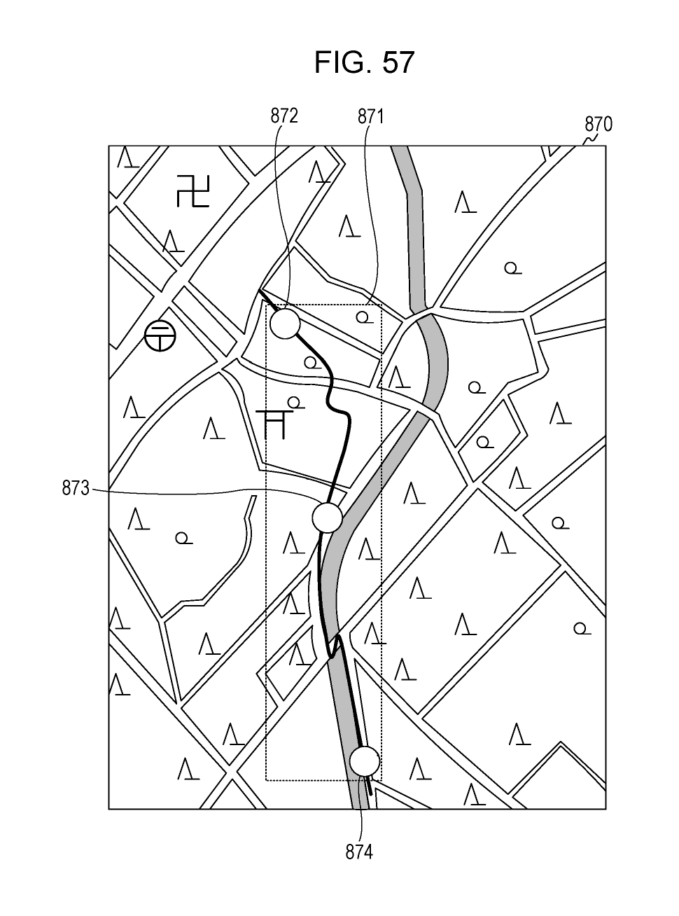

FIG. 57 is a diagram showing an example of the representative location of the fourth modification example of the tenth embodiment of the present technology. Scene locations 872, 873, and 874 in the certain scenario data are included on a map 870. A northwest end point, a northeast end point, a southeast end point, and a southwest end point of a rectangular scene region 871 surrounding all scene locations are used as representative locations. Since coordinates of the northeast end point and the southwest end point among them can be acquired from the northwest end point and the southeast end point, location information of the northwest end point (scene location 872) and the southeast end point (scene location 874) are disclosed in the location information link data as the location information of the representative locations. The shape of the region surrounding the scene location is not limited to the rectangle, and may also be a hexagon.

Operation Example of Display Device

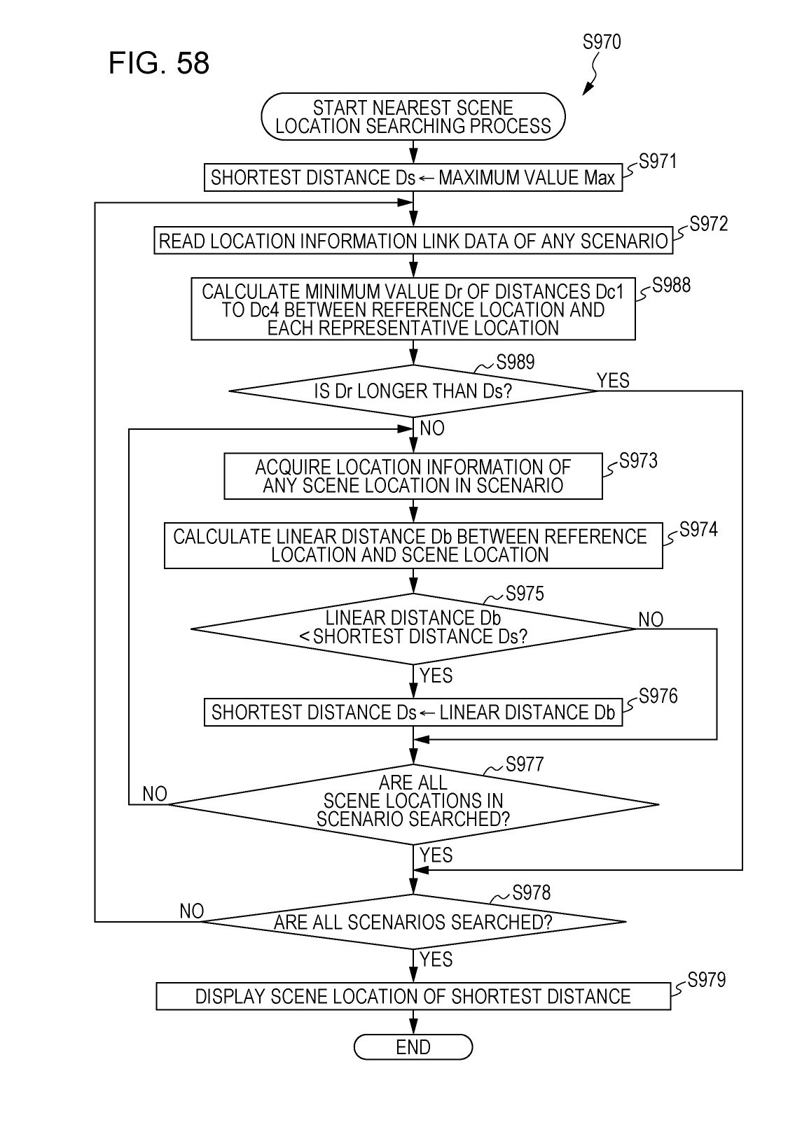

FIG. 58 is a flowchart showing an example of the nearest scene location searching process of the fourth modification example of the tenth embodiment of the present technology. The nearest scene location searching process of the fourth modification example is different from that of the tenth embodiment in that Steps S988 and S989 are further executed.

The display device 10 reads the location information link data of any scenario data (Step S972), acquires our representative locations, and calculates a minimum value from linear distances Dc1 to Dc4 between the reference location and the representative locations, as a representative distance Dr (that is, representative cost) (Step S988). The display device 10 determines whether or not the representative distance Dr is longer than the shortest distance Ds (Step S989). In a case where the representative distance Dr is longer than the shortest distance Ds (Step S989; Yes), the display device 10 determines whether or not all scenario data items are searched (Step S978). On the other hand, in a case where the representative distance Dr is not longer than the shortest distance Ds (Step S989; No), the display device 10 acquires the location information of any scene location in the scenario data (Step S973). In Step S989, the display device 10 compares the shortest distance Ds of the certain contents and the representative distance Dr of the other contents, however it is not limited to this configuration. For example, the display device 10 may acquire the shortest representative distance from the representative distances of all contents items, and may acquire a linear distance for each scene location independently in the contents with the shortest representative distance.

As described above, according to the fourth modification example of the tenth embodiment of the present technology, by acquiring the cost for each scene location in the contents selected based on the representative cost, the scene location with the minimum cost can be efficiently acquired. Accordingly, the time for searching the nearest scene location is shortened,

### 11. Eleventh Embodiment

In the first embodiment of the present technology, the display device 10 displays the scene location regardless of the distance from the specific reference location (location at which the display device 10 exists). However, by searching and displaying a scene location in a given distance from the reference location, a user can grasp the scene location to which a user can easily visit. Accordingly, the convenience is further improved. The display device 10 of the eleventh embodiment is different from that of the first embodiment in that the scene location in a given distance from the reference location is searched and displayed.

Operation Example of Display Device

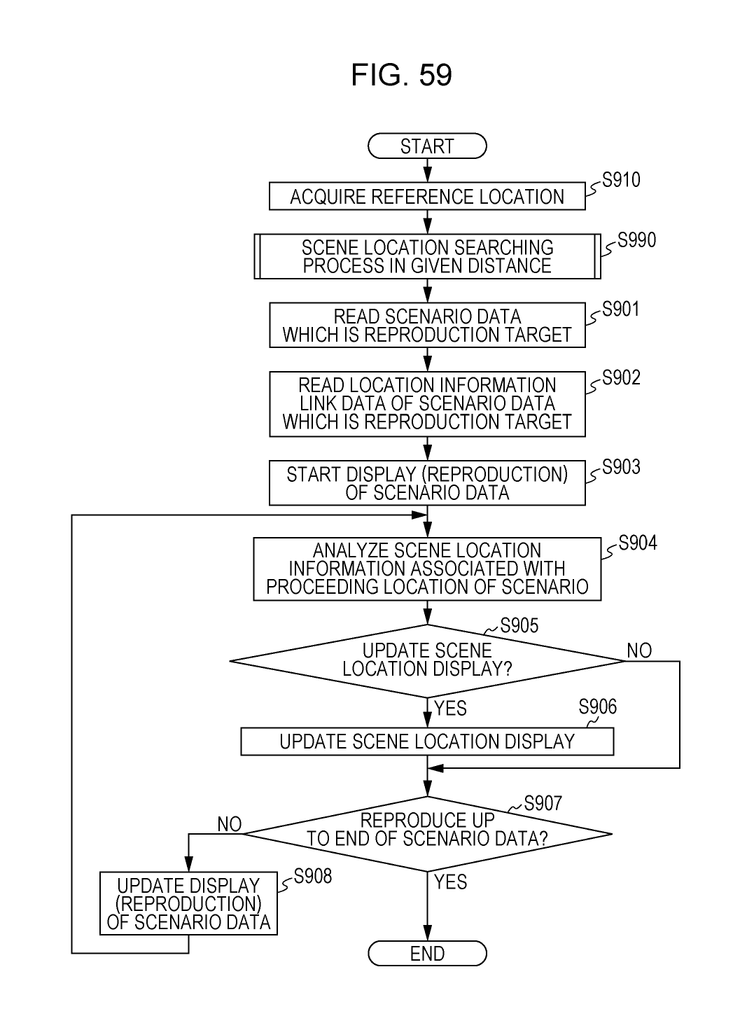

FIG. 59 is a flowchart, showing a procedure example when performing the scenario display and the scene display by the display device 10 of the eleventh embodiment of the present technology. The procedure of the eleventh embodiment is different from that of the first embodiment in that Steps S910 and S990 are further executed by the display device 10.

The display device 10 acquires the reference location (Step S910), and executes a scene location searching process in a given distance for searching the scene location in a given distance from the reference location (Step S990). If any of the scene locations in a given distance is selected as a reproduction target by a user, the display device 10 reads the location information link data of the scenario data corresponding to the selected scene location (Step S902). The display device 10 executes Steps S910 and S990 before starting the reproduction of the scenario data, however, may execute the steps in reproduction or after finishing reproduction.

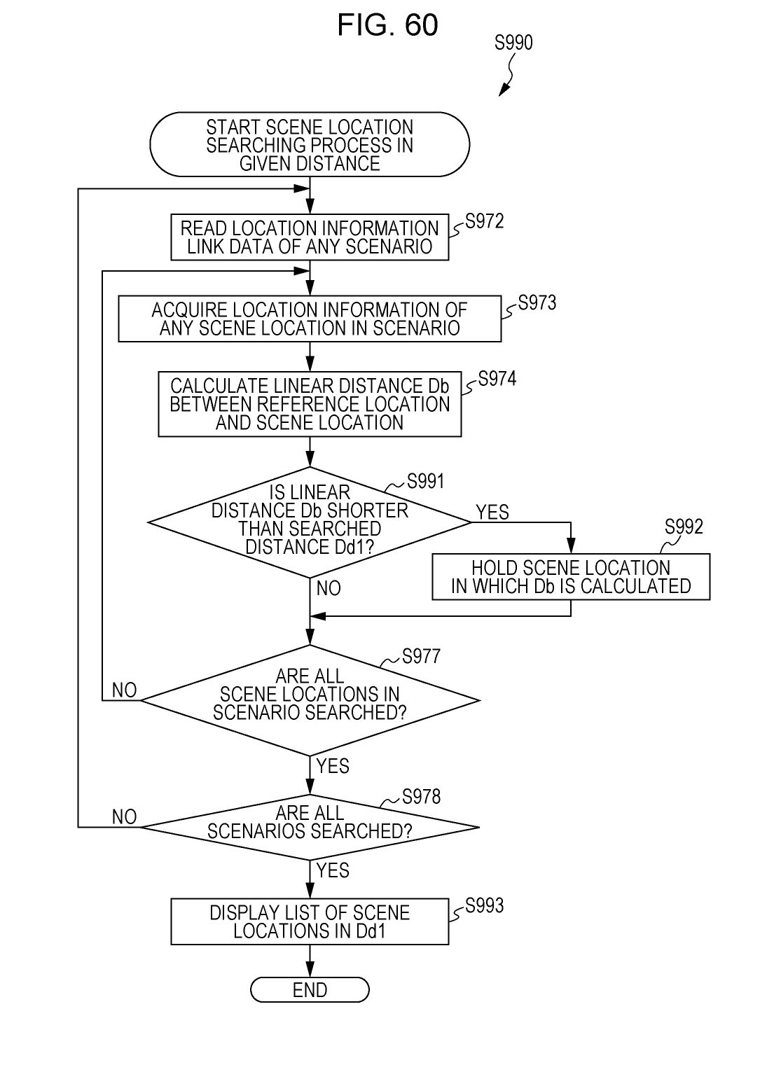

FIG. 60 is a flowchart showing an example of the scene location searching process in a given distance of the eleventh embodiment of the present technology. The display device 10 reads the location information link data of any scenario data (Step S972), and acquires the location information of any scene location in the scenario data (Step S973). Then, the display device 10 calculates the linear distance Db between the reference location and the scene location (Step S974).

The display device 10 determines whether or not the linear distance Db is shorter than a given searched distance Dd1 (Step S991). In a case where the linear distance Db is shorter than the searched distance Dd1 (Step S991; Yes), the display device 10 holds the scene location at which the linear distance Db is calculated (Step S992). In a case where the linear distance Db is not shorter than the searched distance Dd1 (Step S991; No) or after Step S992, the display device 10 determines whether or not all scene locations in the scenario data are searched (Step S977).

In a case where some scene locations are not searched (Step S977; No), the display device 10 returns to Step S973. On the other hand, in a case where all scene locations are searched (Step S977; Yes), the display device 10 determines whether or not all scenario data items are searched (Step S978). In a case where some scenario data items are not searched (Step S978; No), the display device 10 returns to Step S972. On the other hand, in a case where all scenario data items are searched (Step S978; Yes), the display device 10 displays a list of the scene locations in a given distance (Step S993). After Step S993, the display device 10 ends the scene location searching process in a given distance. In Step S993, in addition to the scene location in a given distance, the display device 10 may further display the name of the scenario data corresponding to the scene location.

As described above, according to the eleventh embodiment of the present technology, since the display device 10 displays the scene location in a given distance from the reference location, a user can easily acquire the scene location to which a user can easily visit. Accordingly, the convenience is further improved.

### Modification Example

In the eleventh embodiment of the present technology, the display device 10 acquires the reference location, and does not search the scene location again although the reference location is newly acquired after searching the scene location in a given distance. However, in a case where the reference location is newly acquired, it is desirable to search the scene location in a given distance again based on the new reference location. The display device 10 of the modification example is different from that of the eleventh embodiment in a that the scene location in a given distance is searched again, if the reference location is newly acquired.

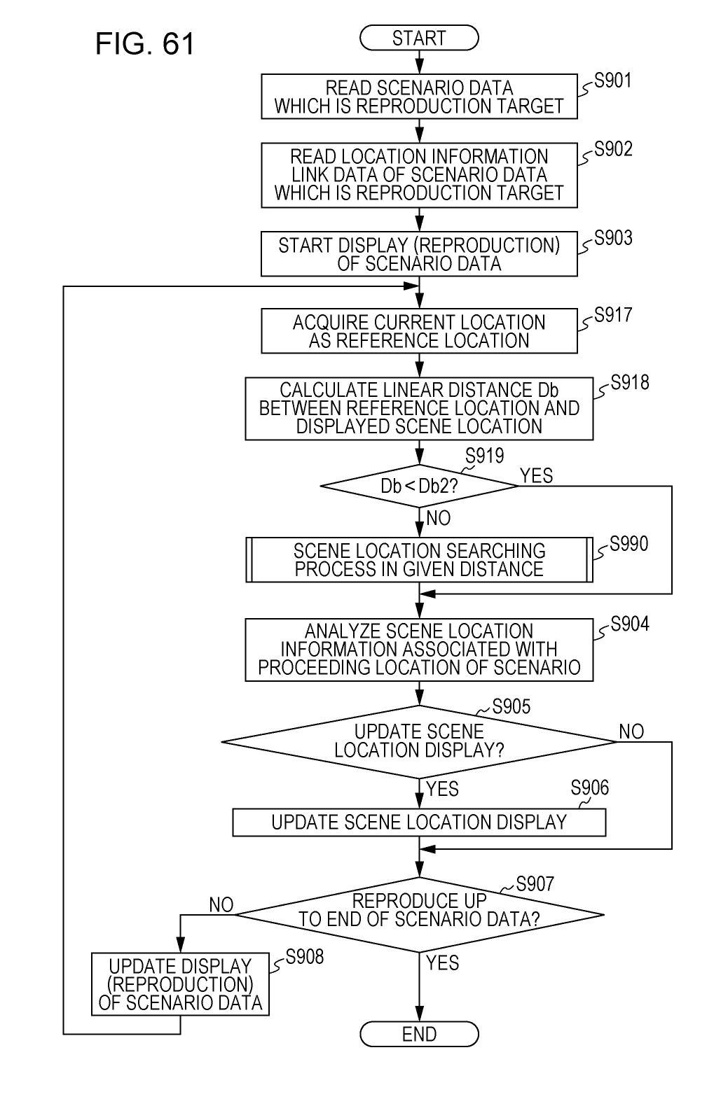

FIG. 61 is a flowchart showing a procedure example when performing the scenario display and the scene display by the display device 10 of the modification example of the eleventh embodiment of the present technology. This procedure is different from that of the tenth embodiment, in that Steps S917, S918, and S919 are executed instead of Step S910, and in that the scene location being reproduced of the contents is searched.

After starting the display of the scenario data (Step S903), the display device 10 acquires the current location of the display device 10 as the reference location (Step S917). The display device 10 calculates the linear distance Db between the reference location and the scene location being displayed (Step S918). Then, the display device 10 determines whether or not the linear distance Db is shorter than a searched distance Db2 (Step S919). In a case where the linear distance Db is not shorter than the searched distance Db2 (Step S919; No), the display device 10 executes the scene location searching process in given distance (Step S990). In a case where the linear distance. Db is shorter than the searched distance. Db2 (Step S919; Yes) or after Step S990, the display device 10 executes Steps S904 to S908. After Step S908, the display device 10 returns to Step S917.

As described above, according to the modification example of the eleventh embodiment of the present technology, since the display device 10 searches the scene location again if the reference location is newly acquired after the scene location searching, a user can easily acquire the scene location to which a user can easily visit even when the reference location is changed. Accordingly, the convenience is further improved.

In the embodiments of the present technology, it is assumed that the progress of the scenario is automatic, however the progress is not limited thereto, and may occur manually. For example, an icon showing a current progressing location is displayed on the display screen of the contents, and the icon is moved by the user manipulation. Accordingly, the display device can recognize the location (progressing location) where a user is currently reading the contents, and the scene location corresponding to the progressing location can be displayed.

In the embodiments of the present technology, it is preferable to perform the contents display and the scene display at the same time, and accordingly the display device including two display screens is assumed and described. However, it is not limited thereto, and for example, the screen may be divided into two screens and be displayed in the display device having one screen. In addition, in the display device having one screen, a user may switch the display by tab. In a case of switching the display, the display device may automatically switch the display of the contents and the scene display at a proper time.

In the embodiments of the present technology, the example of preparing one location information link data item with respect to one scenario data item is assumed, however it is not limited thereto. For example, the plurality of location information link data items, such as location information link data created by a publisher of the contents of the scenario data, or location information link data created by a fan, may exist. In such a case, the location information link data to be used may be set to be selected, so that a user can display the location information link data which the user wants to display.

The embodiments described above are shown as examples for realizing the present technology, and matters of the embodiments and matters used to define the technology of claims have correspondence. In the same manner, the matters used to define the technology of claims and she matters of the embodiments of the present technology with the same terms with those have correspondence. However, the present technology is not limited to the embodiments, and can be realized by performing various modifications to the embodiments in a scope not departing from the gist thereof.

The procedure described in the embodiment may be understood as a method including the series of procedure, or may be understood as a program for causing a computer to execute the series of procedure or a recording medium which records the program thereof. As the recording medium, a hard disk, a compact disc (CD), a mini disc (MD), a digital versatile disk (DVD), a memory card, a Blu-ray disc (trademark), or the like can be used, for example.

The present technology has the following configurations.

(1) An information processing apparatus including: a link information acquisition unit which acquires link information obtained by associating a reproduction location of contents with geographic information regarding geography associated with a story of the contents at the reproduction location; and a display control unit which performs control for displaying a geographic image based on the geographic information associated with the story of the contents being reproduced, based on the acquired link information and the reproduction location of the contents being reproduced.

(2) The information processing apparatus according to (1), wherein the geographic information includes the latitude and the longitude, and the display control unit performs control for displaying a map to which a reproduction location mark which is a mark showing a location on a map specified in the geographic information associated with the reproduction location being reproduced is attached, as the geographic image.

(3) The information processing apparatus according to (2), wherein the link information further includes a date and time associated with the geographic information, and the display control unit performs control for displaying the date and time associated with she geographic information corresponding to a selected reproduction location mark, if any of the reproduction location mark is selected.

(4) The information processing apparatus according to (2) or (3), wherein the display control unit performs control for displaying the map to which an apparatus location mark which is a mark showing a location on a map at which the information processing apparatus exists is further attached.

(5) The information processing apparatus according to any one of (2) to (4), wherein the display control unit performs control for displaying the map to which associated location information which is associated with the story of the contents and is regarding a feature on the map is further attached.

(6) The information processing apparatus according to (5), wherein the associated location information is point-of-interest (POI) information, and the display control unit performs control for displaying the map to which the associated location information is further attached, in a case where the display of the POI information is allowed.

(7) The information processing apparatus according to (5) or (6), wherein the display control unit performs control for displaying the map to which an associated information mark which is a mark showing a location on a map at which the associated location information exists is further attached, and displaying associated location information at a location of the associated information mark, in a case where a distance between the reproduction location mark and the associated information mark is shorter than a set distance.

(8) The information processing apparatus according to any one of (1) to (7), further including: a reproduction history information acquisition unit which acquires reproduction history information showing whether or not the contents are reproduced; and a setting unit which sets a predetermined value to the set distance in a case where the reproduction history information shows that the contents are not reproduced, and sets a value greater than the predetermined value to the set distance in a case where the reproduction history information shows that the contents are reproduced.

(9) The information processing apparatus according to any one of (1) to (8), wherein the display control unit attaches and displays a mark for specifying a reproduction location being reproduced, on a contents image based on the contents.

(10) The information processing apparatus according to any one of (1) to (9), wherein the display control unit attaches and displays a mark for specifying a reproduction location associated with the geographic information in the link information, on a contents image based on the contents.

(11) The information processing apparatus according to any one of (1) to (10), wherein the contents are data configured to have one or a plurality of text contents, image contents, and audio contents.

(12) The information processing apparatus according to any one of (1) to (11), wherein the geographic information includes the latitude and the longitude and information associated with a feature at a location specified in the latitude and the longitude.

(13) The information processing apparatus according to any one of (1) to (12), wherein the display control unit performs control for displaying a virtual map to which the reproduction location mark showing a location on a virtual map specified in the geographic information associated with the reproduction location being reproduced and a mark showing that it is the virtual map are attached, as the geographic image.

(14) The information processing apparatus according to any one of (1) to (13), wherein the link information includes two geographic information items, and the display control unit performs control for displaying the geographic image including one of the two geographic information items, and displaying the geographic image including the other one of the two geographic information items after displaying the geographic image including both of the two geographic information items.

(15) The information processing apparatus according to any one of (1) to (14), wherein the link information includes two geographic information items, and the display control unit performs control for displaying the geographic image including one of the two geographic information items and the geographic image including the other one of the two geographic information items at the same time.

(16) The information processing apparatus according to any one of (1) to (15), wherein the link information includes two geographic information items, and the display control unit performs control for selecting and displaying any of the geographic image including one of the two geographic information items and the geographic image including the other one of the two geographic information items based on the user manipulation.

(17) The information processing apparatus according to any one of (1) to (16), wherein the geographic image is an image obtained by combining a map image and a photograph image.

(18) The information processing apparatus according to any one of (1) to (17), further including: a reproduction history information acquisition unit which acquires reproduction history information showing whether or not the contents are reproduced, wherein the display control unit performs control for displaying the geographic image which is different from that of a case in which the reproduction history information shows that the contents are not reproduced, in a case in which the reproduction history information shows that the contents are reproduced.

(19) The information processing apparatus according to any one of (1) to (18), wherein the link information further includes a date and time associated with the geographic information, and the display control unit performs control for selecting and displaying the geographic information based on a length of a period between a specified reference date and time and a date and time associated with the geographic information.

(20) The information processing apparatus according to any one of (1) to (19), further including: a cost acquisition unit which acquires individual cost which is cost necessary for movement from a specified reference location to a location shown by each of the geographic information items, for each geographic information item, wherein the display control unit performs control for selecting and displaying the geographic information based on the individual, cost.

(21) The information processing apparatus according to (20), wherein the display control unit performs control for selecting and displaying the geographic information with the minimum individual cost.

(22) The information processing apparatus according to (20) or (21), wherein the link information further includes locations at apexes of a region having a predetermined shape surrounding each of the geographic information items corresponding to the contents as representative locations for each contents, and the cost acquisition unit acquires representative cost which is cost necessary for movement from the reference location to the representative location for each contents, to acquire the individual cost of each of the geographic information items corresponding to the contents selected based on the representative cost.

(23) The information processing apparatus according to any one of (20) to (22), wherein the cost acquisition unit acquires the individual cost obtained, by performing weighting for each of the geographic information items using a preset weight coefficient.

(24) The information processing apparatus according to any one of (20) to (23), wherein the link information further includes a date and time associated with the geographic information, and the cost acquisition unit acquires the individual cost obtained by performing weighting using a weight coefficient which is a value based on a length of a period between a specific reference date and time and the date and time associated with the geographic information.

(25) The information processing apparatus according to (20), wherein the display control unit performs control for executing a selection process which is a process of selecting and displaying each of the geographic information items having the individual cost smaller than a given value.

(26) The information processing apparatus according to (25), further including: a location acquisition unit which acquires the reference location a plurality of times, wherein the display control unit executes the selection process again based on a new reference location, in a case where the new reference location which is different from the predetermined location is acquired after executing the selection process based on the reference location of the predetermined location.

(27) An information processing method including: acquiring link information obtained by associating a reproduction location of contents with geographic information regarding geography associated with a story of the contents at the reproduction location; and performing control for displaying a geographic image based on the geographic information associated with the story of the contents being reproduced, based on the acquired link information and the reproduction location of the contents being reproduced.

(28) A program which causes a computer to execute: acquiring link information obtained by associating a reproduction location of contents with geographic information regarding geography associated with a story of the contents at the reproduction location; and performing control for displaying a geographic image based on the geographic information associated with the story of the contents being reproduced, based on the acquired link information and a reproduction location of the contents being reproduced.

What is claimed is:

1. An information processing apparatus comprising:
a link information acquisition unit which acquires link information obtained by associating a reproduction location of contents with geographic information regarding geography associated with a story of the contents at the reproduction location; and
a display control unit which performs control for displaying a geographic image based on the geographic information associated with the story of the contents being reproduced, based on the acquired link information and the reproduction location of the contents being reproduced.

2. The information processing apparatus according to claim 1,
wherein the geographic information includes the latitude and the longitude, and
the display control unit performs control for displaying a map to which a reproduction location mark which is a mark showing a location on a map specified in the geographic information associated with the reproduction location being reproduced is attached, as the geographic image.

3. The information processing apparatus according to claim 2,
wherein the link information further includes a date and time associated with the geographic information, and
the display control unit performs control for displaying the date and time associated with the geographic information corresponding to a selected reproduction location mark, if any of the reproduction location mark is selected.

4. The information processing apparatus according to claim 2,
wherein the display control unit performs control for displaying the map to which an apparatus location mark which is a mark showing a location on a map at which the information processing apparatus exists is further attached.

5. The information processing apparatus according to claim 2,
wherein the display control unit performs control for displaying the map to which associated location information which is associated with the story of the contents and is regarding a feature on the map is further attached.

6. The information processing apparatus according to claim 5,
wherein the associated location information is point-of-interest (POI) information, and
the display control unit performs control for displaying the map to which the associated location information is further attached, in a case where the display of the POI information is allowed.

7. The information processing apparatus according to claim 5,
wherein the display control unit performs control for displaying the map to which an associated information mark which is a mark showing a location on a map at which the associated location information exists is further attached, and displaying associated location information at a location of the associated information mark, in a case where a distance between the reproduction location mark and the associated information mark is shorter than a set distance.

8. The information processing apparatus according to claim 7, further comprising:
a reproduction history information acquisition unit which acquires reproduction history information showing whether or not the contents are reproduced; and
a setting unit which sets a predetermined value to the set distance in a case where the reproduction history information shows that the contents are not reproduced, and sets a value greater than the predetermined value to the set distance in a case where the reproduction history information shows that the contents are reproduced.

9. The information processing apparatus according to claim 1,
wherein the display control unit attaches and displays a mark for specifying a reproduction location being reproduced, on a contents image based on the contents.

10. The information processing apparatus according to claim 1,
wherein the display control unit attaches and displays a mark for specifying a reproduction location associated with the geographic information in the link information, on a contents image based on the contents.

11. The information processing apparatus according to claim 1,
wherein the contents are data configured to have, one or a plurality of text contents, image contents, and audio contents.

12. The information processing apparatus according to claim 1,
wherein the geographic information includes the latitude and the longitude and information associated with a feature at a location specified in the latitude and the longitude.

13. The information processing apparatus according to claim 1,
wherein the display control unit performs control for displaying a virtual map to which the reproduction location mark showing a location on a virtual map specified in the geographic information associated with the reproduction location being reproduced and a mark showing that it is the virtual map are attached, as the geographic image.

14. The information processing apparatus according to claim 1,
wherein the link information includes two geographic information items, and
the display control unit performs control for displaying the geographic image including one of the two geographic information items, and displaying the geographic image including the other one of the two geographic information items after displaying the geographic image including both of the two geographic information items.

15. The information processing apparatus according to claim 2,
wherein the link information includes two geographic information items, and
the display control unit performs control for displaying the geographic image including one of the two geographic information items and the geographic image including the other one of the two geographic information items at the same time.

16. The information processing apparatus according to claim 1,
wherein the link information includes two geographic information items, and
the display control unit performs control for selecting and displaying any of the geographic image including one of the two geographic information items and the geographic image including the other one of the two geographic information items based on the user manipulation.

17. The information processing apparatus according to claim 1,
wherein the geographic image is an image obtained by combining a map image and a photograph image.

18. The information processing apparatus according to claim 1, further comprising:
a reproduction history information acquisition unit which acquires reproduction history information showing whether or not the contents are reproduced,
wherein the display control unit performs control for displaying the geographic image which is different from that of a case in which the reproduction history information shows that the contents are not reproduced, in a case in which the reproduction history information shows that the contents are reproduced.

19. The information processing apparatus according to claim 1,
wherein the link information further includes a date and time associated with the geographic information, and
the display control unit performs control for selecting and displaying the geographic information based on a length of a period between a specified reference date and time and a date and time associated with the geographic information.

20. The information processing apparatus according to claim 1, further comprising:
a cost acquisition unit which acquires individual cost which is cost necessary for movement from a specified reference location to a location shown by each of the geographic information items, for each geographic information item,
wherein the display control unit performs control for selecting and displaying the geographic information based on the individual cost.

21. The information processing apparatus according to claim 20,
wherein the display control unit performs control for selecting and displaying the geographic information with the minimum individual cost.

22. The information processing apparatus according to claim 20,
wherein the link information further includes locations at apexes of a region having a predetermined shape surrounding each of the geographic information items corresponding to the contents as representative locations for each contents, and
the cost acquisition unit acquires representative cost which is cost necessary for movement from the reference location to the representative location for each contents, to acquire the individual cost of each of the geographic information items corresponding to the contents selected based on the representative cost.

23. The information processing apparatus according to claim 20,
wherein the cost acquisition unit acquires the individual cost obtained by performing weighting for each of the geographic information items using a preset weight coefficient.

24. The information processing apparatus according to claim 20,
wherein the link information further includes a date and time associated with the geographic information, and
the cost acquisition unit acquires the individual cost obtained by performing weighting using a weight coefficient which is a value based on a length of a period between a specific reference date and time and the date and time associated with the geographic information.

25. The information processing apparatus according to claim 20,
wherein the display control unit performs control for executing a selection process which is a process of selecting and displaying each of the geographic information items having the individual cost smaller than a given value.

26. The information processing apparatus according to claim 25, further comprising:
a location acquisition unit which acquires the reference location a plurality of times,
wherein the display control unit executes the selection process again based on a new reference location, in a case where the new reference location which is different from the predetermined location is acquired after executing the selection process based on the reference location of the predetermined location.

27. An information processing method comprising:
acquiring link information obtained by associating a reproduction location of contents with geographic information regarding geography associated with a story of the contents at the reproduction location; and
performing control for displaying a geographic image based on the geographic information associated with the story of the contents being reproduced, based on the acquired link information and the reproduction location of the contents being reproduced.

28. A program which causes a computer to execute:
acquiring link information obtained by associating a reproduction location of contents with geographic information regarding geography associated with a story of the contents at the reproduction location; and
performing control for displaying a geographic image based on the geographic information associated with the story of the contents being reproduced, based on the acquired link information and a reproduction location of the contents being reproduced.
